(19) United States
(12) Patent Application Publication
(10) Pub. No.: US 2024/0428812 A1
(43) Pub. Date: Dec. 26, 2024

(54) METHOD AND APPARATUS FOR SPECTROTEMPORALLY IMPROVED SPECTRAL GAP FILLING IN AUDIO CODING USING DIFFERENT NOISE FILLING METHODS

(71) Applicant: Fraunhofer-Gesellschaft zur Förderung der angewandten Forschung e.V., München (DE)

(72) Inventors: Christian HELMRICH, Erlangen (DE); Eleni FOTOPOULOU, Erlangen (DE); Richard FÜG, Erlangen (DE); Goran MARKOVIC, Erlangen (DE); Markus MULTRUS, Erlangen (DE); Franz REUTELHUBER, Erlangen (DE)

(73) Assignee: Fraunhofer-Gesellschaft zur Förderung der angewandten Forschung e.V., München (DE)

(21) Appl. No.: 18/751,317

(22) Filed: Jun. 23, 2024

Related U.S. Application Data
(63) Continuation of application No. PCT/EP2022/087810, filed on Dec. 23, 2022.

(30) Foreign Application Priority Data
Dec. 23, 2021 (EP) 21217660.6
Jan. 28, 2022 (WO) PCT/EP2022/052150

(51) Int. Cl. G10L 19/04

(52) U.S. Cl. CPC G10L 19/04

(57) ABSTRACT

Embodiments according to the invention are related to methods and apparatuses for spectrotemporally improved spectral gap filling in audio coding using a filtering. Embodiments according to the invention are related to methods and apparatuses for spectrotemporally improved spectral gap filling in audio coding using different noise filling methods. Embodiments according to the invention are related to methods and apparatuses for spectrotemporally improved spectral gap filling in audio coding using a tilt.

### CROSS-REFERENCES TO RELATED APPLICATIONS

This application is a continuation of copending International Application No. PCT/EP2022/087810, filed Dec. 23, 2022, which is incorporated herein by reference in its entirety, and additionally claims priority from European Application No. EP 21 217 660.6, filed Dec. 23, 2021, and International Application No. PCT/EP2022/052150, filed Jan. 28, 2022, all of which are incorporated herein by reference in its entirety.

Embodiments according to the invention are related to methods and apparatuses for spectrotemporally improved spectral gap filling in audio coding using a filtering.

Embodiments according to the invention are related to methods and apparatuses for spectrotemporally improved spectral gap filling in audio coding using different noise filling methods.

Embodiments according to the invention are related to methods and apparatuses for spectrotemporally improved spectral gap filling in audio coding using a tilt.

Embodiments according to the invention are related to decoders, encoders and methods using a spectral tilt information for audio coding.

Further embodiments according to the invention are related to decoders, encoders and methods using a prediction lag information and/or using a lag value and a gain value and/or a high frequency energy value or a high frequency energy delta value for audio coding.

Further embodiments according to the invention are related to decoders and methods using a filtering strength adaptation.

Further embodiments according to the invention are related to methods and apparatuses for spectrotemporally improved spectral gap filling in audio coding.

### BACKGROUND OF THE INVENTION

Conventional audio coding approaches comprise techniques for filling zero-quantized parts of the spectral range with random spectral values. As an example, a Perceptual Noise Substitution (PNS) decoder may insert pseudo-random values into zero-quantized bands, scaled such that the inserted signal energy matches the signaled target energy. However, for such approaches many bits may have to be reserved for a signaling of the zero-quantized band energies. Furthermore, only fully zero-quantized spectral bands may be substituted, hence such an approach may lack flexibility.

Further noise filling approaches may allow to replace zero-quantized spectral coefficients with pseudo-random values upon decoding, above a certain “noise fill start frequency”, however a large signaling overhead may therefore be required, especially when many bands are zero-quantized.

Therefore, it is desired to get a concept which makes a better compromise between a hearing impression based on a coded audio information and a signaling effort for a transmission of the coded audio information.

This is achieved by the subject matter of the independent claims of the present application.

Further embodiments according to the invention are defined by the subject matter of the dependent claims of the present application.

### SUMMARY

An embodiment may have an audio decoder for providing a decoded audio information on the basis of an encoded audio information, wherein the audio decoder is configured to fill spectral holes of a decoded set of spectral values; wherein the audio decoder is configured to acquire a prediction lag information; and wherein the audio decoder is configured to switch between a first spectral filling method, in which a frequency filtering or a frequency prediction is used to acquire filling values which are used to fill spectral holes, and one or more further spectral filling methods, in which no frequency filtering and no frequency prediction are used to acquire filling values which are used to fill spectral holes, in dependence on the prediction lag information.

Another embodiment may have an audio encoder for providing an encoded audio information on the basis of an input audio information, wherein the audio encoder is configured to encode a plurality of quantized spectral values; wherein the audio encoder is configured to acquire a lag value, which defines a characteristic of a filtering operation or of a prediction operation to be performed by an audio decoder for deriving one or more filling values for filling spectral holes; and wherein the audio encoder is configured to acquire a gain value which defines a characteristic of the filtering operation or of the prediction operation to be performed by an audio decoder for deriving one or more filling values for filling spectral holes; wherein the audio encoder is configured to set the lag value to zero if the gain value is smaller than a threshold value or if an absolute value of the gain value is smaller than a threshold value, to thereby acquire a modified lag value; and wherein the audio encoder is configured to encode the determined lag value or the modified lag value.

Another embodiment may have an audio encoder for providing an encoded audio information on the basis of an input audio information, wherein the audio encoder is configured to encode a plurality of quantized spectral values; wherein the audio encoder is configured to encode a high frequency energy value or a high frequency energy delta value, wherein the high frequency energy value or the high frequency energy delta value represents an energy of a plurality of spectral coefficients at a frequency below a noise filling end frequency or in a frequency region below the noise filling end frequency which were quantized to zero.

Another embodiment may have an audio decoder for providing a decoded audio information on the basis of an encoded audio information, wherein the audio decoder is configured to fill spectral holes of a decoded set of spectral values; wherein the audio decoder is configured to acquire a prediction gain information; and wherein the audio decoder is configured to switch between a first spectral filling method, in which a frequency filtering or a frequency prediction is used to acquire filling values which are used to fill spectral holes, and one or more further spectral filling methods, in which no frequency filtering and no frequency prediction are used to acquire filling values which are used to fill spectral holes, in dependence on the prediction gain information.

Another embodiment may have an audio encoder for providing an encoded audio information on the basis of an input audio information, wherein the audio encoder is configured to encode a plurality of quantized spectral values; wherein the audio encoder is configured to acquire a gain value which defines a characteristic of a filtering operation or of a prediction operation to be performed by an audio decoder for deriving one or more filling values for filling spectral holes; wherein the audio encoder is configured to encode the gain value; wherein the audio encoder is configured to selectively encode a lag value, which defines a characteristic of the filtering operation or of the prediction operation to be performed by an audio decoder for deriving one or more filling values for filling spectral holes, if a quantized gain value or an encoded gain value is non-zero, or wherein the audio encoder is configured to selectively encode a lag value, which defines a characteristic of the filtering operation or of the prediction operation to be performed by an audio decoder for deriving one or more filling values for filling spectral holes, if the gain value is larger than or equal to a threshold value.

Another embodiment may have a method for providing a decoded audio information on the basis of an encoded audio information, the method comprising: filling spectral holes of a decoded set of spectral values; acquiring a prediction lag information; and switching between a first spectral filling method, in which a frequency filtering or a frequency prediction is used to acquire filling values which are used to fill spectral holes, and one or more further spectral filling methods, in which no frequency filtering and no frequency prediction are used to acquire filling values which are used to fill spectral holes, in dependence on the prediction lag information.

Another embodiment may have a method for providing an encoded audio information on the basis of an input audio information, encoding a plurality of quantized spectral values; acquiring a lag value, which defines a characteristic of a filtering operation or of a prediction operation to be performed by an audio decoder for deriving one or more filling values for filling spectral holes; and acquiring a gain value which defines a characteristic of the filtering operation or of the prediction operation to be performed by an audio decoder for deriving one or more filling values for filling spectral holes; setting the lag value to zero if the gain value is smaller than a threshold value or if an absolute value of the gain value is smaller than a threshold value, to thereby acquire a modified lag value; and encoding the determined lag value or the modified lag value.

Another embodiment may have a method for providing a decoded audio information on the basis of an encoded audio information, the method comprising: filling spectral holes of a decoded set of spectral values; acquiring a prediction gain information; and switching between a first spectral filling method, in which a frequency filtering or a frequency prediction is used to acquire filling values which are used to fill spectral holes, and one or more further spectral filling methods, in which no frequency filtering and no frequency prediction are used to acquire filling values which are used to fill spectral holes, in dependence on the prediction gain information.

Another embodiment may have a method for providing an encoded audio information on the basis of an input audio information, the method comprising encoding a plurality of quantized spectral values; acquiring a gain value which defines a characteristic of a filtering operation or of a prediction operation to be performed by an audio decoder for deriving one or more filling values for filling spectral holes; encoding the gain value; selectively encoding a lag value, which defines a characteristic of the filtering operation or of the prediction operation to be performed by an audio decoder for deriving one or more filling values for filling spectral holes, if a quantized gain value or an encoded gain value is non-zero, or selectively encoding a lag value, which defines a characteristic of the filtering operation or of the prediction operation to be performed by an audio decoder for deriving one or more filling values for filling spectral holes, if the gain value is larger than or equal to a threshold value.

Another embodiment may have a non-transitory digital storage medium having a computer program stored thereon to perform the method for providing a decoded audio information on the basis of an encoded audio information, the method comprising: filling spectral holes of a decoded set of spectral values; acquiring a prediction lag information; and switching between a first spectral filling method, in which a frequency filtering or a frequency prediction is used to acquire filling values which are used to fill spectral holes, and one or more further spectral filling methods, in which no frequency filtering and no frequency prediction are used to acquire filling values which are used to fill spectral holes, in dependence on the prediction lag information, when said computer program is run by a computer.

Another embodiment may have a non-transitory digital storage medium having a computer program stored thereon to perform the method for providing an encoded audio information on the basis of an input audio information, encoding a plurality of quantized spectral values; acquiring a lag value, which defines a characteristic of a filtering operation or of a prediction operation to be performed by an audio decoder for deriving one or more filling values for filling spectral holes; and acquiring a gain value which defines a characteristic of the filtering operation or of the prediction operation to be performed by an audio decoder for deriving one or more filling values for filling spectral holes; setting the lag value to zero if the gain value is smaller than a threshold value or if an absolute value of the gain value is smaller than a threshold value, to thereby acquire a modified lag value; and encoding the determined lag value or the modified lag value, when said computer program is run by a computer.

Another embodiment may have a non-transitory digital storage medium having a computer program stored thereon to perform the method for providing a decoded audio information on the basis of an encoded audio information, the method comprising: filling spectral holes of a decoded set of spectral values; acquiring a prediction gain information; and switching between a first spectral filling method, in which a frequency filtering or a frequency prediction is used to acquire filling values which are used to fill spectral holes, and one or more further spectral filling methods, in which no frequency filtering and no frequency prediction are used to acquire filling values which are used to fill spectral holes, in dependence on the prediction gain information, when said computer program is run by a computer.

Another embodiment may have a non-transitory digital storage medium having a computer program stored thereon to perform the method for providing an encoded audio information on the basis of an input audio information, the method comprising encoding a plurality of quantized spectral values; acquiring a gain value which defines a characteristic of a filtering operation or of a prediction operation to be performed by an audio decoder for deriving one or more filling values for filling spectral holes; encoding the gain value; selectively encoding a lag value, which defines a characteristic of the filtering operation or of the prediction operation to be performed by an audio decoder for deriving one or more filling values for filling spectral holes, if a quantized gain value or an encoded gain value is non-zero, or selectively encoding a lag value, which defines a characteristic of the filtering operation or of the prediction operation to be performed by an audio decoder for deriving one or more filling values for filling spectral holes, if the gain value is larger than or equal to a threshold value, when said computer program is run by a computer.

Another embodiment may have an audio decoder for providing a decoded audio information on the basis of an encoded audio information, wherein the audio decoder is configured to fill spectral holes of a decoded set of spectral values; wherein the audio decoder is configured to acquire a prediction lag information; and wherein the audio decoder is configured to switch between a first spectral filling method, in which a frequency filtering or a frequency prediction is used to acquire filling values which are used to fill spectral holes, and one or more further spectral filling methods, in which no frequency filtering and no frequency prediction are used to acquire filling values which are used to fill spectral holes, in dependence on the prediction lag information, wherein the one or more further spectral filling methods comprise a usage of random or pseudo-random filling values to fill spectral holes, and/or a copying of non-zero spectral coefficients to fill spectral holes.

Another embodiment may have an audio decoder for providing a decoded audio information on the basis of an encoded audio information, wherein the audio decoder is configured to fill spectral holes of a decoded set of spectral values; wherein the audio decoder is configured to acquire a prediction lag information; and wherein the audio decoder is configured to switch between a first spectral filling method, in which a frequency filtering or a frequency prediction is used to acquire filling values which are used to fill spectral holes, and one or more further spectral filling methods, in which the frequency filtering or the frequency prediction is not used to acquire filling values which are used to fill spectral holes, in dependence on the prediction lag information.

Another embodiment may have an audio decoder for providing a decoded audio information on the basis of an encoded audio information, wherein the audio decoder is configured to fill spectral holes of a decoded set of spectral values; wherein the audio decoder is configured to acquire a prediction lag information; and wherein the audio decoder is configured to switch between a first spectral filling method, in which a noise filling, that uses random or pseudo random values, with a frequency filtering or a frequency prediction is used to acquire filling values which are used to fill spectral holes, and one or more further spectral filling methods, in which a noise filling, that uses random or pseudo random values, or a tonality based gap filling is used without the frequency filtering or the frequency prediction to acquire filling values which are used to fill spectral holes, in dependence on the prediction lag information.

In the following, embodiments of the invention are explained structured according to inventive aspects. However, it is to be noted that the following structuring is for explanatory purposes, in order to facilitate understanding the invention.

Hence, it is to be noted that any features, functionalities and/or details according to an embodiment according to any aspect of the invention may be used with, and/or incorporated in, any other embodiment according to the same and/or another aspect of the invention, individually or in combination.

Furthermore, some inventive embodiments will be explained in the context of a decoder and other inventive embodiments will be explained in the context of an encoder. It is to be noted that features, functionalities and details that are explained in the context of a decoder may be implemented analogously in or added to or used with a corresponding encoder, individually or taken in combination. Vice versa, features, functionalities and details as disclosed for inventive encoders may be incorporated in corresponding decoders. Accordingly, it is to be noted that decoders and corresponding encoders (or vice versa) may be based on similar and/or equivalent inventive concepts and may hence comprise corresponding advantages.

Moreover, further inventive aspect will be explained in the context of methods. It is to be noted that any of the features, functionalities and/or details as explained in the context of any of the inventive encoders and/or decoders may be incorporated in or may be used with or may be added to any of the inventive methods, individually or taken in combination.

Furthermore, methods according the embodiments of the invention may be based on the same or similar or analogous considerations and/or ideas as corresponding encoders and/or decoders. Hence, these methods may comprise same or similar or analogous features and advantages.

According to the above explanations, some features, functionalities and details may be explained or disclosed in the context of embodiments according to a specific aspect, or an encoder rather than a decoder or vice versa, or according to a method, for the sake of brevity and conciseness. Hence, again, it is to be highlighted that any feature, functionality and/or detail of an embodiment may be incorporated or used with or added to any other embodiment according to the invention, individually or taken in combination.

### Aspect 1

Embodiments according to a first aspect of the invention comprise an audio decoder for providing a decoded audio information on the basis of an encoded audio information, wherein the audio decoder is configured to derive a spectral tilt information, e.g. T′_{sf}, from the encoded audio information. Furthermore, the audio decoder is configured to use filling values, e.g. gap fill coefficients; e.g. noise values of a noise filling; e.g. gap filling values of an intelligent gap filling, in order to fill spectral holes of a decoded set of spectral values.

Moreover, the audio decoder is configured to apply, e.g. in a multiplicative manner, a frequency variable scaling, a spectral tilt of which is determined by the spectral tilt information, to the filling values, e.g. to the noise samples substituted for the zero-quantized samples, wherein, as an example, the spectral tilt of the frequency variable scaling is determined by the spectral tilt information.

The inventors recognized that the quality of a decoded audio information may be improved using a frequency variable scaling of filling values for filling spectral holes of a decoded set of spectral values. Therefore, an audio decoder according to embodiments of the invention may be configured to derive a spectral tilt information from an encoded audio information based on which the frequency variable scaling may be determined.

For example, one main idea according to embodiments of the first aspect of the invention is a calculation and, for example, low-bit-rate signaling of a difference curve, for example in logarithmic intensity domain, between a frame's (and/or a subframe's), e.g. true, spectral envelope (e.g. its input signal envelope) and the frame's (and/or subframe's) masking envelope, e.g. its noise shaping envelope. Since the masking envelope may be transmitted to the decoder, e.g. additional, transmission of the difference may allow to, in a spectral hole filling procedure, e.g. in a gap or noise filling decoding procedure, reconstruct the, e.g. true, spectral envelope, from the masking envelope and the difference curve. Therefore, according to the invention, the difference curve may be characterized by the spectral tilt information. Using a corresponding inventive decoder, a good accuracy and/or quality of the audio information may be achieved, for example with few side information bits.

The spectral tilt information may, for example, be a frame-wise and/or a subframe-wise spectral tilt information. As an example, the spectral tilt information may comprise a tilt index, e.g. t_{sf}, based on which, as an example, an information T′_{sf} may be determined, wherein T′_{sf} may, for example, be multiplied with a frequency dependent term, e.g. f, for example, in order to apply the frequency variable scaling to the filling values. Optionally, no explicit transmission of target energies in zero-quantized nonoverlapping frequency ranges may be transmitted, hence signaling effort may be kept at a low level.

The inventors recognized that using the spectral tilt, a spectral envelope of the audio information may be recovered from a masking envelope (e.g. noise shaping envelope, e.g. a masking envelope corresponding to or associated with scaling values or scaling factors of the frames and/or subframes) of the audio information with only few additional signaling bits.

According to further embodiments according to the first aspect of the invention the audio decoder is configured to derive a noise level information, e.g. L_{sf}, from the encoded audio information and the audio decoder is configured to use the noise level information, for example in addition to the frequency-variable scaling, in order to obtain the filling values.

The noise level information, e.g. L_{sf}, may, for example, be derived or reconstructed from a noise level index, e.g. an N-bit noise level index 0≤l_{sf}<2^{N}. The noise level information and/or the noise level index may, for example, be transmitted from a corresponding encoder to the decoder. As an example, the noise level information and/or the noise level index may, for example, comprise an information about the spectral tilt information (for example, i.e. further information about the difference curve), e.g. an offset, e.g. O_{sf}. In other words, the decoder may be configured to derive an information about the spectral tilt information (for example, i.e. further information about the difference curve) from the noise level information and/or from the noise level index.

The inventors recognized that using the noise level information for decoding may allow to determine improved filling values, e.g. allowing for a good reconstruction of the encoded audio signal.

According to further embodiments according to the first aspect of the invention, the audio decoder is configured to apply the frequency variable scaling, such that the frequency variable scaling describes, e.g. within a tolerance of +/−3 dB or +/−2 dB or +/−1 dB, a linear decrease of intensity, e.g. of the filling values, with increasing frequency on a logarithmic intensity scale.

The inventors recognized that using or by a linear decrease of intensity with increasing frequency on a logarithmic intensity scale, an improved reconstruction of the spectral envelope of the audio information may be achieved. As an example, an influence of a pre-emphasis tilt applied during the calculation of a masking envelope of the audio information may be compensated, such that the spectral envelope may be recovered, at least approximately.

According to further embodiments according to the first aspect of the invention the spectral tilt information describes a spectral tilt in a logarithmic domain, for example wherein a spectral tilt, e.g. the spectral tilt information, may, for example, be used in a logarithmic domain and/or in a linear domain.

It is to be noted that embodiments according to the invention are not limited to spectral tilt information in a logarithmic domain. The spectral tilt information, may, for example, be used in a logarithmic domain and/or in a linear domain. Usage in the logarithmic domain may allow a computation of the, e.g. spectrally tilted, filling values with low computational costs.

According to further embodiments according to the first aspect of the invention, the spectral tilt information describes a line function with a spectral tilt in a logarithmic domain.

The inventors recognized that this form of function, with the spectral tilt in the logarithmic domain, allows for an efficient decoding of the audio information with good accuracy.

According to further embodiments according to the first aspect of the invention, the audio decoder is configured to obtain scaling values for the frequency-variable scaling in a logarithmic domain, and the audio decoder is configured to convert the scaling values for the frequency-variable scaling from the logarithmic domain to a linear domain, e.g. using an exponential function; e.g. using an exponential function for a basis of 10; e.g. using a function of the form 10^{x}.

According to embodiments of the invention, a calculation domain, e.g. a logarithmic domain or a linear domain, may for example, be changed or adapted for different processing steps.

The inventors recognized that such a switching or changing of domains may improve the flexibility of inventive audio coding concepts. Furthermore, computational costs may be reduced by performing different processing steps in respective, suitable domains.

According to further embodiments according to the first aspect of the invention, the audio decoder is configured to obtain scaling values for the frequency variable scaling in dependence on a product of a tilt value, e.g. T′_{sf}, which is based on the tilt information, and of a frequency value, e.g. f, e.g. a frequency value describing the frequency, or a frequency value describing a frequency offset relative to a reference value.

As an example, the tilt value may, for example be scaled by a constant, e.g. an additional constant, in order to maintain, on average, a value range of a noise level information, e.g. L_{sf}. The inventors recognized that scaling values for the frequency variable scaling may, for example, be obtained with low computational effort using the product of the tilt value and the frequency value.

According to further embodiments according to the first aspect of the invention, the audio decoder is configured to obtain a plurality of scaling values for the frequency variable scaling associated with different frequency bands, e.g. such that the scaling values are associated with different frequency bands.

The inventors recognized that using scaling values associated with different frequency bands, a decoding of the audio information may be improved in, e.g., complexity or flexibility.

According to further embodiments according to the first aspect of the invention, the audio decoder is configured to obtain scaling values for the frequency variable scaling using start frequencies of respective frequency bands or using center frequencies of respective frequency bands; wherein, for example, a scaling value associated with a first frequency band is obtained using a multiplication of a (e.g. lower) start frequency of the first frequency band and a tilt value, and wherein, for example, a scaling value associated with a second frequency band is obtained using a multiplication of a (e.g. lower) start frequency of the second frequency band and the tilt value; or wherein, for example, a scaling value associated with a first frequency band is obtained using a multiplication of a center frequency of the first frequency band and a tilt value, and wherein, for example, a scaling value associated with a second frequency band is obtained using a multiplication of a center frequency of the second frequency band and the tilt value.

It is to be noted that embodiments according to the invention are not limited to a specific choice of a frequency representation of a respective frequency band. As explained before, start frequencies and/or center frequencies may be used. However, other, e.g. applications specific advantageous choices of frequency band information may be implemented. Hence, an inventive concept according to embodiments may provide a high flexibility.

According to further embodiments according to the first aspect of the invention, the audio decoder is configured to obtain scaling values for the frequency variable scaling using start frequency bin indices of respective frequency bands or using center frequency bin indices of respective frequency bands; wherein, for example, a scaling value associated with a first frequency band is obtained using a multiplication of a (e.g. lower) start frequency bin index of the first frequency band and a tilt value, and wherein, for example, a scaling value associated with a second frequency band is obtained using a multiplication of a (e.g. lower) start frequency bin index of the second frequency band and the tilt value; or wherein, for example, a scaling value associated with a first frequency band is obtained using a multiplication of a center frequency bin index of the first frequency band and a tilt value, and wherein, for example, a scaling value associated with a second frequency band is obtained using a multiplication of a center frequency bin index of the second frequency band and the tilt value.

The inventors recognized that using frequency bin indices, e.g. instead of frequency values, may allow to reduce computational costs.

According to further embodiments according to the first aspect of the invention, the audio decoder is configured to obtain filling values using a noise intensity information, e.g. L_{sf}; e.g. using a frequency-independent noise scaling value, which may, for example, be derived from the encoded audio information; which may, for example, be derived from l_{sf}.

Hence, the audio decoder may, for example be configured to determine or obtain filling values using a noise level information and/or a noise intensity information. Optionally, the decoder may, for example, be configured to derive the noise intensity information. In some applications, the noise level information may, for example, be equal to the noise intensity information.

According to further embodiments according to the first aspect of the invention, the audio decoder is configured to obtain a filling value using a multiplication of a noise value, of a frequency-independent noise scaling value, e.g. L_{sf}, and of a frequency-variable noise scaling value, e.g. 10^{Tsf*f}, which is determined considering the spectral tilt; wherein the noise value is a random noise value or a pseudo-random noise value, e.g. having a predetermined amplitude or having an amplitude within a predetermined amplitude range.

The inventors recognized that an adaptation of a noise value with a frequency-independent noise scaling value and a frequency-variable noise scaling value based on the spectral tilt may improve the quality of the decoded audio information with only limited impact on the complexity of a respective decoder. The frequency-variable noise scaling value may allow to shape, e.g. tilt with respect to frequency, a masking envelope of the audio information in order to better approximate the spectral envelope of the originally encoded audio information.

According to further embodiments according to the first aspect of the invention, the audio decoder is configured to apply a scaling, which is based on a masking envelope, to, e.g. non-zero, decoded spectral values and to filling values, e.g. such that, in effect, a masking envelope is applied to the full spectrum, optionally including the filling values.

The inventors recognized that, for example, an application of the inventive scaling may improve the decoded audio information when not only filling values, but other decoded spectral values are affected by the scaling. Hence, the decoded spectrum of the audio information may, for example, be adapted, e.g. tilted in dependence on the frequency.

Further embodiments according to the first aspect of the invention comprise an audio encoder for providing an encoded audio information on the basis of an input audio information, wherein the audio encoder is configured to encode a plurality of quantized spectral values and wherein the audio encoder is configured to determine a spectral tilt information, (e.g. a spectral tilt information describing a line function with a spectral tilt in a logarithmic domain e.g. wherein a spectral tilt, e.g. the spectral tilt information may, for example, be used in a logarithmic domain and/or in a linear domain) on the basis of a spectral energy information, e.g. a spectral envelope, and a masking envelope information, e.g. such that the spectral tilt information describes an average frequency variation of a difference between the spectral energy and the masking envelope. Moreover, the audio encoder is configured to encode the spectral tilt information.

As explained before, the spectral tilt information may describe a shape difference between the spectral energy of the audio information and the masking envelope for encoding the audio information. This shape difference may, for example, be expressed in the form of a frequency dependent tilt (in the frequency—amplitude plane). Hence, the spectral tilt information may be transmitted to a corresponding decoder, and the spectral tilt information may, for example, be used as an correction factor to adapt a transmitted masking envelope in order to better reconstruct the spectral envelope of the audio information.

According to further embodiments according to the first aspect of the invention, the audio encoder is configured to determine the spectral tilt information, such that the spectral tilt information describes a frequency variation of a difference between the spectral energy information, e.g. a “true spectral envelope” or a smoothened (e.g. in a frequency direction) version of the spectral values, and the masking envelope information, e.g. represented by scale factors or by one or more prediction coefficients, over frequency, e.g. such that the tilt information describes an average of a frequency variation, or, for example, such that the tilt information describes a tilt of a (e.g. linear) regression line of a difference between the spectral energy information and the masking envelope information over frequency.

As explained before, an idea according to embodiments of the invention is a calculation and low-bit-rate signaling of a frequency variation, e.g. of a difference curve, e.g. in logarithmic intensity domain, between a frame's (and/or a subframe's), e.g. true, spectral energy, e.g. spectral envelope, e.g. its input signal envelope and the frame's (and/or the subframe's) masking envelope. This information may be transmitted using the spectral tilt information.

Therefore, as an example, by providing the masking envelope and the spectral tilt information and hence an information about said difference curve a reconstruction of the spectral energy of the audio information may be performed with good accuracy and with low signaling effort. This may improve in particular a reconstruction of zero-quantized spectral coefficients, since noise filled or spectral gap filled coefficients (in a corresponding decoder) may, for example, be adapted or corrected using the spectral tilt information, therefore reducing a difference between the “original” spectrum and the reconstructed or decoded spectrum of the audio information.

According to further embodiments according to the first aspect of the invention, the spectral tilt information describes a line function with a spectral tilt in a logarithmic domain. The inventors recognized that this may allow to signal a correction information for the masking envelope to better approximate the original spectrum of the audio information with few signaling bits and good accuracy.

According to further embodiments according to the first aspect of the invention, the audio encoder is configured to determine the spectral tilt information in a logarithmic domain, e.g. using a logarithmized (e.g. frequency-dependent) representation of a spectral energy information and, for example, using a logarithmized (e.g. frequency-dependent) representation of the masking envelope information.

As explained before, the inventors recognized that a determination of the spectral tilt information in a logarithmic domain may be performed computationally efficient.

According to further embodiments according to the first aspect of the invention, the audio encoder is configured to determine the spectral tilt information on the basis of a difference, e.g. difference curve (f)=true spectral envelope (f)−masking envelope (f), e.g. a frequency dependent difference, between a logarithmized representation, e.g. as a function of frequency, of a spectral envelope, which may constitute the spectral energy information, and a logarithmized representation, e.g. as a function of frequency, of a masking envelope, which may constitute the masking envelope information.

The inventors recognized that a determination of the spectral tilt information in the logarithmic domain may be performed as a for example, simple and efficiently implementable difference operation.

According to further embodiments according to the first aspect of the invention, the audio encoder is configured to obtain the spectral tilt information using a linear regression, wherein the spectral tilt information may, for example, be a regression coefficient obtained by the linear regression, e.g. of an evolution of a difference between the (true) spectral envelope and the masking envelope over frequency in a logarithmic intensity domain.

The inventors recognized that a linear regression may allow to approximate a correction term or difference term or, e.g. monotonic, difference curve between the (e.g. true) spectral envelope and the masking envelope with limited complexity and good approximation results. Based on the correction term or difference term or, e.g. monotonic, difference curve, the spectral tilt information may, for example, be obtained. Optionally, the correction term or difference term or, e.g. monotonic, difference curve may be the spectral tilt information.

According to further embodiments according to the first aspect of the invention, the audio encoder is configured to obtain the spectral tilt information on the basis of spectral-band-wise, e.g. summed-up, energy values or spectral band wise root-mean-square values representing an energy of spectral values in a plurality of respective spectral bands and on the basis of spectral band-wise, e.g. summed-up, energy values or spectral-band-wise root-mean-square values representing, e.g. an energy level of the masking threshold in a plurality of respective spectral bands.

The inventors recognized that usage of a representation of spectral band-wise energy values (e.g. sum of squares) or root-means-square (RMS) values for obtaining the spectral tilt information may allow to keep a computational complexity low. However, embodiments are not limited to a usage of such representations, hence, transform coefficient-wise values may as well be used.

According to further embodiments according to the first aspect of the invention, the audio encoder is configured to determine separate spectral tilt information, e.g. separate spectral tilt values, for different audio frames and/or for different audio subframes.

The inventors recognized that frame-wise or subframe-wise spectral tilt information may allow to determine an effective correction information, e.g. a spectral tilt to be transmitted to a corresponding decoder, in order to improve a fitting of a decoded spectrum of the audio information to the original spectrum of the audio information.

According to further embodiments according to the first aspect of the invention, the audio encoder is configured to determine a difference value (e.g. O_{sf} or T_{sf}, e.g. an offset value O_{sf}; or, for example, a tilt value T_{sf}, e.g. a value which is quantized e.g. to a value t_{sf}; and/or which may, for example, be transmitted, e.g. to a noise-filling decoder; and/or which may, for example, be used, e.g. in a negated form, in a noise filling encoder) representing, in the form of a single value, a difference between the spectral energy information and the masking envelope information over a frequency range comprising a plurality of spectral bins, e.g. over a frequency band, or even over a plurality of spectral bands, or even over all of the frequency bands. Furthermore, the audio encoder is configured to obtain a noise level information, which may, for example, describe a noise level over a plurality of spectral bands, or even over all frequency bands, e.g. l_{sf}, in dependence on the difference value.

For example, O_{sf} may be an offset, which may not really be needed or which may not need to be encoded (but may optionally be used). For example, T_{sf} may be the value which is quantized (e.g. into t_{sf}) and which may be transmitted, and which may, for example, be used (e.g. in a negated form) in a noise filling encoder (and/or in a noise filling decoder).

The inventors recognized that using a single difference value may provide a good compromise between a (e.g. signaling or transmission) complexity and a reconstruction accuracy of the audio information. As an example, a tilt information may be determined that may describe a tilt of the masking envelope over frequency with respect to an original spectrum of the audio information. Hence, a decoder sided correction of, for example, zero quantized spectral coefficients based on filling values, adapted according to the masking envelope and corrected using the tilt information may allow for an efficient audio information reconstruction.

According to further embodiments according to the first aspect of the invention, the audio encoder is configured to obtain the difference value, (e.g. Osf or Tsf, e.g. an offset value Osf; or, for example, a tilt value Tsf, e.g. a value which is quantized e.g. to a value tsf; and/or which may, for example, be transmitted, e.g. to a noise-filling decoder; and/or which may, for example, be used, e.g. in a negated form, in a noise filling encoder) using a linear regression, e.g. using the linear regression mentioned above.

The inventors recognized that, for example, in many applications a difference between a original, e.g. “true” audio signal spectral envelope and a masking envelope may comprise an approximately linear, e.g. in logarithmic frequency domain, characteristic. In other words, an intensity difference between the true spectral envelope and masking envelope may change monotonically with frequency. E.g. in a logarithmic intensity domain (e.g., base-10 logarithm) and in the gap or noise filling spectral region, the monotonic difference curve may resemble a straight line most of the time. Hence, using a linear regression may allow to approximate a corresponding difference value with low computational costs and good accuracy.

According to further embodiments according to the first aspect of the invention, the audio encoder is configured to encode the spectral tilt information using three bits.

This may allow a good tradeoff between a number of signaling bits and accuracy of the spectral tilt information.

According to further embodiments according to the first aspect of the invention, the audio encoder is configured to encode the spectral tilt information such that the encoded spectral tilt information represents a negative spectral tilt, e.g. a decrease with increasing frequency.

The inventors recognized that a negative spectral tilt may, for example, allow a good adaptation or correction or improvement of the reconstructed audio information. As an example, a correction of filling values with a negative spectral tilt information may compensate for an undesirable influence of a pre-emphasis.

According to further embodiments according to the first aspect of the invention, the audio encoder is configured to perform the following functionality for one or more frames or subframes sf, e.g. audio frames or audio subframes:
1. Calculate spectral band wise energy values or RMS values E_{sf}(f) from an input, e.g. uncoded, spectrum;
2. Convert one or more values E_{sf}(f) to a logarithmic domain and subtract from the values E_{sf}(f), or, for example, from a logarithmized version thereof, an overall mean of a plurality of values E_{sf}(f), or, for example, of a logarithmized version thereof, to obtain zero-mean values E′_{sf}(f);
3. Calculate, quantize and dequantize a masking envelope M_{sf} from the zero mean values E′s_{f}
4. Reconstruct spectral band wise energy values or RMS values from M_{sf}, and derive logarithmic, or, for example, logarithmized and zero-mean values M′_{sf}(f) from M_{sf}
5. Conduct a linear regression between pairs of spectral band wise E′_{sf} and M′_{sf}, in order to obtain a slope T_{sf} and an offset O_{sf}
6. Quantize and dequantize a tilt index t_{sf} from T_{sf};
7. Reconstruct a tilt value from t_{sf}, to obtain a decoded tilt T′_{sf}, and use −T′_{sf}*f in a calculation of a noise level index l_{sf}.

The inventors recognized that the above functionality may allow for an efficient encoding of the audio information.

Further embodiments according to the first aspect of the invention comprise a method for providing a decoded audio information on the basis of an encoded audio information, the method comprising deriving a spectral tilt information, e.g. T′_{sf}, from the encoded audio information and using filling values (e.g. gap fill coefficients; e.g. noise values of a noise filling; e.g. gap filling values of an intelligent gap filling), in order to fill spectral holes of a decoded set of spectral values. The method further comprises applying, e.g. in a multiplicative manner, a frequency variable scaling, a spectral tilt of which is determined by the spectral tilt information, to the filling values, e.g. to the noise samples substituted for the zero-quantized samples.

Further embodiments according to the first aspect of the invention comprise a method for providing an encoded audio information on the basis of an input audio information, the method comprising encoding a plurality of quantized spectral values and determining a spectral tilt information on the basis of a spectral energy information, e.g. a spectral envelope, and a masking envelope information, e.g. such that the spectral tilt information describes an average frequency variation of a difference between the spectral energy and the masking envelope. The method further comprises encoding the spectral tilt information.

Further embodiments according to the first aspect of the invention comprise a computer program for performing any of the above methods, when the computer program runs on a computer.

### Aspect 2

Embodiments according to a second aspect of the invention comprise an audio decoder for providing a decoded audio information on the basis of an encoded audio information, wherein the audio decoder is configured to fill spectral holes of a decoded set of spectral values, e.g. using a substitution of spectral coefficients quantized to zero on the basis of respective filling values. Furthermore, the audio decoder is configured to obtain a prediction lag information, e.g. a frequency domain long-term-prediction lag value p_{sf}; e.g. a prediction lag information indicating a prediction period in a frequency direction, e.g. a spectral (LTP, e.g. Long-Term Prediction) distance value p_{sf}, e.g. from a bitstream or from the encoded audio information.

Moreover, the audio decoder is configured to switch between a first spectral filling method, e.g. a “noise filling”+FD LTP, e.g. if p_{sf} is not zero, in which a frequency filtering or a frequency prediction, e.g. a TNS or a LTP, (e.g. a filtering in which a spectral value associated with a first frequency has an influence on a spectral value associated with a second frequency) is used to obtain filling values which are used to fill spectral holes, and one or more further spectral filling methods (e.g. the second spectral filling method or the third spectral filling method, e.g. “noise filling” without FD-LTP; e.g. “gap filling”, e.g. if p_{sf} is zero), in which no frequency filtering and no frequency prediction are used, e.g. in which neither a frequency filtering nor a frequency prediction are used, to obtain filling values which are used to fill spectral holes, in dependence on the prediction lag information.

An idea according to embodiments according to the second aspect of the invention is to adaptively, e.g. based on a (e.g. sub)frame's signal characteristic, switch between a first spectral filling method, e.g. a noise filling solution, and a second (or a plurality of second, e.g. a second and a third) spectral filling method, e.g. a gap filling solution. Furthermore, the first spectral filling method may comprise a frequency filtering or a frequency prediction, e.g. a frequency-domain long-term prediction (FD-LTP), and the second spectral filling method may comprise no frequency filtering and no frequency prediction. Hence, the decoder may, for example, switch between different methods for generating an “artificial” spectral content for the filling of zero-quantized spectral coefficients.

The inventors recognized that a switching between different filling methods may improve the reconstructed, e.g. decoded, audio signal. Furthermore, the inventors found out that a prediction lag information may allow to control an adaptation of the different filling methods with only limited impact on the signaling complexity. As an example, a decoder according to embodiments may be configured to switch or choose, depending on the prediction lag information, e.g. depending on a FD-LTP lag value p_{sf}, between a noise filling with FD-LTP, and a tonality based gap filling without FD-LTP (e.g. similar to IGF in EVS) or a noise filling without FD-LTP (e.g. similar to that in EVS or MPEG-D).

As another optional feature, the prediction lag information may, for example, comprise, e.g. only, integer values, in order to lower the computational complexity.

Hence, an inventive coding concept according to the second aspect of the invention may provide a good flexibility, e.g. in the switching or choice of spectral hole filling methods, in order to achieve a better coding efficiency for the audio information.

The prediction lag information may comprise an information about a relationship of, e.g. zero quantized, spectral coefficients of different frequency blocks. The prediction lag information may comprise an information about a periodicity or about an abatement of spectral coefficients. Hence, the prediction lag information may, for example, be an indicator whether a relationship between, e.g. zero quantized, spectral coefficients is sufficient or well suited, in order to reconstruct or to approximate spectral coefficients in dependency on corresponding related spectral coefficients. In such a case, a good hearing impression can, for example, be achieved although bits may be saved.

In particular, as an example, the inventors discovered experimentally that, for example, applause-like, rain-like, and low frequency, LF, male speech signals can benefit from improved reconstruction of the high frequency, HF, fine temporal signal envelope during decoder-side spectral hole filling, e.g. gap or noise filling. For such signals, that may, for example, be detected and classified as “long-term transient” (e.g. classified using the prediction lag information), the fine temporal structure of a specific (e.g. sub)frame can be parameterized by a prediction lag information, e.g. a frequency-domain long-term prediction (FD-LTP) information. Analogous to e.g. conventional LTP pitch and gain information acquired in time domain (TD), as an example, prediction lag information lag and gain values, e.g. FD-LTP lag and gain values can, for example, be obtained, e.g. directly, in the audio codec's transform domain. The choice of spectral hole filling to be applied in a decoder can be made and signaled to the decoder depending on the value of said prediction lag information, e.g. FD-LTP lag p or p_{sf}, transmitted in the audio bitstream.

According to further embodiments according to the second aspect of the invention, the audio decoder is configured to, e.g. selectively, use the first spectral filling method if the prediction lag information, e.g. a prediction lag value; e.g. a quantized FD LTP, e.g. Long-Term Prediction, lag value; e.g. p_{sf}, is non-zero. Alternatively, or for example in addition, the audio decoder is configured to, e.g. selectively use the first spectral filling method if the prediction lag information, e.g. a prediction lag value; e.g. a quantized FD LTP lag value; e.g p_{sf}, is larger than zero. Furthermore, the audio decoder is configured to, e.g. selectively, use one of the one or more further spectral filling methods otherwise, e.g. if the prediction lag information is zero, or if the prediction lag information is smaller than or equal to zero.

The inventors recognized that the prediction lag information may allow to implement a simple distinction of cases. As an example, in case a relationship between, e.g. zero quantized, spectral coefficients brings along advantages, e.g. a better reconstruction of the time signal, for a reconstruction, the prediction lag information may be non-zero, or larger than zero. Otherwise, the decoder may, for example, use the second spectral filling, e.g. in case the prediction lag information is zero, which may be associated with a small dependency between spectral coefficients.

According to further embodiments according to the second aspect of the invention, the audio decoder is configured to use an encoded representation of a prediction lag value, e.g. a quantized and encoded representation, which is included in the encoded audio information, in order to obtain the prediction lag value.

According to further embodiments according to the second aspect of the invention, the audio decoder is configured to determine a, e.g. final, filling value, e.g. a replacement for c(i); e.g. č(i), using a prediction or filtering, e.g. using a computation rule d*c(i)+G′_{sf}*c(i−P′_{sf}), such that a given filling value, e.g. č(i), which is associated with a given frequency, e.g. with a given frequency bin, is obtained in dependence on another spectral value, e.g. c(i−P′_{sf}), or č (i−P′_{sf}), which is associated with a different frequency, (e.g. with a different frequency bin, e.g. with a different frequency bin having a frequency bin index i−P′_{sf}; e.g. with a frequency or frequency bin having a spectral distance P′_{sf} or a spectral distance d_{sf} from the given frequency or from the given frequency bin), when using the first spectral filling method.

Furthermore, the audio decoder is configured to adapt a filtering strength (e.g. a weighting of a spectral value associated with the different frequency, e.g. by selectively setting the filtering strength to G′_{sf} or ½G′_{sf}) in dependence on an encoded or quantized spectral value (e.g. a spectral value as it is, for example originally, determined by the encoded representation of individual spectral values in the encoded audio information; e.g. by a spectral value before a noise filling is applied; e.g. by a spectral value directly after an arithmetic decoding) associated with the different frequency (e.g. with the different frequency bin; e.g. with the different frequency bin having a frequency bin index i−P′_{sf}) when using the first spectral filling method.

As explained before, a filling value, associated with a given frequency, may be determined or obtained or calculated based on, or using a spectral value, which is associated with a different frequency, e.g. in case the prediction lag information is non-zero, and hence, as an example, indicating a transientness of a signal. Furthermore, the inventors recognized that a decoding and/or a reconstruction of the audio information may be improved by adapting a filtering strength in dependence on the encoded or quantized spectral value associated with the different frequency.

As an example, in case the first spectral filling method is chosen, e.g. in case a noise filling with FD-LTP is selected (e.g. if the prediction lag information is non-zero, as an example, if the FD-LTP lag is nonzero), application of a long-term predictive filter in a spectral domain (e.g. the MDCT domain) of the audio transform codec may be performed, during the decoder-side noise filling routine, e.g. depending on whether a “current” coded FD coefficient is zero and on whether a corresponding “previous” coded FD coefficient located at a distance from the current coefficient (e.g. specified by the transmitted prediction lag information, e.g. by the transmitted FD-LTP lag) is zero.

As an example, an infinite impulse response (IIR) LTP-like filter is may be used for the filtering.

According to further embodiments according to the second aspect of the invention, the filtering strength determines an impact of the other spectral value, e.g. of c(i−P′_{sf}), onto the given filling value.

The inventors recognized that adapting the impact of the other spectral value onto the given filling value based on the filtering strength may improve the quality of the decoded audio information.

According to further embodiments according to the second aspect of the invention, the audio decoder is configured to adapt the filtering strength in dependence on the spectral value associated with the different frequency as it is, e.g. originally, determined by the encoded representation of individual spectral values in the encoded audio information.

The inventors recognized that using a value which is represented by the encoded representation for an adaptation of the filtering strength allows to use or exploit an information provided by the encoded representation rather than a filtered version thereof, which may, for example, be alternated. It has been found that using such a criterion is more reliable for the selection of a filter strength than using a criterion that is depending on a value that was already preprocessed on the decoder side.

According to further embodiments according to the second aspect of the invention, the audio decoder is configured to adapt the filtering strength in dependence on the spectral value associated with the different frequency before a noise filling is applied.

The inventors recognized that using the spectral value associated with the different frequency before noise filling may allow to adapt the filtering strength based on the information whether the spectral value was quantized to zero or not.

According to further embodiments according to the second aspect of the invention, the audio decoder is configured to adapt the filtering strength in dependence on whether the spectral value associated with the different frequency (or value) is quantized to zero or not.

According to further embodiments according to the second aspect of the invention, the audio decoder is configured to adapt the filtering strength in dependence on whether a noise filling is applied to the spectral value associated with the different frequency (or value or not.

The inventors recognized that using this criterion, the filter strength adaptation may be performed based on an information whether a respective spectral value was quantized to zero, e.g. in addition to whether for the respective frequency of the spectral value a noise filling is intended to be performed or was performed. This may comprise usage flags.

According to further embodiments according to the second aspect of the invention, the audio decoder is configured to selectively apply a filtering in a frequency direction or a prediction in a frequency direction for spectral values for which a noise filling is applied, e.g. for each noise-filled zero quantized spectral coefficient c at location i>=P′_{sf}.

The inventors recognized that, as an example, zero-quantized spectral values may be approximated or estimated based on or using the filtering or prediction in the frequency direction. Hence, a dependency of spectral values of different spectral values in frequency direction may, for example, be exploited.

According to further embodiments according to the second aspect of the invention, the audio decoder is configured to apply the prediction or the filtering, in order to determine the given, e.g. final, filling value, e.g. č(i), on the basis of a random or pseudo-random noise values, e.g. c(i).

The inventors recognized that a random or pseudo random noise value may, for example, be adapted using the prediction or the filtering, in order to calculate a e.g. final filing value that may provide a good approximation for a zero-quantized spectral value of an e.g. original e.g. input spectrum of the audio information.

According to further embodiments according to the second aspect of the invention, the audio decoder is configured to perform a weighted combination of a noise value associated with the given frequency, and of a noise value associated with the other frequency in order to obtain the given, e.g. final, filling value, e.g. č(i).

As an example, the audio decoder may be configured to perform a combination d*c(i)+G′_{sf}*c(i−P′_{sf}), with weight d for the noise value c(i) associated with the given frequency, and weight G′_{sf} for the noise value associated with the other frequency, or a combination d*c(i)+½*G′_{sf}*c(i−P′_{sf}), with weight d for the noise value c(i) associated with the given frequency, and weight ½*G′_{sf} for the noise value associated with the other frequency.

Alternatively, the audio decoder is configured to perform a weighted combination of a noise value associated with the given frequency, and of a filling value associated with the other frequency in order to obtain the given, e.g. final, filling value, e.g. č(i).

Furthermore, the audio decoder is configured to adjust a weight, e.g. G′_{sf} or ½*G′_{sf}, given to the noise value associated with the other frequency or the weight, e.g. G′_{sf} or ½*G′_{sf}, given to the filling value associated with the other frequency in dependence on whether a noise filling has been applied for a spectral value associated with the other frequency.

As explained above, the inventors recognized that the e.g. final, filling value, may, for example, be calculated using different frequency dependent quantity, e.g. a noise value associated with the given frequency, and/or associated with the other frequency, and/or a filling value associated with the other frequency. Hence, an inventive concept may allow to determine or to obtain or to calculate the e.g. final filling value with good flexibility, such that, according to a specific situation, a filing value may be obtain that may be well or even best suitable for a reconstruction of the e.g. original audio information spectrum. Choice of the respective quantity to be used for obtaining the e.g. final filling value may, for example, be performed based on the prediction lag information. Furthermore, the inventors recognized that an adaptation or adjustment of a respective weight of a corresponding noise value or filling value associated with the other frequency may improve the determination of the e.g. final filling value and hence the reconstruction of the audio information.

According to further embodiments according to the second aspect of the invention, the audio decoder is configured to perform a weighted combination of a noise value associated with the given frequency, and of a noise value associated with the other frequency in order to obtain the given, e.g. final, filling value, e.g. č(i).

As an example, the audio decoder may be configured to perform a combination d*c(i)+G′_{sf}*c(i−P′_{sf}), with weight d for the noise value c(i) associated with the given frequency, and weight G′_{sf} for the noise value associated with the other frequency, or a combination d*c(i)+½*G′_{sf}*c(i−P′_{sf}), with weight d for the noise value c(i) associated with the given frequency, and weight ½*G′_{sf} for the spectral (or noise) value associated with the other frequency.

Alternatively, the audio decoder is configured to perform a weighted combination of a noise value associated with the given frequency, and of a filling value associated with the other frequency in order to obtain the given, e.g. final, filling value, e.g. č(i).

Furthermore, the audio decoder is configured to adjust a weight, e.g. G′_{sf} or ½*G′_{sf}, given to the noise value associated with the other frequency or to a spectral value associated with the other frequency or to the weight, e.g. G′_{sf} or ½*G′_{sf}, given to the filling value associated with the other frequency or to a spectral value associated with the other frequency in dependence on whether a noise filling has been applied for a spectral value associated with the other frequency.

According to further embodiments according to the second aspect of the invention, the audio decoder is configured to determine a spectral distance, e.g. P′_{sf} (e.g. a spectral distance d_{sf} based on P′_{sf}), between the filling value associated with the given frequency and the other spectral value associated with the different frequency on the basis of an encoded information, e.g. an encoded value, describing the spectral distance, which is included in the encoded representation of the audio information.

As an example, filling value, e.g. a noise sample, e.g. č(i) substituted for a zero-quantized sample may be filtered such that the filtering strength depends on a quantized value c(i−d_{sf}) located at spectral distance d_{sf} from i. In the case of a usage of an FD-LTP d_{sf} may be equal to P′_{sf}.

The inventors recognized that the spectral distance may, for example, be used in order to improve the determination of the spectral filling values.

According to further embodiments according to the second aspect of the invention, the audio decoder is configured to determine a weight, e.g. d, which is applied to the noise value associated with the given frequency, on the basis of a gain information, e.g. a gain value, e.g. g_{sf}, which is included in the encoded representation of the audio information, wherein the weight, which is applied to the noise value associated with the given frequency, is a positive value, e.g. in a range between 0.5 and 1.

The inventors recognized that such a determination and application of a weight may, for example, allow to adjust the noise value associated with the given frequency, in order to better approximate an original spectral envelope of the audio information.

According to further embodiments according to the second aspect of the invention, the audio decoder is configured to determine a weight, e.g. G_{sf}=(−1)^{Ssf}*(3+2*g_{sf})/8, or ½*G_{sf}, which is applied to the noise value, e.g. c(i−P′_{sf}), associated with the other frequency, or to the filling value associated with the other frequency, in dependence on a gain information, e.g. a gain value, e.g. g_{sf}, which is included in the encoded representation of the audio information, wherein the weight, which is applied to the noise value associated with the given frequency, is, for example, a positive or negative value, e.g. having an absolute value between 0.25 and 0.75.

The inventors recognized that a respective noise value, or a respective filling value associated with the other frequency may, for example, be adapted with the weight that is determined in dependence on the gain information. This may allow to shape said noise or filling value to improve its matching with a corresponding spectral value of the originally encoded audio information.

According to further embodiments according to the second aspect of the invention, the audio decoder is configured to determine the weight, e.g. G_{sf}=(−1)^{Ssf}*(3+2*g_{sf})/8, or ½*G_{sf}, which is applied to the noise value, e.g. c(i−P′_{sf}), associated with the other frequency, or to the filling value associated with the other frequency, in dependence on a sign information, e.g. a sign value, e.g. S_{sf}, which is included in the encoded representation of the audio information.

The inventors recognized that, for example, using a sign information, e.g. a 1-bit information, the weight determination may, for example, be improved. As an example, the sign information may allow an adaptation of a phase relation of the e.g. final filling value with respect to the noise value and/or the filling value associated with the other frequency, it may be based on.

According to further embodiments according to the second aspect of the invention, the audio decoder is configured to determine the given filling value č(i) according to č(i)=d*c(i)+G′_{sf}*c(i−P′_{sf}), if the coefficient c(i−P′_{sf}) was obtained using a noise filling, e.g. if the coefficient c(i−P′_{sf}) at a spectral location i−P′_{sf} was marked as a noise filled zero-quantized spectral coefficient in a previous processing, and according to č(i)=d*c(i)+½*G′_{sf}*c(i−P′_{sf}), if the coefficient c(i−P′_{sf}) was not obtained using a noise filling, e.g. if the coefficient c(i−P′_{sf}) at a spectral location i−P′_{sf} was not marked as a noise filled zero-quantized spectral coefficient in a previous processing. c(i) designates a spectral coefficient which is obtained using a noise filling and having a spectral index i, d designates an attenuation coefficient, G′_{sf} designates a weight which is based on a gain value that is included in the encoded audio representation and c(i−P′_{sf}) designates a spectral coefficient (which may, for example, be obtained using a noise, or which may, for example, be obtained without using a noise filling, and which may, for example, be obtained using a prediction or a filtering) having a spectral index i−P′_{sf}, wherein P′_{sf} is a prediction parameter or a filtering parameter which is based on a prediction parameter information that is included in the encoded audio representation.

The inventors recognized that using the above equations, an efficient filling value may be determined.

According to further embodiments according to the second aspect of the invention, the audio decoder is configured to obtain the prediction parameter or filtering parameter P′_{sf} according to P′_{sf}=p_{sf}+B, wherein p_{sf} is a lag index which is included in the encoded audio representation, and wherein B is a constant, wherein B may, for example, be equal to a number of bits which are used to encode p_{sf}, wherein p_{sf} may, for example, take values between 0 and 2^{B}−1. In addition or alternatively the audio decoder is configured to obtain the weight G′_{sf} according to G′_{sf}=(−1)^{Ssf}*(3+2*g_{sf})/8, wherein S_{sf} is a binary value which is included, e.g. in an encoded form, in the encoded representation and wherein g_{sf} is a binary value which is included, e.g. in an encoded form. in the encoded representation. Alternatively, or in addition, the audio decoder is configured to obtain the attenuation coefficient d according to d=(7.5−g_{sf})/8, wherein g_{sf} is a binary value which is included, e.g. in an encoded form, in the encoded representation.

As an example, constant B may be chosen according to whether a given frame has more than one subframe. The inventors recognized that using the above equations a good trade-off between signaling effort, complexity and effectivity of the decoding may be achieved.

According to further embodiments according to the second aspect of the invention, the audio decoder is configured to mark noise-filled zero-quantized spectral coefficients, and the audio decoder is configured to selectively use a reduced filtering strength, e.g. ½*G′_{sf}, which is applied to spectral coefficients which are not marked, as noise-filled zero-quantized spectral coefficients.

The inventors recognized that a reduction of the filtering strength for unmarked spectral coefficients may, for example, be improve the reconstruction or approximation of the original spectrum of the audio information.

According to further embodiments according to the second aspect of the invention, the audio decoder is configured to switch between a second spectral filling method, e.g. a “noise filling”, in which random or pseudo-random filling values are used to fill spectral holes, e.g. without using a frequency filtering and without using a frequency prediction in order to obtain the filling values, and a third spectral filling method, e.g. “gap filling”, in which filling values which are obtained using a copying of non-zero spectral coefficients are used to fill spectral holes, in dependence on a prediction lag information and/or in dependence on a tonality of the audio information. Optionally, the tonality may, for example, be judged in dependence on a presence of a tonality information and/or in dependence on a tonality information, and/or in dependence on a HPF data. As another optional feature, the second spectral filling method and the third spectral filling method are, for example, “one or more further spectral filling methods”.

The inventors recognized that a decoding of the audio information may, for example, be improved by switching between a usage of random or pseudo-random filling values and a copying of non-zero spectral, e.g. within a frequency distance, e.g. withing a frequency distance that is determined by the prediction lag information. Furthermore, the inventors recognized that such a switching may be performed based on the prediction lag information and/or in dependence on a tonality of the audio information.

As an example, the classification of the audio information or e.g. of a subframe sf as “tonal” may be performed based upon the prior-art audio tonality data, e.g., by classifying sf as “tonal” if the audio tonality data is present (e.g. the TD-LTP/HPF data is nonzero). Alternatively, as another example, sf may only be classified “tonal” if the TD-LTP/HPF gain value is transmitted and maximum.

According to further embodiments according to the second aspect of the invention, the audio decoder is configured to obtain a tonality information, e.g. a tonality value quantitatively describing a tonality of an audio content of the encoded audio information, or, for example, a tonality flag indicating whether an audio content of the encoded audio information is tonal or not, on the basis of the encoded audio information, e.g., to obtain a frame-wise or subframe-wise (e.g. audio frame wise or audio subframe wise) temporal (audio tonality) pitch information j_{sf} from a bitstream. Furthermore, the audio decoder is configured to switch between a second spectral filling method, e.g. a “noise filling”; e.g. a noise filling which is based on random or pseudo-random noise values, and a third spectral filling method, e.g. a “gap filling”, in dependence in or in dependence on the tonality information.

The inventors recognized that a signaling effort may be improved if the decoder is configured to obtain the tonality information from or on the basis of the encoded audio information.

According to further embodiments according to the second aspect of the invention, the audio decoder is configured to obtain a prediction lag information, e.g. a frequency domain long-term-prediction lag value p_{sf}, e.g. a spectral (LTP, e.g. Long-Term Prediction) distance value p_{sf}, e.g. from a bitstream or from the encoded audio information.

According to further embodiments according to the second aspect of the invention, the audio decoder is configured to judge, e.g. to determine or to decide, whether the audio information is tonal in dependence on a tonality information which is included in the encoded audio representation, and which may be extracted from the encoded audio information by the audio decoder, and/or in dependence on an information, e.g. a flag, indicating whether a tonality information is included in the encoded audio information, and/or in dependence on a filtering gain value and/or in dependence on a prediction gain value, e.g. a TD-LTP gain value, and/or in dependence on a time-domain post-filter gain value, e.g. a HPF gain value, e.g. a harmonic post-filter gain value.

As explained above, embodiments according to the invention are not limited to a specific evaluation of the tonality characteristics of the audio information. Hence, an inventive decoder may comprise a good flexibility for inspecting the tonality information.

According to further embodiments according to the second aspect of the invention, the audio decoder is configured to apply a high frequency noise gain adjustment for a filling of spectral holes in an upper frequency region below an, e.g. upper, noise filling end frequency.

As an example, using the high frequency noise gain adjustment, a spectral energy of filling values for filling spectral holes may be adjusted to allow for a better reconstruction of the e.g. original audio input spectrum.

According to further embodiments according to the second aspect of the invention, the audio decoder is configured to obtain a high frequency energy information, e.g. a high frequency energy delta value, on the basis of the encoded audio information, e.g. using a decoding of an encoded high frequency energy information value included in the encoded audio information.

As an example, the high frequency energy information, e.g. an HF energy value (or, for example, delta in case of differential entropy coding), may represents an original energy, e.g. the original RMS energy, of the spectrotemporally normalized spectral coefficients of the audio information, e.g. slightly below the noise filling end frequency (e.g., in the 8-10 kHz frequency range) which were quantized to zero. The high frequency energy information may, for example, be quantized like the scale factors in AAC, e.g., logarithmically in steps of 1.51 dB.

Using the high frequency energy information, the audio information may be decoded and/or reconstructed efficiently. Optionally, the gain adjustment may be performed based on the high frequency energy information.

According to further embodiments according to the second aspect of the invention, the audio decoder is configured to obtain a high frequency energy delta value, e.g. nrFac_{sf}, in dependence on a high frequency energy value, e.g. EHF_{sf} (which may, for example, be included, in an encoded form, in the encoded audio representation), in dependence on a global gain value, e.g. GG_{sf} (which may, for example, be included, in an encoded form, in the encoded audio representation), and in dependence on a, e.g. broadband, noise level information, which may, for example, be associated with a frequency region which is wider than the frequency region to which the high frequency energy value is associated, e.g. L_{sf}; which may, for example, be included, in an encoded form, in the encoded audio representation. Furthermore, the audio decoder is configured to apply the high frequency energy delta value to obtain one or more noise filling values.

As an example, to minimize the signaling overhead required to convey an information about the high frequency energy value to the decoder, the information about the energy value may be transmitted as a delta value relative to the global gain value, e.g. a core coder's global gain, and the noise level information, e.g. a noise level product, e.g., as a “noise gain normalized” value, e.g. GG_{sf}*L_{sf}. This may, for example, be realized by transmitting a rounded scaled result of a logarithm of the ratio between the high frequency energy value and the product of the global gain value and noise level information.

The inventors recognized that based on the product of the gain value and the noise level information a HF energy value may be obtained that allows to obtain noise filling values for filling spectral holes that may provide a good reconstruction of an e.g. original input audio spectrum.

According to further embodiments according to the second aspect of the invention, the audio decoder is configured to selectively multiply one or more intermediate noise filling values which are associated with frequencies in an upper frequency region below an, e.g. upper, noise filling end frequency, with the high frequency energy delta value, e.g. while leaving noise values in a lower frequency region, below the upper frequency region, unaffected by the high frequency energy delta value.

Using such an approach a noise intensity in the upper frequency region can be adjusted, e.g. on the basis of the high frequency energy delta value which may be encoded in the bitstream. This way a hearing impression may, for example, be improved.

According to further embodiments according to the second aspect of the invention, the audio decoder is configured to selectively apply the high frequency noise gain adjustment to spectral values for which a noise filling is performed, e.g. while leaving spectral values for which no noise filling is performed unaffected.

The inventors recognized that a good comprise between a computational effort and an optimization effort may be achieved by, for example only gain adjusting spectral values for which a noise filling is performed.

According to further embodiments according to the second aspect of the invention, the audio decoder is configured to, e.g. selectively, apply the high frequency noise gain adjustment in a frequency range between 8 kHz and 10 kHz, e.g. on the basis of a single common high frequency energy value or on the basis of a single common high frequency energy delta value.

The inventors recognized that applying the high frequency noise gain adjustment in the above frequency range may provide a good compromise between additional complexity and a quality of the decoded audio information.

According to further embodiments according to the second aspect of the invention, the high frequency energy value or the high frequency energy delta value represents an, e.g. original, e.g. RMS, energy of a plurality of, e.g. spectro-temporally normalized, spectral coefficients at a frequency below, and, for example, adjacent to, a noise filling end frequency or in a frequency region below, and, for example, adjacent to, the noise filling end frequency which were quantized to zero.

Thus, a noise in the upper frequency region can be adjusted to be close to an e.g. original, e.g. real intensity.

Further embodiments according to the second aspect of the invention, comprise an audio encoder for providing an encoded audio information on the basis of an input audio information, wherein the audio encoder is configured to encode a plurality of quantized spectral values and wherein the audio encoder is configured to obtain, e.g. to determine, a lag value, e.g. a FD-LTP lag; e.g. a lag value P_{sf}, which defines a characteristic of a filtering operation, e.g. in a frequency direction, or of a prediction operation, e.g. in a frequency direction, to be performed by an audio decoder for deriving one or more filling values for filling spectral holes. Furthermore, the audio encoder is configured to obtain, e.g. to determine, a gain value, e.g. G_{sf}, which defines a characteristic of the filtering operation or of the prediction operation to be performed by an audio decoder for deriving one or more filling values for filling spectral holes. Moreover, the audio encoder is configured to, e.g. selectively, set, or, for example, change, the lag value to zero if the gain value, e.g. G_{sf}, is smaller than a threshold value, e.g. β, or if an absolute value of the gain value is smaller than a threshold value, to thereby obtain a modified lag value, e.g. p_{sf}=0; and the audio encoder is configured to encode the determined lag value or the modified lag value, wherein, for example, the modified lag value is encoded if the gain value is modified, e.g. using 3 or 4 bits.

For example, as explained before, a decoder-sided filling of spectral holes of a decoded set of spectral values may be performed based on a prediction lag information. The prediction lag information may correspond, e.g. may be or may comprise or may be determined using the lag value or the modified lag value. Hence, based on such a lag information a decoding and/or reconstruction of the audio information may, for example, be performed efficiently.

The inventors recognized that the lag value may be determined according to the gain value, which is associated with the filtering operation or of the prediction operation to be performed by an audio decoder for deriving one or more filling values for filling spectral holes. In simple words, and as an example, a the lag value may be set to zero if the gain value is insignificant. This adaptation may yield a modified lag value.

For example, in case the gain value is low or insignificant, there may only be a weak relationship between spectral coefficients from different frequency bands, hence a lag information, that may correspond to a correlation between such values in frequency direction may not be exploitable, or may not be useful, for a spectral value reconstruction, e.g. because of the gain-wise low impact correlation. Accordingly, by setting the lag value to zero, if the gain is too small, bitrates can be saved.

According to further embodiments according to the second aspect of the invention, the audio encoder is configured to determine the lag value and the gain value using an autocorrelation information which is applied to a set of spectral values, e.g. to a spectrotemporally normalized spectrum, e.g. at lags B<p′<B+2^{B}, wherein, for example, the lag value, e.g. P_{sf}, is determined in dependence on a position of a peak of an autocorrelation function which is obtained on the basis of the set of spectral values.

As an example, the autocorrelation information may be a normalized autocorrelation information. In general, the lag value (or modified lag value) the gain value and/or a sign index for the filtering and/or prediction of spectral coefficients, or corresponding indices may, for example, be calculated in a spectrotemporally normalized domain utilized e.g. before the transform coefficient quantization.

According to further embodiments according to the second aspect of the invention, the audio encoder is configured to selectively encode the gain value if the encoded lag value, e.g. the lag value or the modified lag value, is non-zero.

As an example, vice versa as explained before, a prediction or filtering of spectral coefficients, e.g. of noise filled or gap filled spectral values, may be performed if the gain value is significant, and the lag value is non-zero, hence, as an example, only in such cases signaling bits for gain value and lag value may be provided.

According to further embodiments according to the second aspect of the invention, the audio encoder is configured to selectively encode a high-frequency energy value, which describes an energy in an upper portion of a spectrum, e.g. of the input audio information or of a pre-processed version thereof, if the encoded lag value is zero.

As an example, in case no filtering or prediction of spectral coefficients may be performed because of unfavorable gain and/or lag values, a high-frequency energy value may be provided, e.g. to perform a noise filling or a gap filling with a corresponding spectral energy.

According to further embodiments according to the second aspect of the invention, the audio encoder is configured to selectively either encode the gain value or a high-frequency energy value, which describes an energy in an upper portion of a spectrum, e.g. of the input audio information or of a pre-processed version thereof, in dependence on the encoded lag value.

As an example, by using the selective encoding of gain value or high-frequency energy value, a signaling effort may be reduced.

According to further embodiments according to the second aspect of the invention, the audio encoder is configured to encode the gain value and the high-frequency energy value using a same number of bits, wherein, for example, the gain value is encoded using one bit for the sign and one bit for the magnitude and wherein, for example, the high frequency energy value is encoded using 2 bits.

The inventors recognized that using a same number of bits for an encoding of the gain value and of the high-frequency energy value an interchangeable encoding may be provided, such that a decision what to encode can be taken with respect to the lag value, without having to adapt a number of bits to be encoded.

According to further embodiments according to the second aspect of the invention, the audio encoder is configured to determine separate lag values and/or separate gain values for different audio frames and/or for different audio subframes.

The inventors recognized that frame-wise and/or subframe-wise lag values and/or gain values may improve the coding of the audio information.

According to further embodiments according to the second aspect of the invention, the audio encoder is configured to obtain the lag value and/or the gain value in a transform domain, e.g. using a set of spectral values; e.g. using an analysis of a periodicity within the set of spectral values in a frequency direction.

The inventors recognized that a determination or obtaining of said information may be performed in a computationally efficient manner.

According to further embodiments according to the second aspect of the invention, the audio encoder is configured to perform a long term transientness detection and to selectively set the lag value to zero if an audio frame or audio subframe, e.g. designated by sf, is found to be not long-term transient.

Since the lag value may, for example, be an indicator for a transientness of the frame or subframe, the value may be set to zero in case no transientness is detected. Hence, the encoder may further suspend a filtering or prediction of zero quantized spectral values in the decoder based on the transientness detection, in case no transientness of the frame or subframe is detected.

Further embodiments according to the invention comprise an audio encoder for providing an encoded audio information on the basis of an input audio information, wherein the audio encoder is configured to encode a plurality of quantized spectral values and wherein the audio encoder is configured to encode a high frequency energy value or a high frequency energy delta value. Furthermore, the high frequency energy value or the high frequency energy delta value represents an, e.g. original, e.g. RMS, energy of a plurality of, e.g. spectro-temporally normalized, spectral coefficients at a frequency below, and, for example, adjacent to, a noise filling end frequency or in a frequency region below, and, for example, adjacent to, the noise filling end frequency which were quantized to zero.

As explained before, The high frequency energy value (or the delta e.g. in case of differential entropy coding) may represent an original energy, e.g. the original RMS energy of the spectro-temporally normalized spectral coefficients slightly below the noise filling end frequency (e.g., in the 8-10 kHz frequency range) which were quantized to zero.

To minimize the signaling overhead to convey the high frequency energy value to the decoder, the energy value may be transmitted as a delta e.g. relative to the global gain and noise level product e.g., as a “noise gain normalized” value. This may, for example, be realized by transmitting a rounded scaled result of a logarithm of the ratio between the high frequency energy value and the product of global gain and noise level.

As an example, based on the high frequency energy value or the high frequency energy delta value, in the decoder, the zero quantized spectral coefficients may be reconstructed, e.g. using a gap filling, such that the energy of said zero-quantized coefficients (e.g. of the original audio signal) is at least approximated.

According to further embodiments according to the second aspect of the invention, the audio encoder is configured to logarithmically quantize the high frequency energy value or the high frequency energy delta value.

The inventors recognized that a logarithmic quantization may be performed in a computationally efficient manner.

According to further embodiments according to the second aspect of the invention, the audio encoder is configured to encode a high frequency energy delta value, which describes the energy of a plurality of, e.g. spectro-temporally normalized, spectral coefficients at a frequency below, and, for example, adjacent to, a noise filling end frequency or in a frequency region below, and, for example, adjacent to, the noise filling end frequency which were quantized to zero, relative to a product of a global gain, which is encoded by the audio encoder, and of a noise level, which is encoded by the audio encoder.

The inventors recognized that the encoding of a high frequency energy delta value may, for example, minimize a signaling overhead.

According to further embodiments according to the second aspect of the invention, the audio encoder is configured to obtain a rounded scaled result of a logarithm of a ratio between the high frequency energy value and a product of a global gain and of a noise value, in order to encode the high frequency energy value, e.g. in the form of a high frequency energy delta value.

The inventors realized that the rounded scaled result may be obtained in a computationally efficient manner.

According to further embodiments according to the second aspect of the invention, the audio encoder is configured to determine a quantized high frequency energy delta value according to Ehf_{sf}=1+round(Δ*log₂(EHF_{f}/(GG_{sf}*L_{sf})), wherein EHF is a high frequency energy value, e.g. a HF original RMS energy, e.g of spectral values quantized to zero, wherein GG_{sf} is a global gain, wherein L_{sf} is a noise level, and wherein Δ is a constant.

The inventors recognized that usage of the above formula may allow for an efficient determination of the quantized high frequency energy delta value.

Further embodiments according to the invention comprise a method for providing a decoded audio information on the basis of an encoded audio information, the method comprising filling spectral holes of a decoded set of spectral values, e.g. using a substitution of spectral coefficients quantized to zero on the basis of respective filling values and obtaining a prediction lag information, e.g. a frequency domain long-term-prediction lag value psf, e.g. a prediction lag information indicating a prediction period in a frequency direction, e.g. a spectral (LTP, e.g. Long-Term Prediction) distance value psf, e.g. from a bitstream or from the encoded audio information. Furthermore, the method comprises a switching between a first spectral filling method, e.g. a “noise filling”+FD LTP, in which a frequency filtering or a frequency prediction, e.g. a TNS or a LTP, e.g. a filtering in which a spectral value associated with a first frequency has an influence on a spectral value associated with a second frequency, is used to obtain filling values which are used to fill spectral holes, and one or more further spectral filling methods, e.g. the second spectral filling method or the third spectral filling method, e.g. “gap filling”, in which no frequency filtering and no frequency prediction are used to obtain filling values which are used to fill spectral holes, in dependence on the prediction lag information.

Further embodiments according to the invention comprise a method for providing an encoded audio information on the basis of an input audio information, the method comprising encoding a plurality of quantized spectral values and obtaining, e.g. determining, a lag value, e.g. a FD-LTP lag; e.g. a lag value P_{sf}, which defines a characteristic of a filtering operation, e.g. in a frequency direction, or of a prediction operation, e.g. in a frequency direction, to be performed by an audio decoder for deriving one or more filling values for filling spectral holes. The method further comprises obtaining, e.g. determining, a gain value, e.g. G_{sf}, which defines a characteristic of the filtering operation or of the prediction operation to be performed by an audio decoder for deriving one or more filling values for filling spectral holes and, e.g. selectively, setting, or, for example, changing, the lag value to zero if the gain value, e.g. G_{sf}, is smaller than a threshold value, e.g. β or if an absolute value of the gain value is smaller than a threshold value, to thereby obtain a modified lag value, e.g. p_{sf}=0. Moreover, the method comprises encoding the determined lag value or the modified lag value, wherein, for example, the modified lag value is encoded if the gain value is modified, e.g. using 3 or 4 bits.

Further embodiments according to the invention comprise a computer program for performing any of the above explained methods, when the computer program runs on a computer.

According to further embodiments of the invention, the audio decoder is configured to perform a weighted combination of a noise value associated with the given frequency, and of a spectral value, e.g. a noise value or a filling value, or a processed or unprocessed encoded value, associated with the other frequency or a weighted combination of a filling value associated with the given frequency, and of a spectral value, e.g. a noise value or a filling value, or a processed or unprocessed encoded value, associated with the other frequency in order to obtain the given filling value. Furthermore, the audio decoder is configured to adjust a weight given to the spectral value associated with the other frequency in dependence on whether a noise filling has been applied for the spectral value associated with the other frequency.

Further embodiments comprise an audio decoder for providing a decoded audio information on the basis of an encoded audio information, wherein the audio decoder is configured to fill spectral holes of a decoded set of spectral values. Furthermore, the audio decoder is configured to obtain a prediction gain information; and to switch between a first spectral filling method, in which a frequency filtering or a frequency prediction is used to obtain filling values which are used to fill spectral holes, and one or more further spectral filling methods, in which no frequency filtering and no frequency prediction are used to obtain filling values which are used to fill spectral holes, in dependence on the prediction gain information.

Further embodiments according to the invention comprise an audio encoder for providing an encoded audio information on the basis of an input audio information, wherein the audio encoder is configured to encode a plurality of quantized spectral values. Furthermore, the audio encoder is configured to obtain a gain value which defines a characteristic of a filtering operation or of a prediction operation to be performed by an audio decoder for deriving one or more filling values for filling spectral holes. Moreover, the audio encoder is configured to encode the gain value and to selectively encode a lag value, which defines a characteristic of the filtering operation or of the prediction operation to be performed by an audio decoder for deriving one or more filling values for filling spectral holes, if a quantized gain value or an encoded gain value is non-zero. Alternatively or in addition, the audio encoder is configured to selectively encode a lag value, which defines a characteristic of the filtering operation or of the prediction operation to be performed by an audio decoder for deriving one or more filling values for filling spectral holes, if the gain value is larger than or equal to a threshold value.

Further embodiments according to the invention comprise a method for providing a decoded audio information on the basis of an encoded audio information, the method comprising: filling spectral holes of a decoded set of spectral values, obtaining a prediction gain information and switching between a first spectral filling method, in which a frequency filtering or a frequency prediction is used to obtain filling values which are used to fill spectral holes, and one or more further spectral filling methods, in which no frequency filtering and no frequency prediction are used to obtain filling values which are used to fill spectral holes, in dependence on the prediction gain information.

Further embodiments according to the invention comprise a method for providing an encoded audio information on the basis of an input audio information, the method comprising: encoding a plurality of quantized spectral values, obtaining a gain value which defines a characteristic of a filtering operation or of a prediction operation to be performed by an audio decoder for deriving one or more filling values for filling spectral holes, encoding the gain value, selectively encoding a lag value, which defines a characteristic of the filtering operation or of the prediction operation to be performed by an audio decoder for deriving one or more filling values for filling spectral holes, if a quantized gain value or an encoded gain value is non-zero, or selectively encoding a lag value, which defines a characteristic of the filtering operation or of the prediction operation to be performed by an audio decoder for deriving one or more filling values for filling spectral holes, if the gain value is larger than or equal to a threshold value.

Further embodiments according to the invention comprise, as an example, an audio decoder for providing a decoded audio information on the basis of an encoded audio information, wherein the audio decoder is configured to fill spectral holes of a decoded set of spectral values; wherein the audio decoder is configured to obtain a prediction lag information; wherein the audio decoder is configured to switch between a first spectral filling method, in which a frequency filtering or a frequency prediction is used to obtain filling values which are used to fill spectral holes, and one or more further spectral filling methods, in which no frequency filtering and no frequency prediction are used to obtain filling values which are used to fill spectral holes, in dependence on the prediction lag information, and wherein the one or more further spectral filling methods comprise a usage of random or pseudo-random filling values to fill spectral holes, and/or a copying, e.g. a copying which is independent from the prediction lag information, of non-zero spectral coefficients to fill spectral holes.

Further embodiments according to the invention comprise, as an example, an audio decoder for providing a decoded audio information on the basis of an encoded audio information, wherein the audio decoder is configured to fill spectral holes of a decoded set of spectral values; wherein the audio decoder is configured to obtain a prediction lag information; and wherein the audio decoder is configured to switch between a first spectral filling method, in which a frequency filtering or a frequency prediction is used to obtain filling values which are used to fill spectral holes, and one or more further spectral filling methods, in which the frequency filtering or the frequency prediction is not used to obtain filling values which are used to fill spectral holes, in dependence on the prediction lag information.

Further embodiments according to the invention comprise, as an example, an audio decoder for providing a decoded audio information on the basis of an encoded audio information, wherein the audio decoder is configured to fill spectral holes of a decoded set of spectral values; wherein the audio decoder is configured to obtain a prediction lag information; and wherein the audio decoder is configured to switch between a first spectral filling method, in which a noise filling, that uses random or pseudo random values, with a frequency filtering or a frequency prediction is used to obtain filling values which are used to fill spectral holes, and one or more further spectral filling methods, in which a noise filling, that uses random or pseudo random values, or a tonality based gap filling is used without the frequency filtering or the frequency prediction to obtain filling values which are used to fill spectral holes, in dependence on the prediction lag information.

According to further embodiments of the invention, the audio encoder may, for example, be configured to encode the modified gain value, if the modified gain value was obtained, and to encode the gain value if the modified gain value was not obtained.

### Aspect 3

Further embodiments according to the third aspect of the invention comprise an audio decoder for providing a decoded audio representation on the basis of an encoded audio representation, wherein the audio decoder is configured to fill spectral holes of a decoded set of spectral values, e.g. using a substitution of spectral coefficients quantized to zero on the basis of respective filling values, using respective filling values. Furthermore, the audio decoder is configured to determine a, e.g. final, filling value, e.g. a replacement for c(i); e.g. č(i), using a prediction or filtering, e.g. using a computation rule d*c(i)+G′_{sf}*c(i−P′_{sf}), such that a given filling value, e.g. č(i), which is associated with a given frequency, e.g. with a given frequency bin, is obtained in dependence on another spectral value, e.g. c(i−P′_{sf}), or č (i−P′_{sf}), which is associated with a different frequency, e.g. with a different frequency bin, e.g. with a different frequency bin having a frequency bin index i−P′_{sf}; e.g. with a frequency or frequency bin having a spectral distance P′_{sf} or a spectral distance d_{sf} from the given frequency or from the given frequency bin.

Furthermore, the audio decoder is configured to adapt a filtering strength, (e.g. a weighting of a spectral value associated with the different frequency, e.g. by selectively setting the filtering strength to G′_{sf} or ½G′_{sf}) in dependence on an encoded or quantized spectral value (e.g. a spectral value as it is (originally) determined by the encoded representation of individual spectral values in the encoded audio information; e.g. by a spectral value before a noise filling is applied; e.g. by a spectral value directly after an arithmetic decoding) associated with the different frequency, e.g. with the different frequency bin; e.g. with the different frequency bin having a frequency bin index i−P′_{sf}.

The inventors recognized that filling values may be determined or calculated or obtained using a prediction or filtering based on other spectral values, which are associated with a different frequency. In simple words and as an example, a correlation or a dependency of spectral coefficients e.g. of spectral values of different frequencies, e.g. of different frequency bands, may be exploited.

Consequently, a coding effort may, for example, be reduced by taking advantage of such a correlation and/or a hearing impression may be improved. Hence, using prediction coefficients and/or filtering coefficients, filling values may be determined with a reduced amount of bits needed to be transmitted, while still providing a good representation of an originally encoded audio signal.

Furthermore, the inventors recognized that a decoding of the encoded audio representation may, for example, be improved by adapting the filtering strength in dependence on an encoded or quantized spectral value associated with the different frequency.

As explained before, a filling value, associated with a given frequency, may be determined or obtained or calculated based on, or using a spectral value, which is associated with a different frequency, e.g. in case a prediction lag information is non-zero, and hence, as an example, indicating a transientness of a signal.

As an example, in case a first spectral filling method is chosen, e.g. in case a noise filling with FD-LTP is selected (e.g. if the prediction lag information is non-zero, as an example, if the FD-LTP lag is nonzero), application of a long-term predictive filter in a spectral domain (e.g. the MDCT domain) of the audio transform codec may be performed, during the decoder-side noise filling routine, e.g. depending on whether a “current” coded FD coefficient is zero and on whether a corresponding “previous” coded FD coefficient located at a distance from the current coefficient (e.g. specified by the transmitted prediction lag information, e.g. by the transmitted FD-LTP lag) is zero. As an example, an infinite impulse response (IIR) LTP-like filter is may be used for the filtering.

For example, a filtering strength may be reduced if the spectral value associated with the different frequency is comparatively large, e.g. non-zero. Accordingly, an impact of a large spectral value associated with the different frequency can be reduced, by selectively adapting the filtering strength. Accordingly, it can be avoided that a filling value or a noise value takes an excessively large value.

According to further embodiments according to the third aspect of the invention, the filtering strength determines an impact of the other spectral value, e.g. of c(i−P′_{sf}), onto the given filling value.

Therefore, as an example, the filtering strength may represent a weighting factor of the other spectral value. The inventors recognized that the adaptiveness of such an impact or as an example weighting, of the other spectral value may improve the decoded audio information.

According to further embodiments according to the third aspect of the invention, the audio decoder is configured to adapt the filtering strength in dependence on the spectral value associated with the different frequency as it is, e.g. originally, determined by the encoded representation of individual spectral values in the encoded audio information.

The inventors recognized that using a value which is represented by the encoded representation for an adaptation of the filtering strength allows to use or exploit an information provided by the encoded representation rather than a filtered version thereof, which may, for example, be alternated. It has been found that using such a criterion is more reliable for the selection of a filter strength than using a criterion that is depending on a value that was already preprocessed on the decoder side.

According to further embodiments according to the third aspect of the invention, the audio decoder is configured to adapt the filtering strength in dependence on the spectral value associated with the different frequency before a noise filling is applied.

The inventors recognized that using the spectral value associated with the different frequency before noise filling may allow to adapt the filtering strength based on the information whether the spectral value was quantized to zero or not.

According to further embodiments according to the third aspect of the invention, the audio decoder is configured to adapt the filtering strength in dependence on whether the spectral value associated with the different frequency (or value) is quantized to zero or not.

The inventors recognized that, for example, a different filtering strength may be applied to spectral values quantized to zero than to spectral values not quantized to zero. This may improve the accuracy of a reconstructed spectrum.

According to further embodiments according to the third aspect of the invention, the audio decoder is configured to adapt the filtering strength in dependence on whether a noise filling is applied to the spectral value associated with the different frequency (or value) or not.

The inventors recognized that using this criterion, the filter strength adaptation may be performed based on an information whether a respective spectral value was quantized to zero, e.g. in addition to whether for the respective frequency of the spectral value a noise filling is intended to be performed or was performed. This may comprise usage flags.

According to further embodiments according to the third aspect of the invention, the audio decoder is configured to selectively apply a filtering in a frequency direction or a prediction in a frequency direction for spectral values for which a noise filling is applied, e.g. for each noise-filled zero quantized spectral coefficient c at location i>=P′_{sf}.

As explained before, the inventors recognized that, as an example, zero-quantized spectral values may be approximated or estimated based on or using the filtering or prediction in the frequency direction. Hence, a dependency of spectral values of different spectral values in frequency direction may, for example, be exploited.

According to further embodiments according to the third aspect of the invention, the audio decoder is configured to apply the prediction or the filtering, in order to determine the given, e.g. final, filling value, e.g. č(i), on the basis of a random or pseudo-random noise values, e.g. c(i).

As explained before, the inventors recognized that a random or pseudo random noise value may, for example, be adapted using the prediction or the filtering, in order to calculate a e.g. final filing value that may provide a good approximation for a zero-quantized spectral value of an e.g. original e.g. input spectrum of the audio information.

According to further embodiments according to the third aspect of the invention, the audio decoder is configured to perform a weighted combination of a noise value associated with the given frequency, and of a noise value associated with the other frequency (e.g. a combination d*c(i)+G′_{sf}*c(i−P′_{sf}), with weight d for the noise value c(i) associated with the given frequency, and weight G′_{sf} for the noise value associated with the other frequency, or a combination d*c(i)+½*G′_{sf}*c(i−P′_{sf}), with weight d for the noise value c(i) associated with the given frequency, and weight ½*G′_{sf} for the noise value associated with the other frequency), or a weighted combination of a noise value associated with the given frequency, and of a filling value associated with the other frequency, in order to obtain the given, e.g. final, filling value, e.g. č(i). Furthermore, the audio decoder is configured to adjust a weight, e.g. G′_{sf} or ½*G′_{sf}, given to the noise value associated with the other frequency or the weight, e.g. G′_{sf} or ½*G′_{sf}, given to the filling value associated with the other frequency in dependence on whether a noise filling has been applied for a spectral value associated with the other frequency.

As explained above, the inventors recognized that the e.g. final, filling value, may, for example, be calculated using different frequency dependent quantities, e.g. a noise value associated with the given frequency, or associated with the other frequency, and/or a filling value associated with the other frequency. Hence, an inventive concept may allow to determine or to obtain or to calculate the e.g. final filling value with good flexibility, such that, according to a specific situation, a filing value may be obtain that may be well or even best suitable for a reconstruction of the e.g. original audio information spectrum. Choice of the respective quantity to be used for obtaining the e.g. final filling value may, for example, be performed based on the prediction lag information. Furthermore, the inventors recognized that an adaptation or adjustment of a respective weight of a corresponding noise value or filling value associated with the other frequency may improve the determination of the e.g. final filling value and hence the reconstruction of the audio information.

According to further embodiments according to the third aspect of the invention, the audio decoder is configured to determine a spectral distance, e.g. P′_{sf}, between the filling value associated with the given frequency and the other spectral value associated with the different frequency on the basis of an encoded information, e.g. an encoded value, describing the spectral distance, which is included in the encoded representation of the audio information.

Based on the spectral distance, the decoder may, for example, decide whether to use the prediction or filtering for the determination of the filing value. The distance may be associated with the before explained prediction lag information and/or prediction lag value. Furthermore, a parameter, e.g. a filter order, of a corresponding prediction or filtering may be determined or set or obtained based on the distance. The inventors recognized that the spectral distance may be used in order to improve the determination of the spectral filling values.

According to further embodiments according to the third aspect of the invention, the audio decoder is configured to determine a weight, e.g. d, which is applied to the noise value associated with the given frequency, on the basis of a gain information, e.g. a gain value, e.g. g_{sf}, which is included in the encoded representation of the audio information, wherein the weight, which is applied to the noise value associated with the given frequency, is, as an example, a positive value, e.g. in a range between 0.5 and 1.

As explained before, the inventors recognized that, for example, a respective noise value associated with the given frequency may be adapted with the weight that is determined in dependence on the gain information. This may allow to shape said noise value to improve its matching with a corresponding spectral value of the originally encoded audio information.

According to further embodiments according to the third aspect of the invention, the audio decoder is configured to determine a weight, e.g. G_{sf}=(−1)^{Ssf}*(3+2*g_{sf})/8, or ½*G_{sf}, which is applied to the noise value, e.g. c(i−P′_{sf}), associated with the other frequency, or to the filling value associated with the other frequency, in dependence on a gain information, e.g. a gain value, e.g. g_{sf}, which is included in the encoded representation of the audio information, wherein the weight, which is applied to the noise value associated with the given frequency, is, for example, a positive or negative value, e.g. having an absolute value between 0.25 and 0.75.

As explained before, the inventors recognized that, for example, a respective noise value, or a respective filling value associated with the other frequency may be adapted with the weight that is determined in dependence on the gain information. This may allow to shape said noise or filling value to improve its matching with a corresponding spectral value of the originally encoded audio information.

According to further embodiments according to the third aspect of the invention, the audio decoder is configured to determine the weight, e.g. G_{sf}=(−1)^{Ssf}*(3+2*g_{sf})/8, or ½*G_{sf}, which is applied to the noise value, e.g. c(i−P′_{sf}), associated with the other frequency, or to the filling value associated with the other frequency, in dependence on a sign information, e.g. a sign value, e.g. S_{sf}, which is included in the encoded representation of the audio information.

As explained before, the inventors recognized that, for example, using a sign information, e.g. a 1-bit information, the weight determination may, for example, be improved. As an example, the sign information may allow an adaptation of a phase relation of the e.g. final filling value with respect to the noise value and/or the filling value associated with the other frequency, it may be based on.

According to further embodiments according to the third aspect of the invention, the audio decoder is configured to determine the given filling value č(i) according to č(i)=d*c(i)+G′_{sf}*c(i−P′_{sf}), if the coefficient c(i−P′_{sf}) was obtained using a noise filling, e.g. if the coefficient c(i−P′_{sf}) at a spectral location i−P′_{sf} was marked as a noise filled zero-quantized spectral coefficient in a previous processing and according to č(i)=d*c(i)+½*G′_{sf}*c(i−P′_{sf}), if the coefficient c(i−P′_{sf}) was not obtained using a noise filling, e.g. if the coefficient c(i−P′_{sf}) at a spectral location i−P′_{sf} was not marked as a noise filled zero-quantized spectral coefficient in a previous processing. c(i) designates a spectral coefficient which is obtained using a noise filling and having a spectral index i, d designates an attenuation coefficient, G′_{sf} designates a weight which is based on a gain value that is included in the encoded audio representation, c(i−P′_{sf}) designates a spectral coefficient, which may, for example, be obtained using a noise, or which may, for example, be obtained without using a noise filling, and which may, for example, be obtained using a prediction or a filtering, having a spectral index i−P′_{sf}, and P′_{sf} is a prediction parameter or a filtering parameter which is based on a prediction parameter information that is included in the encoded audio representation.

The inventors recognized that using the above equations, an efficient filling value may be determined.

According to further embodiments according to the third aspect of the invention, the audio decoder is configured to obtain the prediction parameter or filtering parameter P′_{sf} according to P′_{sf}=p_{sf}+B, wherein p_{sf} is a lag index which is included in the encoded audio representation, and wherein B is a constant, wherein B may, for example, be equal to a number of bits which are used to encode p_{sf}, wherein p_{sf} may, for example, take values between 0 and 2^{B}−1. Alternatively or in addition, the audio decoder is configured to obtain the weight G′_{sf} according to G′_{sf}=(−1)^{Ssf}*(3+²*g_{sf})/8, wherein S_{sf} is a binary value which is included, e.g. in an encoded form, in the encoded representation and wherein g_{sf} is a binary value which is included, e.g. in an encoded form, in the encoded representation.

Alternatively or in addition the audio decoder is configured to obtain the attenuation coefficient d according to d=(7.5−g_{sf})/8, wherein g_{sf} is a binary value which is included, e.g. in an encoded form, in the encoded representation.

As an example, constant B may be chosen according to whether a given frame has more than one subframe. The inventors recognized that using the above equations a good trade-off between signaling effort, complexity and effectivity of the decoding may be achieved.

According to further embodiments according to the third aspect of the invention, the audio decoder is configured to mark noise-filled zero-quantized spectral coefficients, and the audio decoder is configured to selectively use a reduced filtering strength, e.g. ½*G′_{sf}, which is applied to spectral coefficients which are not marked, as noise-filled zero-quantized spectral coefficients.

The inventors recognized that a reduction of the filtering strength for unmarked spectral coefficients may, for example, improve the reconstruction or approximation of the original spectrum of the audio information.

According to further embodiments according to the third aspect of the invention, the audio decoder is configured to perform the following processing for a plurality of subframes (sf):
1. Set P′_{sf}=p_{sf}+B, G′_{sf}=(−1)^{Ssf}*(3+²*g_{sf})/8 and d=(7.5−g_{sf})/8, wherein, for example, p_{sf}>0;
2. perform, e.g. conventional, noise filling, e.g. using l_{sf}; e.g. using random or pseudo-random noise values which are used to substitute spectral coefficients which are zero, wherein a noise intensity may, for example, be determined by a noise intensity value l_{sf}], and mark, e.g. all, or a plurality of, noise-filled zero-quantized spectral coefficients
3. for a plurality of, or even for each, noise-filled zero-quantized spectral coefficient c at location i>=P′_{sf}, e.g. ordered by increasing i, do:
4. if the coefficient c at location i−P′_{sf} was marked in step 2, replace c(i) by d*c(i)+G′_{sf}*c(i−P′_{sf}); else
5. replace c(i) by d*c(i)+½*G′_{sf}*c(i−P′_{sf})

The inventors recognized that using the above steps a good trade-off between signaling effort, complexity and effectivity of the decoding may be achieved.

Further embodiments according to the third aspect of the invention comprise an audio decoder for providing a decoded audio representation on the basis of an encoded audio representation, wherein the audio decoder is configured to determine a processed spectral value, e.g. a spectral coefficient, using a prediction or filtering, e.g. using a temporal noise shaping (TNS) and/or using a frequency-domain noise shaping (FD-LTP), such that a given processed spectral value, which is associated with a given frequency, e.g. with a given frequency bin, is obtained in dependence on another spectral value, e.g. c(i−P′_{sf}), or č(i−P′_{sf}), which is associated with a different frequency, e.g. with a different frequency bin, e.g. with a different frequency bin having a frequency bin index i−P′_{sf}; e.g. with a frequency or frequency bin having a spectral distance P′_{sf} or a spectral distance d_{sf} from the given frequency or from the given frequency bin.

Furthermore, the audio decoder is configured to adapt a filtering strength, e.g. a weighting of a spectral value associated with the different frequency, e.g. by selectively setting the filtering strength to G′_{sf} or ½G′_{sf}, in dependence on an encoded or quantized or signaled spectral value, e.g. a spectral value as it is (originally) determined by the encoded representation of individual spectral values in the encoded audio information; e.g. by a spectral value before a noise filling is applied; e.g. by a spectral value directly after an arithmetic decoding, associated with the different frequency, e.g. with the different frequency bin; e.g. with the different frequency bin having a frequency bin index i−P′_{sf}.

The inventors recognized that a processed spectral value may, for example, be determined or calculated or obtained using a prediction or filtering based on other spectral values, which are associated with a different frequency. As explained before, a correlation or a dependency of spectral coefficients e.g. of spectral values of different frequencies, e.g. of different frequency bands, may be exploited, for example not only for filling values but for processed spectral values.

Consequently, a coding effort may, for example, be reduced by taking advantage of such a correlation. Hence, using prediction coefficients and/or filtering coefficients, spectral values may be determined with a reduced amount of bits needed to be transmitted, while still providing a good representation of an originally encoded audio signal.

Furthermore, the inventors recognized that a decoding of the encoded audio representation may be improved by adapting the filtering strength in dependence on an encoded or quantized spectral value associated with the different frequency.

According to further embodiments according to the third aspect of the invention, the audio decoder is configured to adapt the filtering strength to, e.g. selectively, reduce a contribution, e.g. a weighting in the prediction or filtering, of a nonzero-quantized, and possibly previously processed, e.g. previously TNS synthesis filtered, e.g. lower-frequency, spectral coefficients included in the prediction or filtering, e.g. when compared to a contribution (e.g. a weighting in the prediction or filtering) of zero-quantized (and possibly previously processed, e.g. previously TNS synthesis filtered)(e.g. lower-frequency) spectral coefficients included in the prediction or filtering.

According to further embodiments according to the third aspect of the invention, the audio decoder is configured to selectively adapt, e.g. reduce the filtering strength (e.g. of a temporal noise shaping filter e.g. of a frequency-domain long-term-prediction; e.g. of a filter which provides a filtered current spectral coefficient on the basis of a weighted combination, e.g. d*c(i)+att*G′_{sf}*c(i−P′_{sf}), of an unfiltered current spectral coefficient (e.g. c(i)) and of a filtered or unfiltered previous spectral coefficient (e.g. c(i−P′_{sf})), wherein, for example, d is a weight of the unfiltered current spectral coefficient, att is an attenuation factor that describes the adaptation of the filtering strength, G′_{sf} is a normal weight of the filtered or unfiltered previous spectral coefficient, and P′_{sf} describes a spectral distance between the current spectral coefficient and the previous spectral coefficient) if a current spectral coefficient (e.g. a spectral coefficient c(i) at a current spectral position designated by a spectral index I, e.g. a spectral coefficient c(i) at a current spectral position before application of the filtering; e.g. a transmitted current spectral coefficient or an encoded current spectral coefficient or a quantized current spectral coefficient) is zero, e.g. has been quantized to zero, and a previous spectral coefficient, e.g. a spectral coefficient c(i−P′_{sf}); e.g. represented by the “another spectral value”, has not been encoded as zero or has not been quantized to zero, e.g. at the side of an audio encoder.

According to further embodiments according to the third aspect of the invention, the audio decoder is configured to selectively reduce the filtering strength to a value between 0.25 and 0.75, or, preferably, to a value between 0.4 and 0.6, or, preferably, to a value of 0.5, in order to adapt the filtering strength.

According to further embodiments according to the third aspect of the invention, the audio decoder is configured to selectively, reduce the filtering strength, e.g. by downscaling filtering coefficients or prediction coefficients; e.g. by downscaling the filtering coefficients or filtering coefficients using a common downscaling factor, of a filtering, which considers a plurality, e.g. d_{sf}, of previous spectral coefficients, e.g. c(i−1) to c(i−d_{sf}), in dependence on values, e.g. encoded values or quantized values or signaled values, of a plurality of, e.g. d_{sf} previous, e.g. encoded or quantized or signaled, spectral coefficients, e.g. a plurality of the previous spectral coefficients, if the current spectral coefficient, e.g. c(i), is encoded or quantized as zero.

According to further embodiments according to the third aspect of the invention, the audio decoder is configured to selectively reduce the filtering strength (wherein the filtering strength may, for example, be defined by a plurality of filter weights, wherein the filter weights may, for example, be selectively down-scaled, e.g. using a common down-scaling factor that may, for example, be equal to ½, in case of a reduction of the filtering strength) if the current spectral coefficient, e.g. c(i), is encoded or quantized or signaled as zero and if all previous spectral coefficients considered in the filtering, e.g. c(i−1) to c(i−(d_{sf}−1)), except for one previous spectral coefficient considered in the filtering, e.g. c(i−d_{sf}); e.g. the spectral coefficient considered in the filtering having the largest spectral distance from the current spectral coefficient, are encoded or quantized or signaled as zero, and to use a non-reduced filtering strength otherwise.

According to further embodiments according to the third aspect of the invention, the audio decoder is configured to obtain a filtered current spectral coefficient, e.g. c(i), having spectral index i in dependence on a plurality of, e.g. encoded or quantized or signaled or filtered or predicted, previous spectral coefficients, e.g. c(i−1) to c(i−d_{sf}), having spectral indices i−d_{sf} to i−1 using the filtering or prediction.

Furthermore, the audio decoder is configured to selectively reduce the filtering strength if, e.g. if and only if, one or more, e.g. signaled, spectral coefficients, or all spectral coefficients, having spectral indices i−d_{sf}+1 to i have been quantized or encoded or signaled as zero, and if a spectral coefficient having spectral index i−d_{sf} has not been quantized or encoded or signaled as zero, wherein, for example, d_{sf} is equal to a filter order or prediction order.

According to further embodiments according to the third aspect of the invention, filter coefficients which are associated with spectral coefficients having spectral indices between i−d_{sf}+1 and i−1 are equal to zero.

According to further embodiments according to the third aspect of the invention, the audio decoder is configured to use encoded or quantized or signaled spectral coefficients, e.g. before a noise filling, for deciding about the filtering strength. Moreover, the audio decoder is configured to use preprocessed spectral coefficients, e.g. after an application of a noise filling and/or after an application of a frequency-domain long-term prediction, as an input for the filtering or prediction.

Further embodiments according to the third aspect of the invention comprise a method for providing a decoded audio representation on the basis of an encoded audio representation, the method comprising filling spectral holes of a decoded set of spectral values, e.g. using a substitution of spectral coefficients quantized to zero on the basis of respective filling values, using respective filling values. The method further comprises determining a, e.g. final, filling value, e.g. a replacement for c(i); e.g. č(i), using a prediction or filtering, e.g. using a computation rule d*c(i)+G′_{sf}*c(i−P′_{sf}), such that a given filling value, e.g. č(i), which is associated with a given frequency, e.g. with a given frequency bin, is obtained in dependence on another spectral value, e.g. c(i−P′_{sf}), or č (i−P′_{sf}), which is associated with a different frequency, e.g. with a different frequency bin, e.g. with a different frequency bin having a frequency bin index i−P′_{sf}; e.g. with a frequency or frequency bin having a spectral distance P′_{sf} or a spectral distance d_{sf} from the given frequency or from the given frequency bin. Moreover, the method comprises adapting a filtering strength, e.g. a weighting of a spectral value associated with the different frequency, e.g. by selectively setting the filtering strength to G′_{sf} or ½G′_{sf}, in dependence on an encoded or quantized spectral value (e.g. a spectral value as it is (originally) determined by the encoded representation of individual spectral values in the encoded audio information; e.g. by a spectral value before a noise filling is applied; e.g. by a spectral value directly after an arithmetic decoding) associated with the different frequency, e.g. with the different frequency bin; e.g. with the different frequency bin having a frequency bin index i−P′_{sf}.

Further embodiments according to the third aspect of the invention comprise a method for providing a decoded audio representation on the basis of an encoded audio representation, the method comprising determining a processed spectral value, e.g. a spectral coefficient, using a prediction or filtering, such that a given processed spectral value, which is associated with a given frequency, e.g. with a given frequency bin, is obtained in dependence on another spectral value, e.g. c(i−P′_{sf}), or č (i−P′_{sf}), which is associated with a different frequency, e.g. with a different frequency bin, e.g. with a different frequency bin having a frequency bin index i−P′_{sf}; e.g. with a frequency or frequency bin having a spectral distance P′_{sf} or a spectral distance d_{sf} from the given frequency or from the given frequency bin. Furthermore, the method comprises adapting a filtering strength, e.g. a weighting of a spectral value associated with the different frequency, e.g. by selectively setting the filtering strength to G′_{sf} or ½G′_{sf}, in dependence on an encoded or quantized spectral value, e.g. a spectral value as it is (originally) determined by the encoded representation of individual spectral values in the encoded audio information; e.g. by a spectral value before a noise filling is applied; e.g. by a spectral value directly after an arithmetic decoding, associated with the different frequency, e.g. with the different frequency bin; e.g. with the different frequency bin having a frequency bin index i−P′_{sf}.

Further embodiments according to the third aspect of the invention comprise a computer program for performing any of the above methods, when the computer program runs on a computer.

### BRIEF DESCRIPTION OF THE DRAWINGS

Embodiments of the present invention will be detailed subsequently referring to the appended drawings, in which:

FIG. 1 shows a schematic view of an audio decoder for providing a decoded audio information on the basis of an encoded audio information according to embodiments according to the first aspect of the invention;

FIG. 2 shows a schematic example of spectral envelopes according to conventional concepts;

FIG. 3 shows a schematic example of spectral envelopes (intensity over frequency) according to the first aspect of the invention;

FIG. 4 shows a schematic view of an audio decoder with additional optional features, according to embodiments according to the first aspect of the invention;

FIG. 5 shows a schematic view of an audio encoder for providing an encoded audio information on the basis of an input audio information according to embodiments according to the first aspect of the invention;

FIG. 6 shows a schematic view of an audio encoder with additional optional features, according to embodiments according to the first aspect of the invention;

FIG. 7 shows an example for a functionality of an encoder, according to embodiments according to the first aspect of the invention;

FIG. 8 shows a schematic view of an audio decoder for providing a decoded audio information on the basis of an encoded audio information according to embodiments according to the second aspect of the invention;

FIG. 9 shows a schematic view of a first spectral filling method unit according to embodiments according to the second aspect of the invention.

FIG. 10 shows a schematic view of an audio decoder with additional optional features according to embodiments according to the second aspect of the invention;

FIG. 11 shows a schematic view of an audio encoder for providing an encoded audio information on the basis of an input audio information according to embodiments according to the second aspect of the invention;

FIG. 12 shows a schematic view of another audio encoder for providing an encoded audio information on the basis of an input audio information according to embodiments according to the second aspect of the invention.

FIG. 13 shows a schematic view of an audio decoder for providing a decoded audio information on the basis of an encoded audio information according to embodiments according to the third aspect of the invention;

FIG. 14 shows a schematic view of an audio decoder with additional optional features, according to embodiments according to the third aspect of the invention;

FIG. 15 shows an example for a functionality of a decoder, according to embodiments according to the third aspect of the invention;

FIG. 16 shows a schematic view of an audio decoder with additional optional features, according to embodiments according to the third aspect of the invention;

FIG. 17 shows a block diagram of a method for providing a decoded audio information on the basis of an encoded audio information according to an embodiment according to the first aspect of the invention;

FIG. 18 shows a block diagram of a method for providing an encoded audio information on the basis of an input audio information according to an embodiment according to the first aspect of the invention;

FIG. 19 shows a block diagram of a method for providing a decoded audio information on the basis of an encoded audio information according to an embodiment according to the second aspect of the invention;

FIG. 20 shows a block diagram of a method for providing an encoded audio information on the basis of an input audio information according to an embodiment according to the second aspect of the invention;

FIG. 21 shows a block diagram of a first method for providing a decoded audio information on the basis of an encoded audio information according to an embodiment according to the third aspect of the invention;

FIG. 22 shows a block diagram of a second method for providing a decoded audio information on the basis of an encoded audio information according to an embodiment according to the third aspect of the invention;

FIG. 23 shows an example plot of the time-domain effect of FD-LTP filtering of a pseudo-random noise spectrum subjected to an inverse transform according to embodiments of the invention;

FIG. 24 shows a schematic example for a filtering strength reduction according to embodiments of the invention; and

FIG. 25 shows a schematic example for a an adaptive filtering according to embodiments of the invention.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more throughout explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

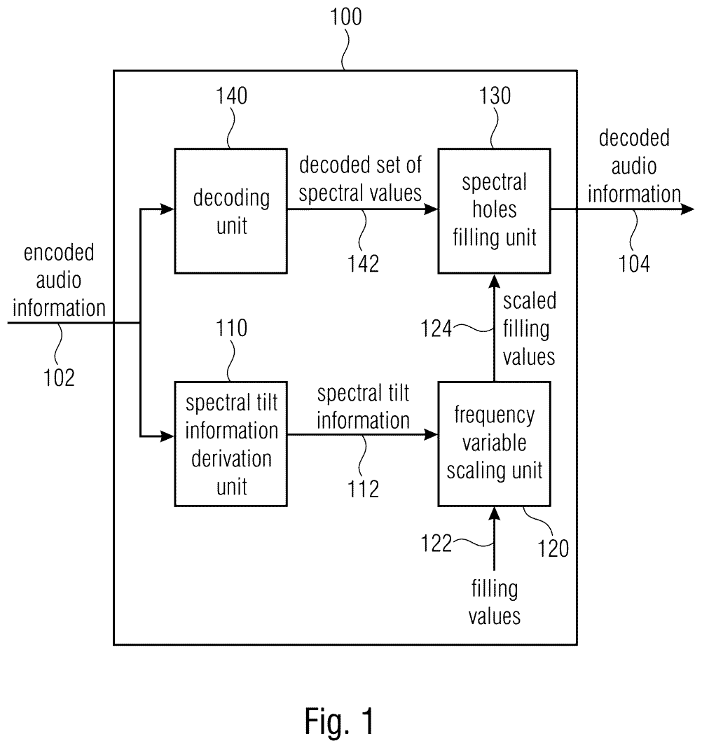

FIG. 1 shows a schematic view of an audio decoder for providing a decoded audio information on the basis of an encoded audio information according to embodiments according to the first aspect of the invention. FIG. 1 shows audio decoder 100 with a spectral tilt information derivation unit 110, a frequency variable scaling unit 120 and a spectral holes filling unit 130. Optionally, as shown in the example of FIG. 1 the decoder 100 may comprise a decoding unit 140.

The decoder 100 may be provided with an encoded audio information 102. From, or using the encoded audio information, the spectral tilt information derivation unit 110 may be configured to derive or determine or calculate a spectral tilt information 112.

Optionally, the decoder 100 may be configured to decode the encoded audio information 102 or a portion of the encoded audio information using the optional decoding unit 140, in order to obtain a decoded set of spectral values 142. However, it is to be noted that the decoded set of spectral values 142 may as well be provided from an external device.

Using the frequency variable scaling unit, the decoder 100 may be configured to apply a frequency variable scaling, a spectral tilt of which is determined by the spectral tilt information 120, to filling values 122. The filling values 122 may, for example, be gap fill coefficients or noise values of a noise filing or gap filling values of an intelligent gap filling (e.g. spectral values from a different frequency or frequency band). Hence, the frequency variable scaling unit may provide scaled filling values 124 to the spectral holes filling unit 130.

Using the spectral holes filling unit 130, the decoder 100 may be configured to use modified filling values 122, 124 in order to fill spectral holes of the decoded set of spectral values 142.

Based on the spectral hole filling, a decoded audio information 104 may be provided.

It is to be noted, that the frequency variable scaling may, for example, be performed after filling spectral holes of the set decoded set of spectral values 142, wherein the holes may be filled with the unmodified filling values 122. The scaling may then, optionally, be applied to the already modified (e.g. set decoded set of spectral values 142 filled with filling values 122) set of spectral values. As an example, the decoded audio information may hence be provided based on the frequency variable scaling unit 120, wherein the frequency variable scaling unit may receive its input from the spectral holes filling unit 130.

As explained before, an adaptation of a spectral envelope of decoded spectral values, e.g. of decoded spectral coefficients may allow to better reconstruct, or approximate an original spectral envelope of the audio information.

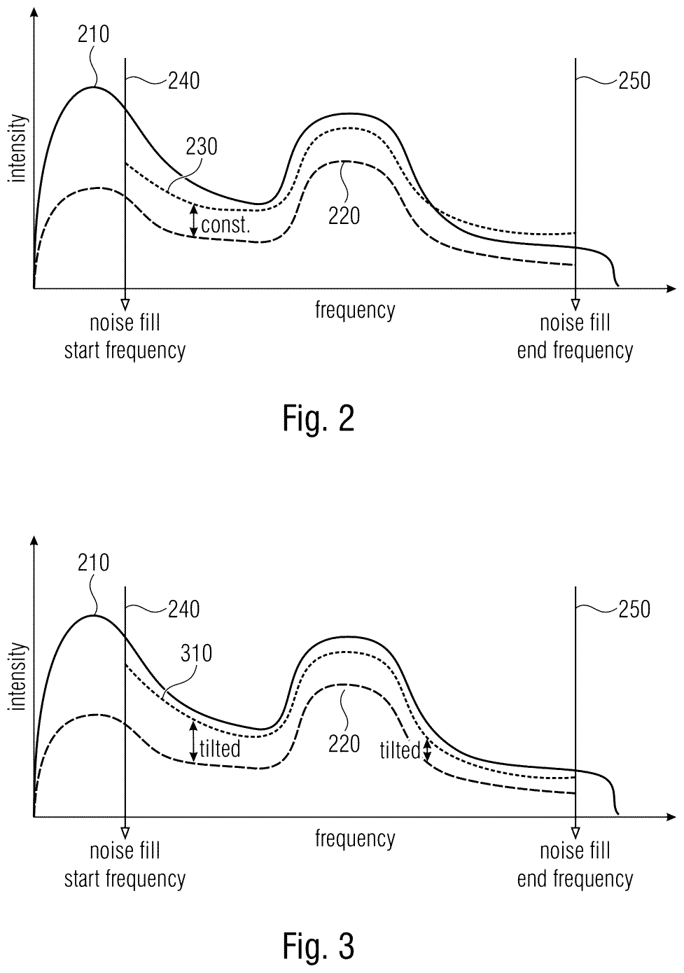

This aspect will be further explained in the context of FIGS. 2 and 3.

FIG. 2 shows a schematic example of spectral envelopes (intensity over frequency) according to conventional concepts. An example of an original spectral envelope e.g. representing the original spectral values; e.g. representing the original spectral coefficients of an audio information or of a frame or of a subframe of the audio information is shown with line 210. The dashed line 220 is offset downwards for better visibility of all curves and represents an example for a masking envelope, e.g. a masking threshold, e.g. a noise shaping envelope, that may be associated with scaling factors. Line 230 may show an example of a reconstructed noise envelope according to conventional concepts. According to the masking envelope 220 noise filling may be performed for signal portions of frequencies between a noise filling start frequency 240 and a noise filling end frequency 250. As shown in FIG. 2, the reconstructed envelope 230 exceeds the original spectral envelope 210 at high frequencies, thus potentially causing audible noise after decoding, while it remains significantly below the original spectral envelope 120 at lower frequencies, thus likely causing insufficient gap-fill energy and audible spectral holes. It can be seen that a distance between the masking envelope 210 and the effective reconstructed noise envelope 230 may be constant (thin double arrow) and, therefore, not follow the original spectral envelope 210 accurately. This may, for example, be caused, e.g. inter alia, by a pre-emphasis tilt during the calculation of the masking envelope.

Using embodiments according to the invention, e.g. a decoder as shown in FIG. 1 a reconstructed noise envelope 310, as shown in FIG. 3 may be achieved. FIG. 3 shows a schematic example of spectral envelopes (intensity over frequency) according to the first aspect of the invention.

Hence, using a spectral tilt information, e.g. spectral tilt information 112 as shown in FIG. 1, the reconstructed noise envelope 310 may be corrected to reduce a difference between the original signal envelope 210 and the reconstructed envelope 310.

With respect to FIGS. 2 and 3 it is to be noted that the masking envelope 220 may, for example, be an approximation or an interpolation based on a plurality of scaling factors of different frequency bands.

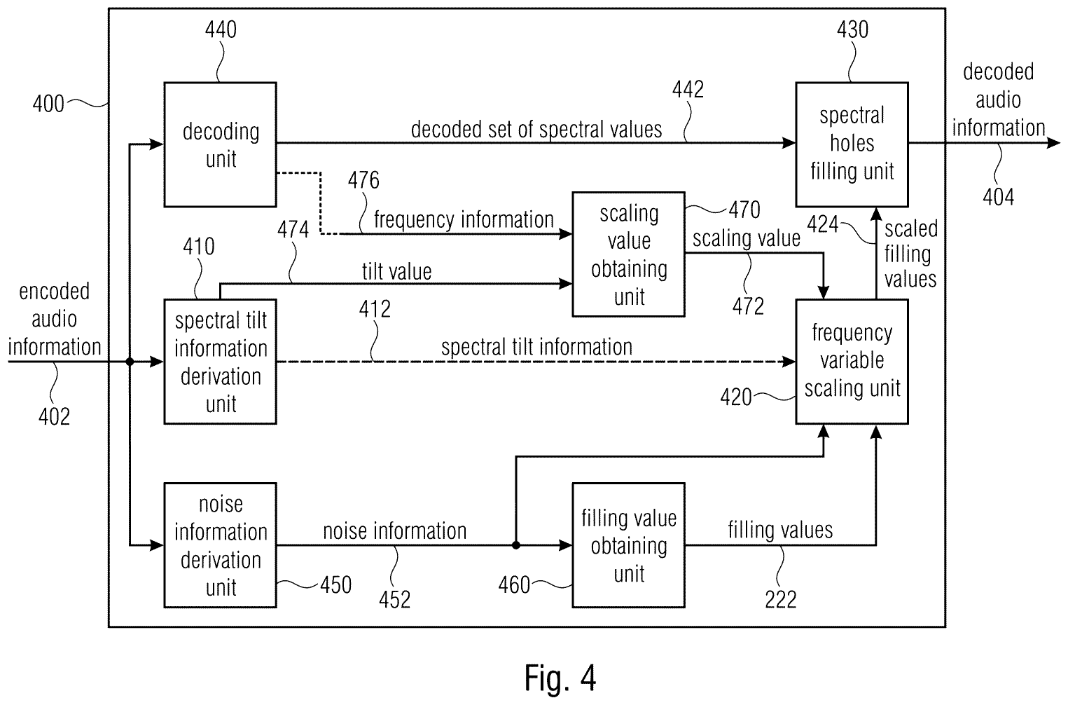

FIG. 4 shows a schematic view of an audio decoder with additional optional features, according to embodiments according to the first aspect of the invention. FIG. 4 shows audio decoder 400 comprising a spectral tilt information derivation unit 410, a frequency variable scaling unit 420, a spectral holes filling unit 430 and an optional decoding unit 440, with functionalities, as an example, according to audio decoder 100 from FIG. 1.

As an optional feature, decoder 400 comprises a noise information derivation unit 450. The noise information derivation unit 450 may be configured to derive a noise information 450 from the encoded audio information 402. The noise information may be or may comprise, for example, a noise level information, e.g. L_{sf} and/or a noise intensity information.

Furthermore, the decoder 400 may optionally comprise filling value obtaining unit 460, which may be configured to obtain or to determine or to calculate the filling values 422 using the noise information 450, e.g. the noise level information and/or the noise intensity information. Hence, the filling values 422 may be noise filling values, wherein an energy of a respective noise filling value may be set according to the noise level information.

Optionally, the frequency variable scaling unit 420 may be configured to apply the frequency variable scaling, such that the frequency variable scaling describes a linear decrease of intensity with increasing frequency on a logarithmic intensity scale.

As another optional feature, the spectral tilt information 412 may describe a spectral tilt in a logarithmic domain.

As another optional feature, the decoder 400 may comprise a scaling value obtaining unit 470. The scaling value obtaining unit may, for example, be configured to obtain scaling values 472 for the frequency-variable scaling. The decoder 400, e.g. the scaling value obtaining unit 470 of the decoder 400 may determine or obtain or derive the scaling values 472 in a logarithmic domain. However it is to be noted that a conversion from logarithmic domain to linear domain may be performed for any value, e.g. spectral value, or mathematic operation. Hence, as an example, the scaling values 472 for the frequency-variable scaling from the logarithmic domain to a linear domain.

As an example, the scaling values 472 may, for example, be derived or obtained or calculated based on or using or in dependence on a product a tilt value 474 which is based on the tilt information 412, and of a frequency information 476, e.g. a frequency value.

As an example, the tilt value 474 may, for example, be provided by the spectral tilt information derivation unit, e.g. based on the spectral tilt information 412, or for example, directly from the encoded audio information 402. In some embodiments, the spectral tilt information 412 may, for example, be the tilt value 474. The frequency information may, for example, be a frequency value or a frequency index, describing or providing an information about the frequency of a spectral value or coefficient that is to be scaled.

As an example, the frequency variable scaling unit 420 may be provided with the information of the spectral tilt information 412 via the scaling value 472 which is based on the tilt value 474.

Optionally, the scaling value obtaining unit 470 may be configured to obtain a plurality of scaling values for the frequency variable scaling associated with different frequency bands.

As another optional feature, the frequency information 476 may, for example, comprise start frequencies center frequencies of respective frequency bands of which spectral values, e.g. spectral coefficients, e.g. noise values or gap filling values, e.g. filling values are to be scaled. Hence, the scaling value obtaining unit may be configured to using start frequencies of respective frequency bands or using center frequencies of respective frequency band to obtain the scaling values 472.

Analogously, the frequency information 476 may comprise start frequency bin indices or center frequency bin indices of respective frequency bands for obtaining the scaling values 472.

As another optional feature, the scaling values 472 may, for example, comprise frequency-independent noise scaling values and/or frequency-variable noise scaling values, wherein the frequency-variable noise scaling values may be determined based on the tilt value 474, e.g. spectral tilt. Optionally, the decoder 400 may be configured, e.g. the frequency variable scaling unit 420 of decoder 200, to obtain a filling value, e.g. a scaled filling value 424 using a multiplication of a noise value (the noise information may, for example, comprise a noise value), of a frequency-independent noise scaling value and of a frequency-variable noise scaling value. The noise value may, for example, be a random noise value or a pseudo-random noise value and may be determined by the noise information derivation unit 450.

As another optional feature, the audio decoder 400 may be configured to apply a scaling, which is based on a masking envelope, to the decoded spectral values 442 and to the filling values 222.

In general, the audio decoder may, for example, be configured to obtain a masking envelope from the encoded audio information. The masking envelop may, for example, be associated with scaling factors, the masking envelope may, for example, be an interpolation of scaling factors.

Hence, a scaling, e.g. based on the masking envelope, may, for example, be applied to the full spectrum e.g. decoded spectral values that were not quantized to zero, and spectral values that were quantized to zero and filled with filling values (or, for example, first scaling the filling values and then filling them in the spectral “holes”).

Optionally, the spectral tilt information derivation unit 410 may, for example, be configured to obtain the spectral envelope from the encoded audio information 402 and may be configured to provide an information about the spectral envelope using the spectral tilt information which may be used to adapt the full spectrum.

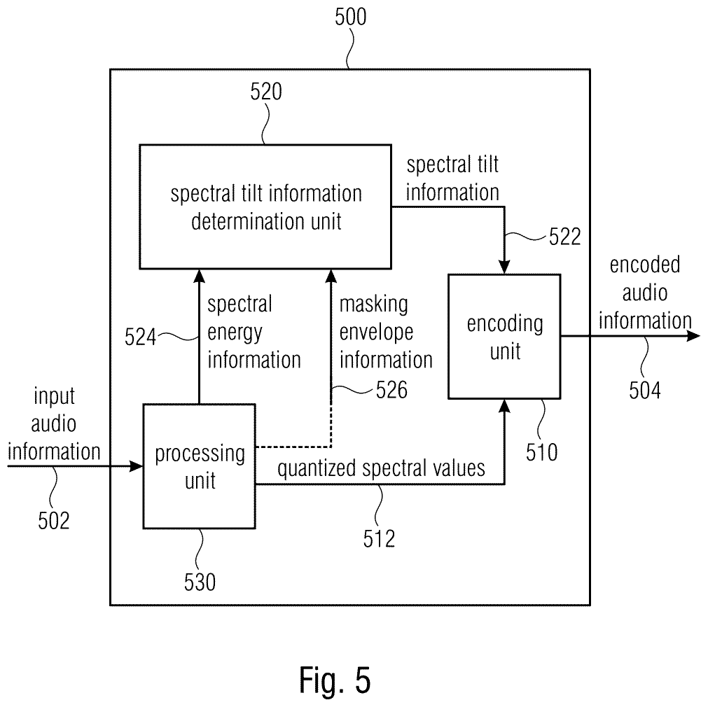

FIG. 5 shows a schematic view of an audio encoder for providing an encoded audio information on the basis of an input audio information according to embodiments according to the first aspect of the invention. FIG. 5 shows encoder 500 comprising an optional encoding unit 510. The encoding unit may, for example, be configured to encode a plurality of quantized spectral values 512. Encoder 500 further comprises an optional spectral tilt information determination unit 520. The spectral tilt information determination unit 520 may be configured to determine a spectral tilt information 522 on the basis of a spectral energy information 524 and a masking envelope information 526. Optionally, the masking envelope information 526 may be provided by the processing unit 530, e.g. based on the input audio information. As an example, a masking envelope may be calculated in dependency on the input audio information. As another example, a fixed masking envelop may be used. The spectral tilt information may, for example, describe an average variation of a difference between a spectral energy of an input audio signal and a masking envelope.

As an optional example, encoder 500 may comprise a processing unit 530 which may be configured to provide the spectral energy information 524, e.g. a spectral energy, and the quantized spectral values 512 to the spectral tilt information determination unit 520 and respectively the encoding unit 510, based on the input audio information 502, e.g. an input audio data.

Furthermore, the encoding unit 510 may receive the spectral tilt information 522 and may be configured to encode the spectral tilt information. As an example, the encoder, e.g. the encoding unit 510 of encoder 500 may be configured to provide an encoded audio information 504, for example comprising an encoded representation of the quantized spectral values 512 and an encoded representation of the spectral tilt information 522.

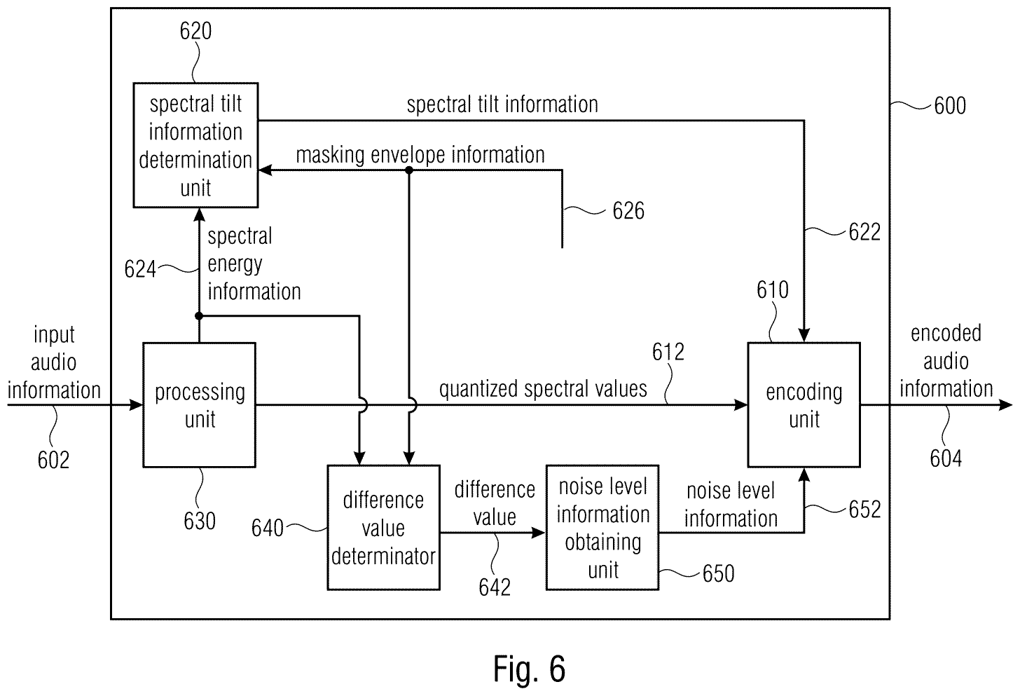

FIG. 6 shows a schematic view of an audio encoder with additional optional features, according to embodiments according to the first aspect of the invention. FIG. 6 shows encoder 600 comprising a spectral tilt information determination unit 620, an optional processing unit 630 and an encoding unit 610 (and corresponding input/output signals), as explained in the context of FIG. 5.

As another optional feature, the spectral tilt information determination unit 620 may optionally be configured to determine the spectral tilt information 622, such that the spectral tilt information describes a frequency variation of a difference between the spectral energy information 624 and the masking envelope information 626 over frequency.

Furthermore, the spectral tilt information 622 may, for example, describe a line function with a spectral tilt in a logarithmic domain. As explained before, the line function may allow to adjust a tilt of a reconstructed spectrum to better approximate an original spectrum of the input audio information 602.

As another optional feature, the spectral tilt information determination unit may, for example, be configured to determine the spectral tilt information in a logarithmic domain.

As another optional feature, the spectral tilt information determination unit 620 may be configured to determine the spectral tilt information 622 on the basis of a difference between a logarithmized representation of a spectral envelope and a logarithmized representation of a masking envelope. Accordingly, the spectral energy information 624 may comprise an information about the spectral envelope of the input audio information 602, as an example, in a logarithmized form and the masking envelope information 626 may, for example, comprise a masking envelope, e.g. comprising scaling factors, for example in a logarithmized form.

Again, it is to be noted, that in general the encoder may perform any calculations in a logarithmic and/or in a linear domain. Hence, values and or calculations may be transformed in one or the other domain.

As another optional feature, the spectral tilt information determination unit 620 may, for example, be configured to obtain the spectral tilt information 622 using a linear regression.

The inventors recognized that using a linear regression a computational inexpensive calculation with good accuracy for the tilt information may be performed.

As another optional feature, the spectral tilt information may, for example, be configured to obtain the spectral tilt information on the basis of spectral-band-wise energy values or spectral band wise root-mean-square values representing an energy of spectral values in a plurality of respective spectral bands and on the basis of spectral band-wise energy values or spectral-band-wise root-mean-square values representing the masking threshold in a plurality of respective spectral bands.

As an example, the spectral energy information 624 may hence comprise spectral band wise root-mean-square values representing an energy of spectral values in a plurality of respective spectral bands and the masking envelope information 626 may, for example comprise spectral band-wise energy values or spectral-band-wise root-mean-square values representing the masking threshold in a plurality of respective spectral bands.

Optionally, the processing unit 630 may be configured to provide said information.

As another optional feature, the spectral tilt information determination unit 620 may be configured to determine separate spectral tilt information 622 for different audio frames and/or for different audio subframes.

As another optional example, encoder 600 may, for example, comprise a difference value determinator 640. The difference value determinator 640 may, for example, be configured to determine a difference value 642 representing, in the form of a single value, a difference between the spectral energy information 624 and the masking envelope information 626 over a frequency range comprising a plurality of spectral bins.

Furthermore, the encoder 600 may optionally comprise a noise level information obtaining unit 650, which may be configured to obtain or determine or to calculate a noise level information 652 in dependence or based on the difference value 642.

As another optional feature, the encoding unit 610 may, for example, receive the noise level information 652 and may be configured to encode the noise level information in the encoded audio information.

Optionally, the difference value determinator 640 may, for example, be configured to obtain the difference value 642 using a linear regression.

As another optional feature, the encoding unit 610 may, for example, be configured to encode the spectral tilt information 622 using three bits.

Furthermore, the encoding unit 610 may, for example, be configured to encode the spectral tilt information 622 such that the encoded spectral tilt information represents a negative spectral tilt.

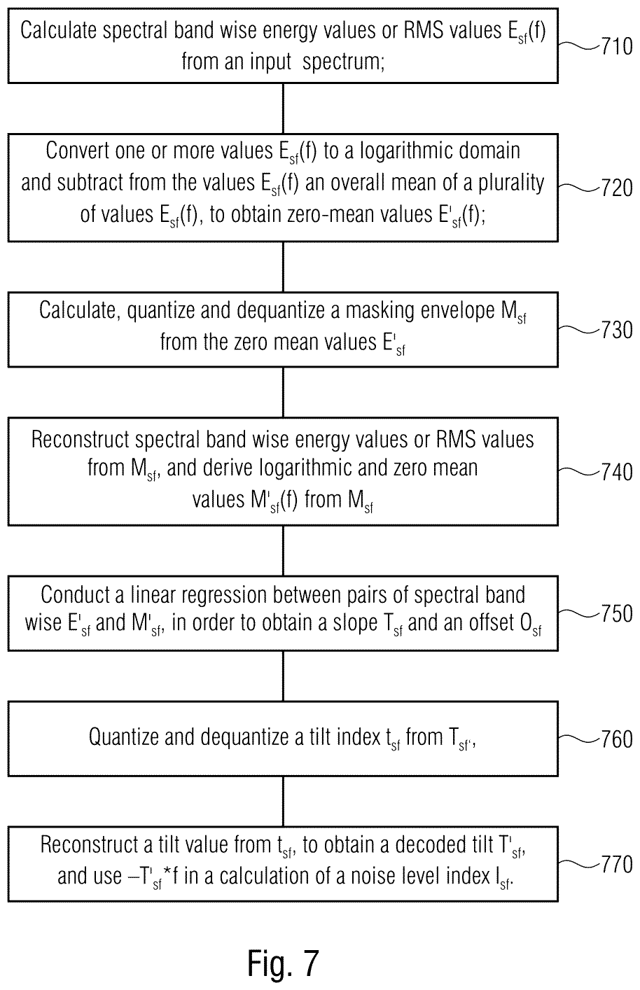

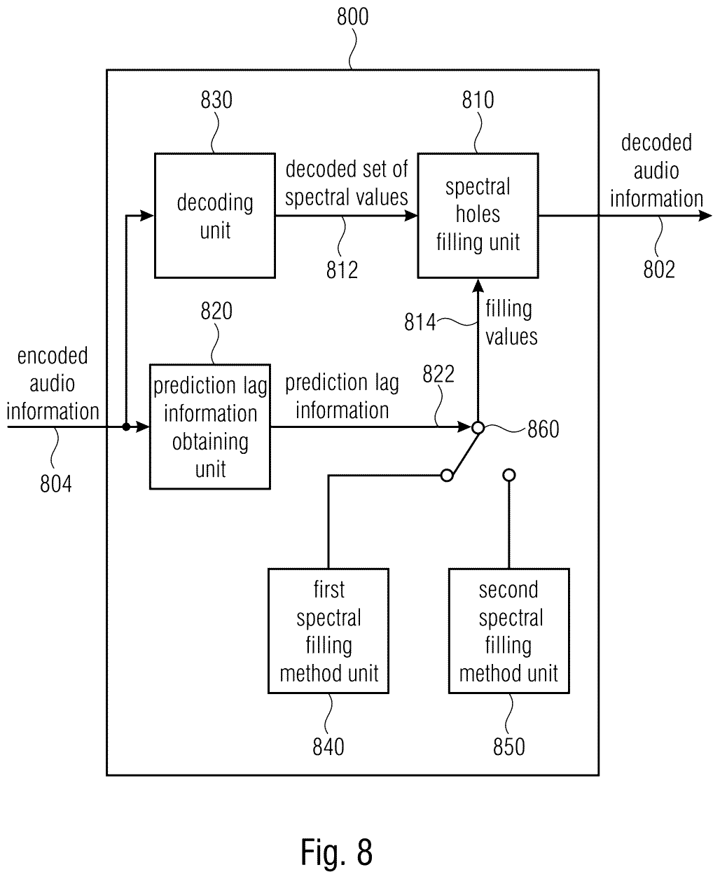

FIG. 7 shows an example for a functionality of an encoder, e.g. encoder 500 shown in FIG. 5 or encoder 600 shown in FIG. 6, according to embodiments according to the first aspect of the invention. Hence an inventive encoder may be configured to perform the following steps:
1. Calculate spectral band wise energy values or RMS values E_{sf}(f) from an input spectrum 602; (710)
2. Convert one or more values E_{sf}(f) to a logarithmic domain and subtract from the values E_{sf}(f) an overall mean of a plurality of values E_{sf}(f), to obtain zero-mean values E′_{sf}(f); (720)
3. Calculate, quantize and dequantize a masking envelope M_{sf} from the zero mean values E′_{sf} (730)
4. Reconstruct spectral band wise energy values or RMS values from M_{sf}, and derive logarithmic and zero mean values M′_{sf}(f) from M_{sf} (740)
5. Conduct a linear regression between pairs of spectral band wise E′_{sf} and M′_{sf}, in order to obtain a slope T_{sf} and an offset O_{sf} (750)
6. Quantize and dequantize a tilt index t_{sf} from T_{sf}; (760)
7. Reconstruct a tilt value from t_{sf}, to obtain a decoded tilt T′_{sf}, and use −T′_{sf}*f in a calculation of a noise level index I_{sf} (770)
FIG. 8 shows a schematic view of an audio decoder for providing a decoded audio information on the basis of an encoded audio information according to embodiments according to the second aspect of the invention. FIG. 8 shows decoder 800 comprising a spectral holes filling unit 810, which is configured to fill spectral holes of a decoded set 812 of spectral values. The result of the hole filling may, for example, be a decoded audio information 802.

As another optional feature, decoder 600 may comprise a prediction lag information obtaining unit 820. The prediction lag information obtaining unit 820 may be configured to obtain or determine or calculate a prediction lag information 822. As another optional feature, the prediction lag information obtaining unit 820 may receive an encoded audio information 804 that may be used to determine the prediction lag information 822.

As another optional feature, decoder 800 comprises a decoding unit 830. Decoding unit 830 may be configured to provide the decoded set 812 of spectral values based on the encoded audio information 804.

Furthermore, the decoder 800 may comprise a first spectral filling method unit 840 and a second spectral filling method unit 850 (Optionally, decoder 800 may comprise a plurality of second, e.g. of further spectral filing method units or the second spectral filling method unit may be configured to provide the functionality of a plurality of further spectral filling methods). The respective spectral filling method unit may, for example, be configured to provide filling values 814 to the spectral holes filling unit 810 in order to fill the spectral holes.

Based on the prediction lag information 822 a switching (using switch 860) may be performed between the first spectral filling method unit 840 and a second spectral filling method unit 850 (or for example a plurality of other spectral filling method units) for the provision of filling values 814 to the spectral holes filling unit 810.

Using the first spectral filling method a frequency filtering or a frequency prediction may be used to obtain filling values which are used to fill spectral holes, using the second spectral filling method no frequency filtering and no frequency prediction may be used to obtain filling values which are used to fill the spectral holes.

Optionally, decoder 800 may, for example, be configured to use the first spectral filling method if the prediction lag information 822 is non-zero, or to use the first spectral filling method if the prediction lag information 822 is larger than zero and to use the second (e.g. one of the one or more further) spectral filling methods otherwise.

As another optional feature, the prediction lag information obtaining unit may, for example, be configured to use an encoded representation of a prediction lag value which is included in the encoded audio information 804, in order to obtain the prediction lag information 822, e.g. an prediction lag value.

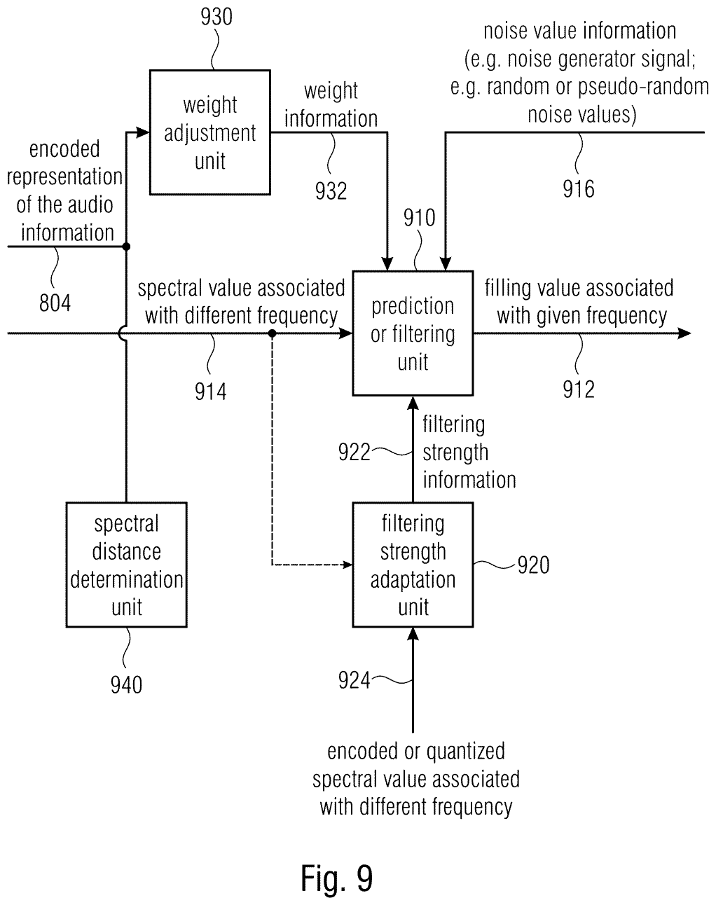

FIG. 9 shows a schematic view of a first spectral filling method unit according to embodiments according to the second aspect of the invention. FIG. 9 may show a schematic view of details of the first spectral filling method unit 840 of FIG. 8. FIG. 9 shows a prediction or filtering unit 910 and a filtering strength adaptation unit 920.

An inventive audio decoder may, for example, be configured to determine, e.g. using prediction or filtering unit 910 to obtain a filling value 912, which is associated with a given frequency in dependence on another spectral value 914, which is associated with a different frequency. The prediction or filtering unit 910 may therefore be configured to use or to apply a prediction or a filtering.

Furthermore, an inventive audio decoder may, for example, be configured to adapt, e.g. using filtering strength adaptation unit 920, a filtering strength information 922, e.g. a filtering strength, in dependence on an encoded or quantized spectral value 924 associated with the different frequency. As an example, spectral value 914 may e.g. alternatively be used to adapt the filtering strength.

Optionally the filtering strength information 922 may, for example, comprise a filtering strength, wherein the filtering strength determines an impact of the other spectral value 914 onto the filling value 912.

Optionally, an inventive decoder, e.g. using filtering strength adaptation unit 920, may be configured to adapt the filtering strength information, e.g. the filtering strength, in dependence on the spectral value 924 associated with the different frequency as it is determined by the encoded representation of individual spectral values in the encoded audio information.

Optionally, adaptation of the filtering information 922, e.g. of the filtering strength in dependence on the spectral value 924 associated with the different frequency may, for example, be performed before a noise filling is applied.

As another optional feature, the filtering strength adaptation unit may be configured to adapt the filtering information 922, e.g. the filtering strength in dependence on whether the spectral value 924 or 914 associated with the different frequency (or value) is or was quantized to zero or not. Hence, the filtering strength may be adjusted in dependence on a masking envelope, e.g. scaling factors. The inventors recognized that zero quantized spectral values may be filtered differently in order to improve the decoding of the audio information.

Optionally, an inventive decoder may be configured to adapt, e.g. using filtering strength adaptation unit 920, the filtering strength in dependence on whether a noise filling is or was applied to the spectral value 924 or 914 associated with the different frequency (or value) or not.

Optionally, an inventive decoder may be configured to, e.g. using prediction or filtering unit 910, to selectively apply a filtering in a frequency direction or a prediction in a frequency direction for spectral values 924 or 914 for which a noise filling is applied.

Optionally, an inventive decoder may be configured, e.g. using prediction or filtering unit 910, to apply the prediction or the filtering, in order to determine the given filling value 912 on the basis of random or pseudo-random noise values. An optional noise value information 916, for example comprising the random or pseudo-random noise values, may therefore be provided to the prediction or filtering unit 910. The optional noise value information 916 may comprise random and/or pseudo-random noise values. Such values may, for example, be provided by a noise generator (not shown). Hence the decoder may optionally comprise a noise generator. Furthermore, the noise value information may comprise a noise generator signal, e.g. the random and/or pseudo-random noise values.

As another optional feature, the spectral value associated with the different frequency 924 or 914 may, for example be a filling value associated with the other frequency. Optionally, the spectral value associated with the different frequency 924 or 914 may, for example, be noise value associated with the other frequency. The inventors recognized that the filling value 912 may, for example, be determined using a weighted combination of a noise value associated with the given frequency, and of a noise value associated with the other frequency or a weighted combination of a noise value associated with the given frequency, and of a filling value associated with the other frequency. Hence, the prediction and/or filtering unit 910 may be configured to perform one or both weighted combinations in order to obtain the given filling value 912.

Furthermore, an inventive decoder may comprise a weight adjustment unit 930. The weight adjustment unit may, for example, be configured to adjust a weight given to the noise value associated with the other frequency or the weight given to the filling value associated with the other frequency in dependence on whether a noise filling has been applied for a spectral value 924 or 914 associated with the other frequency.

Optionally, an inventive audio decoder may comprise a spectral distance determination unit 940, which may be configured to determine a spectral distance between the filling value 912 associated with the given frequency and the other spectral value 924 or 914 associated with the different frequency on the basis of an encoded information describing the spectral distance, which is included in an encoded representation 804 of the audio information.

Optionally, the weight adjustment unit 930 may receive the encoded representation 804 of the audio information. The weight adjustment unit 930 may be configured to determine a weight information 932, e.g. weight, which is applied to the noise value associated with the given frequency, on the basis of a gain information which is included in the encoded representation 804 of the audio information.

As another optional feature, the weight adjustment unit 930 may be configured to determine a weight information 932, e.g. weight, which is applied to the noise value associated with the other frequency, or to the filling value associated with the other frequency, in dependence on a gain information, which is included in the encoded representation 804 of the audio information.

As another optional feature, the weight adjustment unit 930 may be configured to determine a weight information 932, e.g. weight, which is applied to the noise value associated with the other frequency, or to the filling value associated with the other frequency, in dependence on a sign information, which is included in the encoded representation of the audio information.

Optionally, the prediction or filtering unit 910 may, for example, be configured to determine the given filling value č(i) (e.g. filling value 912) according to č(i)=d*c(i)+G′_{sf}*c(i−P′_{sf}), if the coefficient c(i−P′_{sf}) (e.g. spectral value associated with different frequency 924 or 914) was obtained using a noise filling and according to č(i)=d*c(i)+½*G′_{sf}*c(i−P′_{sf}), if the coefficient c(i−P′_{sf}) was not obtained using a noise filling, wherein c(i) designates a spectral coefficient which is obtained using a noise filling and having a spectral index i; wherein d designates an attenuation coefficient, wherein G′_{sf} (e.g. weight information 932) designates a weight which is based on a gain value that is included in the encoded audio representation 804; and wherein c(i−P′_{sf}) designates a spectral coefficient having a spectral index i−P′_{sf}, wherein P′_{sf} is a prediction parameter or a filtering parameter which is based on a prediction parameter information that is included in the encoded audio representation.

As another optional feature, an inventive decoder may be configured to obtain the prediction parameter or filtering parameter P′_{sf} according to P′_{sf}=p_{sf}+B, wherein p_{sf} is a lag index which is included in the encoded audio representation 804, and wherein B is a constant and/or wherein the audio decoder is configured to obtain the weight G′_{sf} according to G′_{sf}=(−1)^{Ssf}*(3+2*g_{sf})/8, wherein S_{sf} is a binary value which is included in the encoded representation and wherein g_{sf} is a binary value which is included in the encoded representation; and/or wherein the audio decoder is configured to obtain the attenuation coefficient d according to d=(7.5−g_{sf})/8, wherein g_{sf} is a binary value which is included in the encoded representation.

Optionally, the filtering strength adaptation unit may, for example, be configured to selectively use a reduced filtering strength which is applied to spectral coefficients which are not marked as noise-filled zero-quantized spectral coefficients. Optionally, the decoder may comprise a marking unit for marking noise-filled zero-quantized spectral coefficients (not shown).

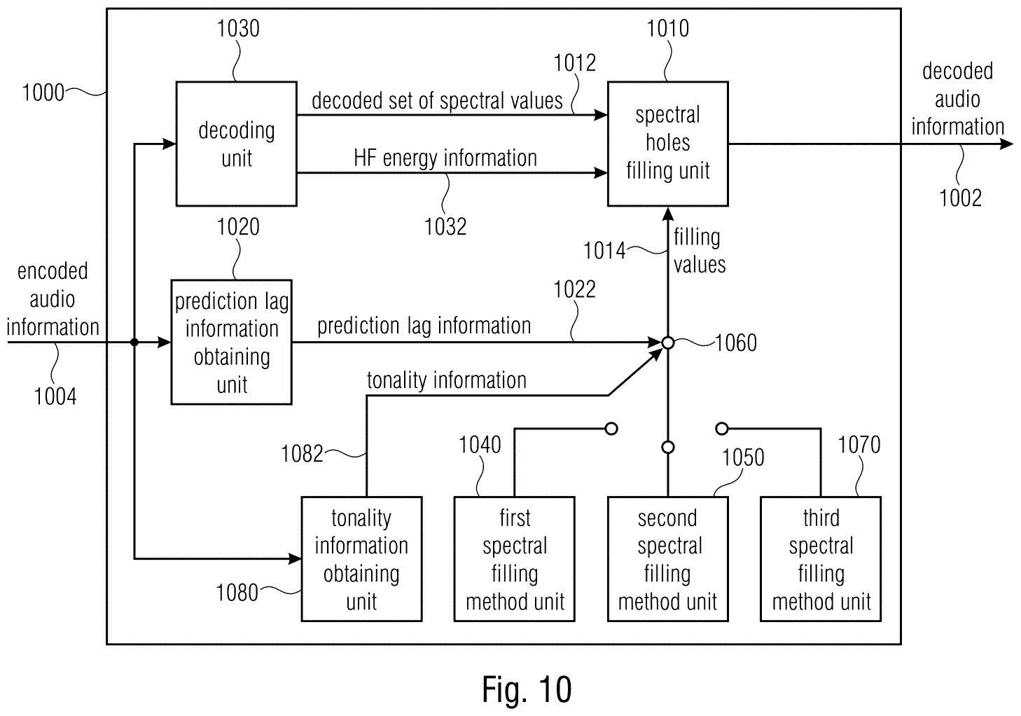

FIG. 10 shows a schematic view of an audio decoder with additional optional features according to embodiments according to the second aspect of the invention. FIG. 10 shows decoder 1000 comprising a spectral holes filling unit 1010, a prediction lag information obtaining unit 1020, a decoding unit 1030, a first spectral filling method unit 1040, a second spectral filling method unit 1050 and a switch 1060. The functionality of these elements may, for example, be similar or analogous to the respective elements of FIG. 8 and respectively 9.

As another optional feature, decoder 1000 comprises a third spectral filling method unit 1070. Decoder 1000 may, for example, be configured to switch between a second spectral filling method (e.g. using spectral filling method unit 1050) in which random or pseudo-random filling values are used to fill spectral holes (e.g. providing respective filling values 1014 to the spectral holes filling unit 1010) and a third spectral filling method 1070, in which filling values 1014, which are obtained using a copying of non-zero spectral coefficients, are used to fill spectral holes, in dependence on a prediction lag information and/or in dependence on a tonality information 1082, e.g. a tonality, of the audio information.

As another optional feature, decoder 1000 may comprise a tonality information obtaining unit 1080, which may be configured to obtain the tonality information 1082 on the basis of the encoded audio information 1004.

Optionally, tonality information obtaining unit 1080 may, for example, be configured to judge whether the audio information is tonal in dependence on a tonality information which is included in the encoded audio representation 1004 and/or in dependence on an information indicating whether a tonality information is included in the encoded audio information, and/or in dependence on a filtering gain value and/or in dependence on a prediction gain value and/or in dependence on a time-domain post-filter gain value. The tonality information obtaining unit 1080 may therefore be configured to determine or extract the respective information for the judgement form the encoded audio information 1004. Hence, tonality information obtaining unit 1080 may receive the encoded audio information and/or, for example, at least one of an information indicating whether a tonality information is included in the encoded audio information, a filtering gain value, a prediction gain value and/or a time-domain post-filter gain value.

As another optional feature, the spectral holes filling 1010 unit may, for example, be configured to apply a high frequency noise gain adjustment for a filling of spectral holes in an upper frequency region below an noise filling end frequency. Therefore, the spectral holes filling unit 1010 may be provided with an high frequency (HF) energy information 1032.

As an example, the decoding unit 1030 may be configured to obtain the high frequency energy information 1032 on the basis of the encoded audio information 1004.

As another optional feature, decoder 1000, e.g. decoding unit 1030, may, for example, be configured to obtain a high frequency energy delta value in dependence on a high frequency energy value, in dependence on a global gain value, and in dependence on a noise level information. In the example of FIG. 10 the HF energy information 1032 may comprise the high frequency energy delta value. Furthermore, the high frequency energy value, the global gain value and/or the noise level information may, for example, be included in an encoded form in the encoded audio information 1004.

Optionally, the audio decoder may be configured to apply the high frequency energy delta value to obtain one or more noise filling values. As an example, according to an embodiment, the filling value 1014 may be a noise filling value, and the spectral holes filling unit 1010 may be configured to apply the high frequency energy delta value provided by the decoding unit to adapt the filling values 1014 to “fill” the noise filling values in the decoded set of spectral values.

As another optional feature, the audio decoder 1000, e.g. the spectral holes filling unit, may be configured to selectively multiply one or more intermediate noise filling values (e.g. filling values 1014) which are associated with frequencies in an upper frequency region below an noise filling end frequency, with the high frequency energy delta value

Optionally, the audio decoder 1000, e.g. the spectral holes filling unit 1010, may be configured to selectively apply the high frequency noise gain adjustment to spectral values for which a noise filling is performed. As an example, the high frequency noise gain adjustment may be applied in a frequency range between 8 kHz and 10 kHz.

Optionally, the high frequency energy value or the high frequency energy delta value may represent an energy of a plurality of spectral coefficients at a frequency below a noise filling end frequency or in a frequency region below the noise filling end frequency which were quantized to zero.

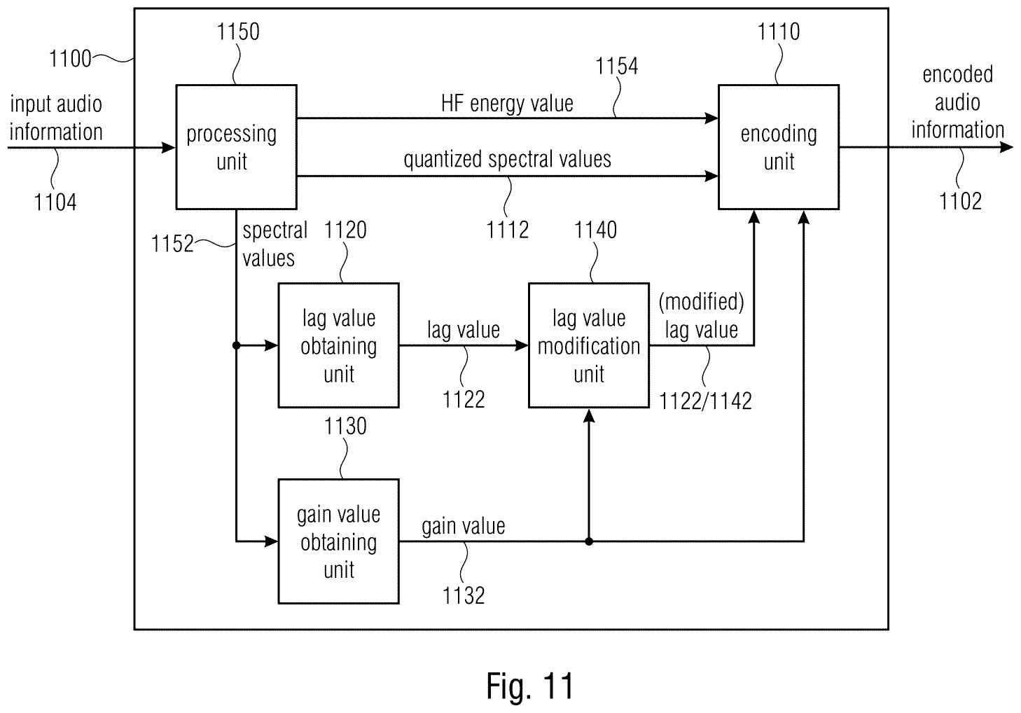

FIG. 11 shows a schematic view of an audio encoder for providing an encoded audio information on the basis of an input audio information according to embodiments according to the second aspect of the invention. FIG. 11 shows encoder 1100 comprising an optional encoding unit 1110. The encoding unit 1110 may be configured to encode a plurality of quantized spectral values 1112.

Furthermore, encoder 1100 comprises a lag value obtaining unit 1120, which may be configured to obtain a lag value 1122, which defines a characteristic of a filtering operation or of a prediction operation to be performed by an audio decoder for deriving one or more filling values for filling spectral holes.

Moreover, encoder 1100 comprises a gain value obtaining unit 1130, which may be configured to obtain a gain value 1132 which defines a characteristic of the filtering operation or of the prediction operation to be performed by an audio decoder for deriving one or more filling values for filling spectral holes.

The encoder 1100 may comprise in addition a lag value modification unit 1140, which may be configured to set the lag value 1122 to zero if the gain value 1132 is smaller than a threshold value or if an absolute value of the gain value is smaller than a threshold value, to thereby obtain a modified lag value 1142.

The encoding unit 1110 may, be configured to encode the determined lag value 1122 or the modified lag value 1142.

Hence, as an option, the quantized spectral values 1112 and the (modified) lag value 1122/1142 may be encoded using the encoding unit 1110 in an encoded audio information 1102.

Furthermore, encoder xx may comprise an optional processing unit 1150 for providing the quantized spectral values 1112 to the encoding unit 1110 based on an input audio information 1104.

As an example, the lag value 1122 and the gain value 1132 may be determined or calculated using or based on an autocorrelation information which is applied to a set of spectral values 1152, which may, for example, be associated with the spectral values 1112. The gain value 1132 may, for example, be determined in dependence on a peak of an autocorrelation function which is obtained on the basis of the set of spectral values. As an example, the processing unit 1150 may be configured to provide the set of spectral values 1152 to the lag value obtaining unit 1120 and to the gain value obtaining unit 1130. The spectral values 1152 may, for example, be quantized and may, for example be equal to the quantized spectral values 1112.

Optionally, the encoding unit 1110 may be configured to encode the gain value 1132 if the encoded lag value is non-zero. The lag value 1122/1142 may comprise an information about a dependency or a correlation between spectral coefficients, e.g. spectral values, for example over different frequency bands. In case such a correlation exists, the lag value 1122 may be non-zero and hence a dependency may be characterized by the gain value 1132.

In general, in simple words, and as an example, the lag value 1122 may describe a distance in the frequency domain of a spectral value with a given frequency to another spectral value with a different frequency. The gain value may, for example, describe or quantize the correlation in between the spectral values. Hence, one spectral value may be determined by the other and the gain and lag information. Hence, a transmission of the second spectral value may not be necessary with known lag and gain information.

As another optional feature, the processing unit 1150 may, for example, be configured to determine or calculate a high-frequency (HF) energy value 1154. The HF energy value 1154 may comprise an information for a adjusting a HF gap filling range.

Optionally, the encoding unit 1110 may be configured to selectively encode the high-frequency energy value 1154, which may describe an energy in an upper portion of a spectrum, e.g. of the quantized spectral values if the encoded lag value is zero. As an example, a lag value 1122/1142 of zero may indicate that no correlation between spectral coefficients may be exploited for an encoding of the spectral values. Hence, instead of encoding a lag and a gain value, the HF energy value may be encoded to perform a gap filling, e.g. such that a spectral energy in the gap filling range is adapted in the decoder according to the HF energy value 1154.

As another optional feature, the encoding unit 1110 may be configured to selectively either encode the gain value 1132 or the high-frequency energy value 1154 in dependence on the encoded lag value.

Furthermore, the encoding unit 1110 may optionally be configured to encode the gain value 1132 and the high-frequency energy value 1154 using a same number of bits. Hence, an encoding scheme, e.g. a number of bits reserved for a specific information in an encoded bitstream, may be kept constant in either case, or in other words irrespective of whether the gain value or the high-frequency energy value are encoded.

As another optional feature, encoder 1100 may, optionally, be configured to determine separate lag values 1122/1142 and/or separate gain values 1132 for different audio frames and/or for different audio subframes.

Furthermore, the lag value 1122/1142 and/or the gain value 1132 may be determined or calculated in a transform domain.

Optionally, the lag value obtaining unit 1120 may be configured to perform a long term transientness detection and to selectively set the lag value 1122 to zero if an audio frame or audio subframe is found to be not long-term transient.

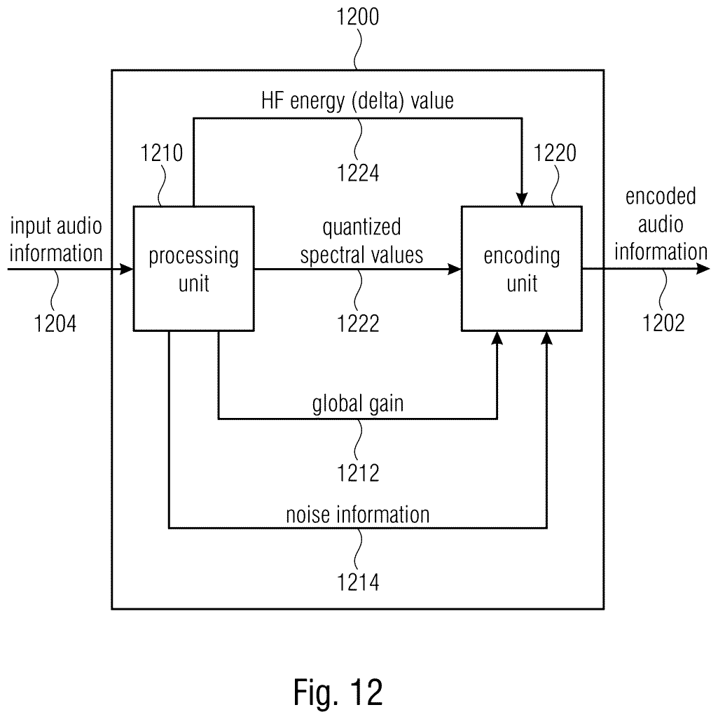

FIG. 12 shows a schematic view of another audio encoder for providing an encoded audio information on the basis of an input audio information according to embodiments according to the second aspect of the invention. FIG. 12 shows encoder 1200 comprising an optional processing unit 1210 and an optional encoding unit 1220.

Encoding unit 1220 may be configured to encode a plurality of quantized spectral values 1222. Furthermore, the encoding unit 1220 may be configured to encode a high frequency energy value or a high frequency energy delta value 1224. Hence, encoder 1200 may provide an encoded audio information 1202 comprising an encoded representation of quantized spectral values and/or HF energy (delta) values.

The processing unit 1210 may be configured to provide said quantizes spectral values 1222 based on the input audio information 1204. Moreover, the processing unit 1210 may be configured to provide said HF energy (delta) values 1224 using the input audio information 1204.

The high frequency energy value or the high frequency energy delta value may represent an energy of a plurality of spectral coefficients at a frequency below a noise filling end frequency or in a frequency region below the noise filling end frequency which were quantized to zero. As an example, the HF energy value (or delta e.g. in case of differential entropy coding) 1224 may represent the original RMS energy of the spectro-temporally normalized spectral coefficients slightly below the noise filling end frequency (e.g., in the 8-10 kHz frequency range) which were quantized to zero.

Optionally, the processing unit 1210 may further be configured to logarithmically quantize the high frequency energy value or the high frequency energy delta value, as an example hence providing quantized representations of the high frequency energy value or the high frequency energy delta value to the encoding unit 1220.

As another optional feature, the processing unit 1210 may, for example, be configured to provide a global gain 1212, e.g. GG_{sf}, and/or a noise information 1214, e.g. a noise level, e.g. L_{sf}, to the encoding unit 1220 (that may be determined based on the input audio information 1204). The encoding unit 1220 may optionally be configured to encode the high frequency energy delta value, which may optionally describe the energy of a plurality of spectral coefficients at a frequency below a noise filling end frequency or in a frequency region below the noise filling end frequency which were quantized to zero, relative to a product of the global gain 1212 and of the noise level 1214.

As another optional feature, the encoding unit 1220 may, for example, be configured to obtain a rounded scaled result of a logarithm of a ratio between the high frequency energy value and a product of the global gain 1212 and of the noise information 1214, e.g. in the form of a noise value, in order to encode the high frequency energy value.

Optionally, the processing unit 1210 may be configured to determine the quantized high frequency energy delta value according to

Ehf_{sf}=1+round(Δ*log 2(EHFₛf/(GG_{sf}*L_{sf})),
wherein EHF is a high frequency energy value, wherein GG_{sf} is a global gain 1212, wherein L_{sf} is a noise level 1214, and wherein Δ is a constant.

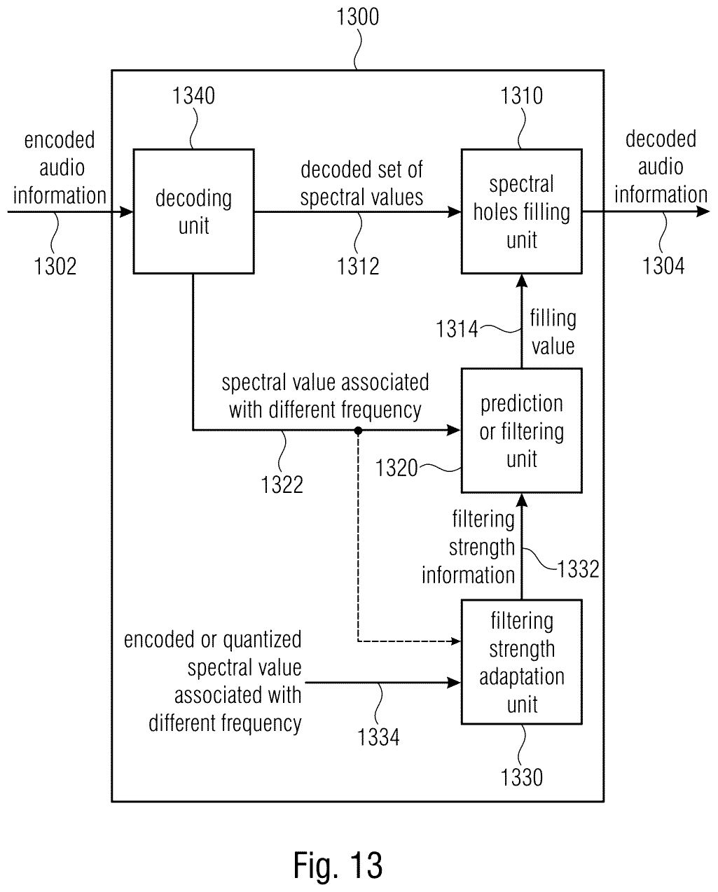

FIG. 13 shows a schematic view of an audio decoder for providing a decoded audio information on the basis of an encoded audio information according to embodiments according to the third aspect of the invention. FIG. 13 shows audio decoder 1300 comprising an optional spectral holes filling unit 1310 which may be configured to fill spectral holes of a decoded set 1312 of spectral values using respective filling values 1314.

The decoder 1300 may further comprise an optional prediction or filtering unit 1320, which may be configured to determine a respective filling value 1314, using a prediction or filtering, such that a given filling value 1314, which is associated with a given frequency, is obtained in dependence on another spectral value 1322, which is associated with a different frequency.

Moreover, the decoder 1300 may optionally comprise a filtering strength adaptation unit 1330. The filtering strength adaptation unit 1330 may provide a filtering strength information 1332, e.g. an information about a filtering strength, to the prediction or filtering unit 1320. The filtering strength adaptation unit 1330 may be configured to adapt the filtering strength in dependence on an encoded or quantized spectral value 1334, optionally, e.g. as an alternative, with the spectral value 1322 provided to the prediction or filtering unit 1320, associated with the different frequency.

As an optional feature, the decoder 1330 may comprise a decoding unit 1340, which may be configured to provide the decoded set 1312 of spectral values to the spectral holes filling unit 1310 using or based on the encoded audio information 1302. Optionally, the decoding unit 1300 may provide the spectral value 1322 associated with the different frequency, e.g. determined from the encoded audio information 1302, to the prediction or filtering unit 1320 and/or to the filtering strength adaptation unit 1330.

Optionally, the filtering strength (e.g. as a part of the filtering strength information 1332) determines an impact of the other spectral value 1322 onto the given filling value 1314. Furthermore, the filtering strength adaptation unit 1330 may, for example, be configured to adapt the filtering strength in dependence on the spectral value 1334 associated with the different frequency as it is determined by the encoded representation of individual spectral values in the encoded audio information 1302. Optionally, the filtering strength may be adapted in dependence on the spectral value 1334 associated with the different frequency before a noise filling is applied and/or in dependence on whether the spectral value 1334 associated with the different frequency (or value) is quantized to zero or not and/or in dependence on whether a noise filling is applied to the spectral value 1334 associated with the different frequency (or value) or not.

As another optional feature, the prediction or filtering unit 1320 may be configured to selectively apply a filtering in a frequency direction or a prediction in a frequency direction for spectral values for which a noise filling is applied.

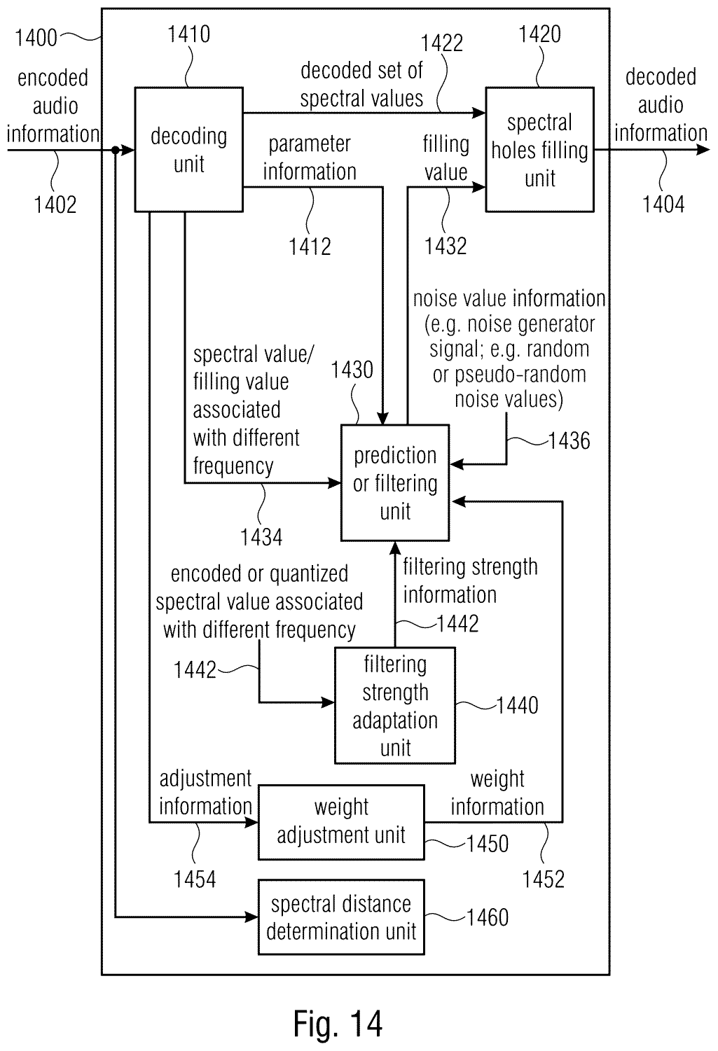

FIG. 14 shows a schematic view of an audio decoder with additional optional features, according to embodiments according to the third aspect of the invention. FIG. 14 shows decoder 1400, comprising an optional decoding unit 1410, a spectral holes filling unit 1420, a prediction or filtering unit 1430 and a filtering strength adaptation unit 1440. These elements may comprise the same or similar or analogous functionalities and corresponding input and/or output signals as explained in the context of FIG. 13.

Additionally, as another optional feature, the audio decoder 1400, e.g. the prediction or filtering unit 1440 of audio decoder 1400, may be configured to apply the prediction or the filtering, in order to determine the given filling value 1432 on the basis of a random or pseudo-random noise values. Hence, a noise value information 1436, for example comprising the random or pseudo-random noise values may be provided to the prediction or filtering unit 1430.

Optionally, the noise value information 1436 may, for example, comprise a noise value associated with the given frequency and/or a noise value associated with the other frequency. As another optional feature, the spectral value 1454 or 1434 associated with the different frequency may, for example, be a filling value associated with the other frequency. Hence, optionally, the decoder 1400 may comprise means to provide the noise value information 1436 and or the filling value associated with the different frequency (e.g. therefore in this case optionally not being provided by the decoding unit 1410. The decoding unit 1410 may, for example, provide an information that spectral value was quantized to zero, an said spectral value may be replaced on the basis of the noise value information or on the filling value with the different frequency, e.g. as explained below).

As another optional feature, the audio decoder 1400, e.g. the prediction or filtering unit 1430 thereof, may be configured to perform a weighted combination of a noise value associated with the given frequency, and of a noise value associated with the other frequency or a weighted combination of a noise value associated with the given frequency, and of a filling value associated with the other frequency, in order to obtain the given filling value 1432.

Furthermore, decoder 1400 may comprise a weight adjustment unit 1450, which may be configured to adjust a weight given to the noise value associated with the other frequency or the weight given to the filling value associated with the other frequency in dependence on whether a noise filling has been applied for a spectral value 1454 or 1434 associated with the other frequency. Therefore, a weight information 1452, e.g. comprising an information about a respective weight, may be provided form the weight adjustment unit 1450 to the prediction or filtering unit 1430.

As another optional feature, decoder 1400 may comprise a spectral distance determination unit 1460 which may be configured to determine a spectral distance between the filling value 1430 associated with the given frequency and the other spectral value 1454 or 1434 associated with the different frequency on the basis of the encoded information describing the spectral distance, which is included in the encoded representation 1402 of the audio information.

Optionally, the audio decoder 1400, e.g. the weight adjustment unit 1450, may be configured to determine a weight (wherein the weight information 1452 may comprise the weight), which is applied to the noise value (wherein the noise value information 1436 may comprise the noise value) associated with the given frequency, on the basis of a gain information which is included in the encoded representation 1402 of the audio information.

As another optional feature, the audio decoder 1400, e.g. the weight adjustment unit 1450, may be configured to determine a weight (wherein the weight information 1452 may comprise the weight), which is applied to the noise value (wherein the noise value information 1436 may comprise the noise value) associated with the other frequency, or to the filling value associated with the other frequency, in dependence on a gain information which is included in the encoded representation of the audio information

Hence, the encoded representation 1402 of the audio information may comprise an encoded representation of the gain information, that may, for example, be decoded by the decoding unit 1410 and provided to the weight adjustment unit 1450. As an example an adjustment information 1454 optionally comprising the gain information may be provided to the weight adjustment unit 1450.

Optionally, the audio decoder, e.g. the weight adjustment unit 1450, may be configured to determine the weight, which is applied to the noise value associated with the other frequency, or to the filling value associated with the other frequency, in dependence on a sign information which is included in the encoded representation 1402 of the audio information.

Hence, the encoded representation 1402 of the audio information may comprise an encoded representation of the sign information, that may, for example, be decoded by the decoding unit 1410 and provided, e.g. in the adjustment information 1454, to the weight adjustment unit 1450.

As an example, the audio decoder, e.g. the prediction or filtering unit 1430, may be configured to determine the given filling value č(i) 1432 according to č(i)=d*c(i)+G′_{sf}*c(i−P′_{sf}), if the coefficient c(i−P′_{sf}) 1454 or 1434 was obtained using a noise filling and according to č(i)=d*c(i)+½*G′_{sf}*c(i−P′_{sf}), if the coefficient c(i−P′_{sf}) 1454 or 1434 was not obtained using a noise filling wherein c(i) designates a spectral coefficient which is obtained using a noise filling and having a spectral index i; wherein d designates an attenuation coefficient, wherein G′_{sf} designates a weight 1452 which is based on a gain value 1454 that is included in the encoded audio representation 1402; and wherein c(i−P′_{sf}) designates a spectral coefficient having a spectral index i−P′_{sf}, wherein P′_{sf} is a prediction parameter or a filtering parameter which is based on a prediction parameter information that is included in the encoded audio representation.

As another optional feature, the audio decoder 1400, e.g. the decoding unit 1410, may be configured to obtain the prediction parameter or filtering parameter P′_{sf} according to P′_{sf}=p_{sf}+B, wherein p_{sf} is a lag index which is included in the encoded audio representation, and wherein B is a constant.

Alternatively or in addition, the audio decoder, e.g. weight adjustment unit 1450, may be configured to obtain the weight G′_{sf} (the weight information may comprise weight G′_{sf}) according to G′_{sf}=(−1)^{Ssf}*(3+²*g_{sf})/8, wherein S_{sf} is a binary value which is included in the encoded representation and wherein g_{sf} is a binary value which is included in the encoded representation

Alternatively or in addition, the audio decoder, e.g. the decoding unit 1410, may be configured to obtain the attenuation coefficient d according to d=(7.5−gsf)/8, wherein g_{sf} is a binary value which is included in the encoded representation.

As optionally shown in FIG. 14, the decoding unit 1410, may for example, provide a parameter information 1412, e.g. comprising the prediction parameter or filtering parameter P′_{sf}, and/or the constant B and/or the attenuation coefficient d to the prediction or filtering unit 1430. However it is to be noted that the decoding unit 1410 may optionally only provide the decoded set of spectral values 1422 to the spectral holes filling unit 1420, and the decoder 1400 may comprise one or more dedicated obtaining and/or calculation and/or determination units for providing the respective information, e.g. based on the encoded audio information 1402.

As another optional feature, the audio decoder 1400 may be configured to mark noise-filled zero-quantized spectral coefficients, and to selectively use a reduced filtering strength which is applied to spectral coefficients which are not marked.

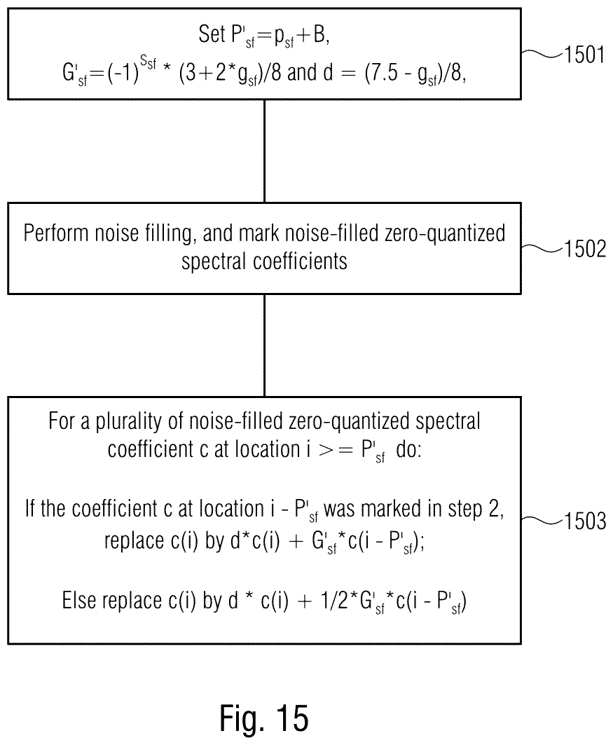

FIG. 15 shows an example for a functionality of a decoder, e.g. decoder 1400 shown in FIG. 14 or decoder 1300 shown in FIG. 13, according to embodiments according to the third aspect of the invention. Hence, an inventive decoder may be configured to perform the following steps:
1. Set P′_{sf}=p_{sf}+B, G′_{sf}=(−1)^{Ssf}*(3+2*g_{sf})/8 and d=(7.5−g_{sf})/8 (1501)
2. perform noise filling, and mark noise-filled zero-quantized spectral coefficients (1502)
3. for a plurality of noise-filled zero-quantized spectral coefficient c at location i>=P′_{sf}do (1503):
4. if the coefficient c at location i−P′_{sf} was marked in step 2, replace c(i) by d*c(i)+G′_{sf}*c(i−P′_{sf}); else
5. replace c(i) by d*c(i)+½*G′_{sf}*c(i−P′_{sf})

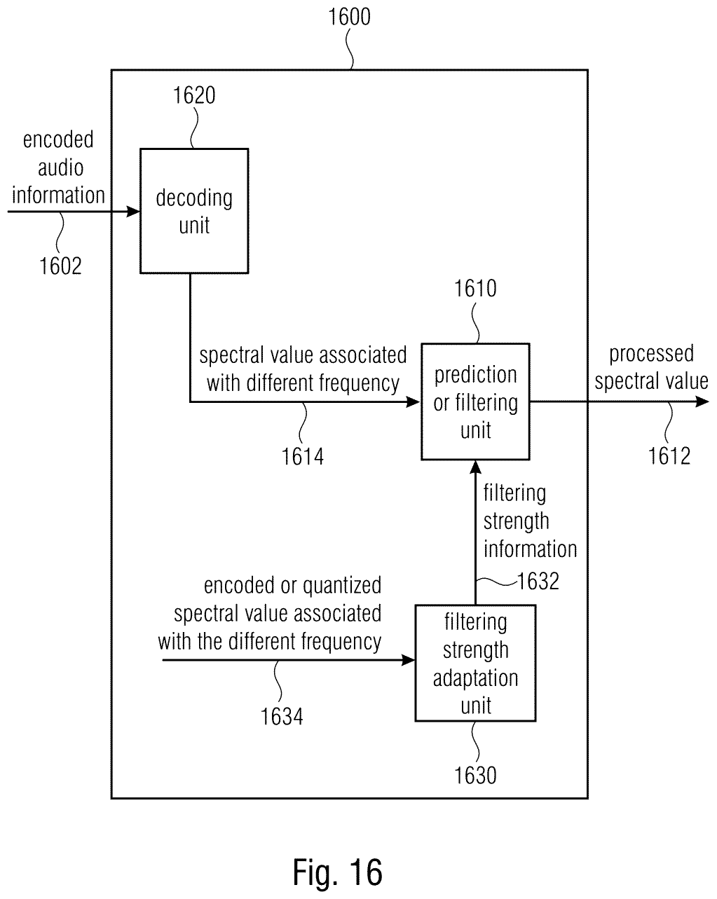

FIG. 16 shows a schematic view of an audio decoder with additional optional features, according to embodiments according to the third aspect of the invention. FIG. 16 shows decoder 1600 comprising an optional prediction or filtering unit 1610, which may be configured to determine a processed spectral value 1612 using a prediction or filtering, such that a given processed spectral value 1612, which is associated with a given frequency, is obtained in dependence on another spectral value 1614 which is associated with a different frequency.

As an optional feature, the decoder 1600 may comprise a decoding unit 1620, which may be configured to provide the spectral value 1614 associated with the different frequency to the prediction or filtering unit 1610 based on an encoded audio representation 1602.

As another optional feature, the decoder 1600 may comprise a filtering strength adaptation unit 1630, that may be configured to adapt a filtering strength in dependence on an encoded or quantized spectral value 1634, e.g. optionally alternatively 1614 associated with the different frequency. Therefore, the filtering strength adaptation unit may provide a filtering strength information 1632 to the prediction or filtering unit 1610. Optionally spectral value 1634 may be provided by the decoding unit based on the encoded audio representation.

Optionally, the filtering strength adaptation unit 1630 may be configured to adapt the filtering strength to reduce a contribution of a nonzero-quantized spectral coefficients included in the prediction or filtering.

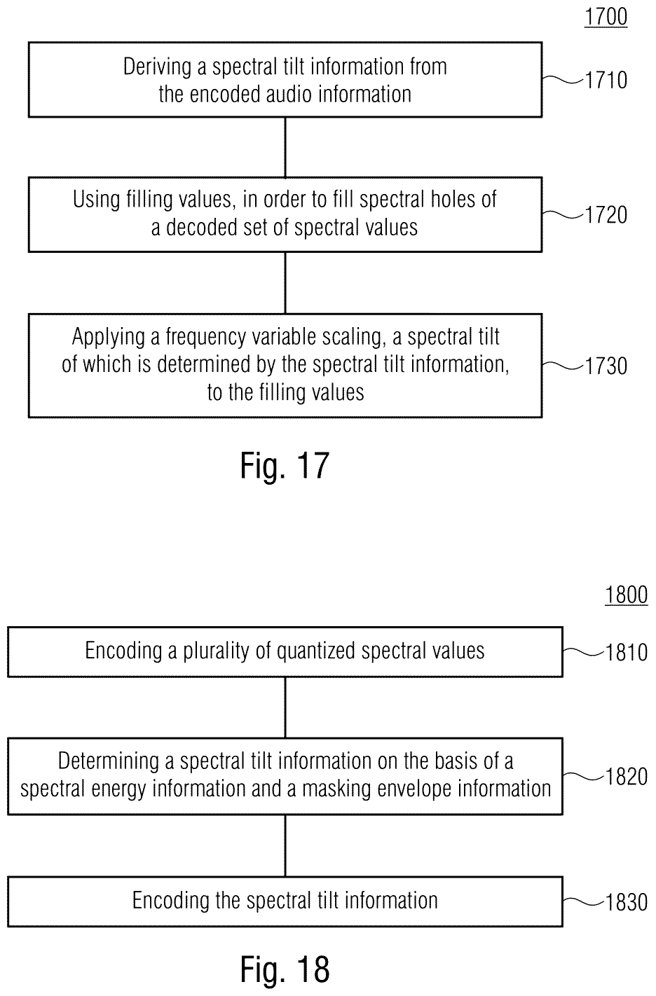

FIG. 17 shows a block diagram of a method for providing a decoded audio information on the basis of an encoded audio information according to an embodiment according to the first aspect of the invention. Method 1700 comprises deriving 1710 a spectral tilt information from the encoded audio information, using 1720 filling values, in order to fill spectral holes of a decoded set of spectral values and applying 1730 a frequency variable scaling, a spectral tilt of which is determined by the spectral tilt information, to the filling values.

FIG. 18 shows a block diagram of a method for providing an encoded audio information on the basis of an input audio information according to an embodiment according to the first aspect of the invention. Method 1800 comprises encoding 1810 a plurality of quantized spectral values, determining 1820 a spectral tilt information on the basis of a spectral energy information and a masking envelope information and encoding 1830 the spectral tilt information

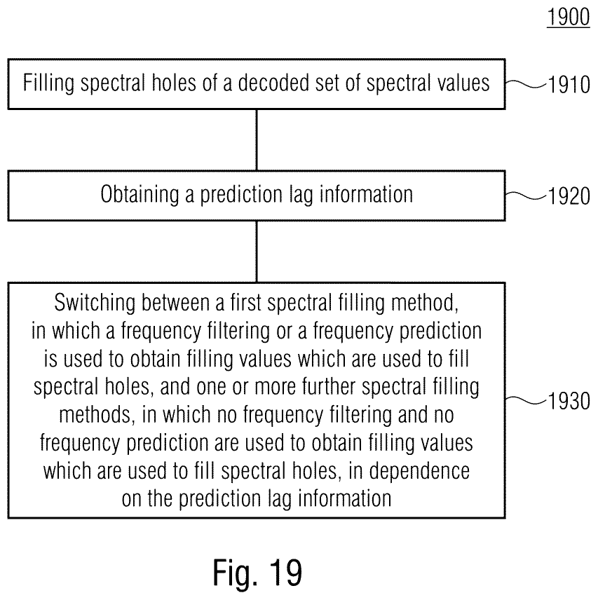

FIG. 19 shows a block diagram of a method for providing a decoded audio information on the basis of an encoded audio information according to an embodiment according to the second aspect of the invention. Method 1900 comprises filling 1910 spectral holes of a decoded set of spectral values, obtaining 1920 a prediction lag information and switching 1930 between a first spectral filling method, in which a frequency filtering or a frequency prediction is used to obtain filling values which are used to fill spectral holes, and one or more further spectral filling methods, in which no frequency filtering and no frequency prediction are used to obtain filling values which are used to fill spectral holes, in dependence on the prediction lag information.

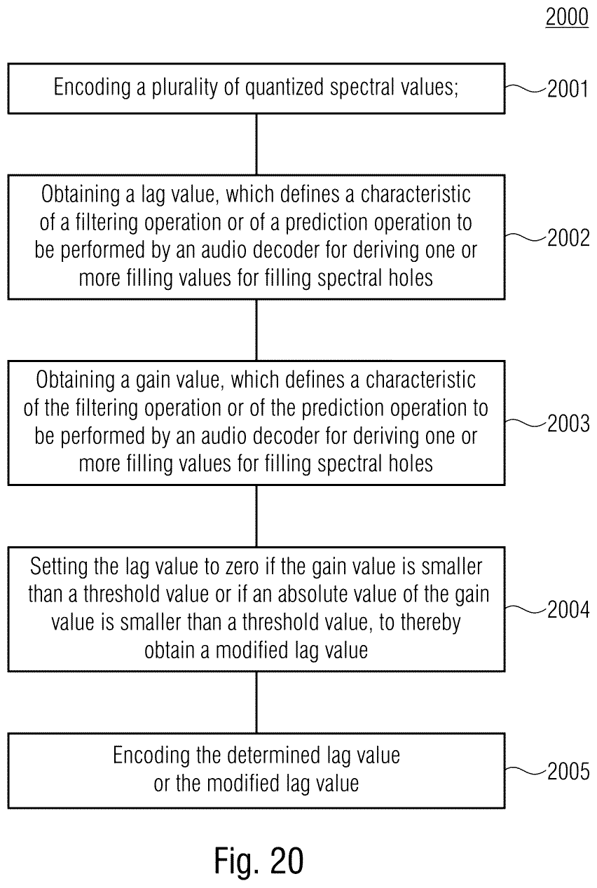

FIG. 20 shows a block diagram of a method for providing an encoded audio information on the basis of an input audio information according to an embodiment according to the second aspect of the invention. Method 2000 comprises encoding 2001 a plurality of quantized spectral values, obtaining 2002 a lag value, which defines a characteristic of a filtering operation or of a prediction operation to be performed by an audio decoder for deriving one or more filling values for filling spectral holes, obtaining 2003 a gain value, which defines a characteristic of the filtering operation or of the prediction operation to be performed by an audio decoder for deriving one or more filling values for filling spectral holes, setting 2004 the lag value to zero if the gain value is smaller than a threshold value or if an absolute value of the gain value is smaller than a threshold value, to thereby obtain a modified lag value and encoding 2005 the determined lag value or the modified lag value.

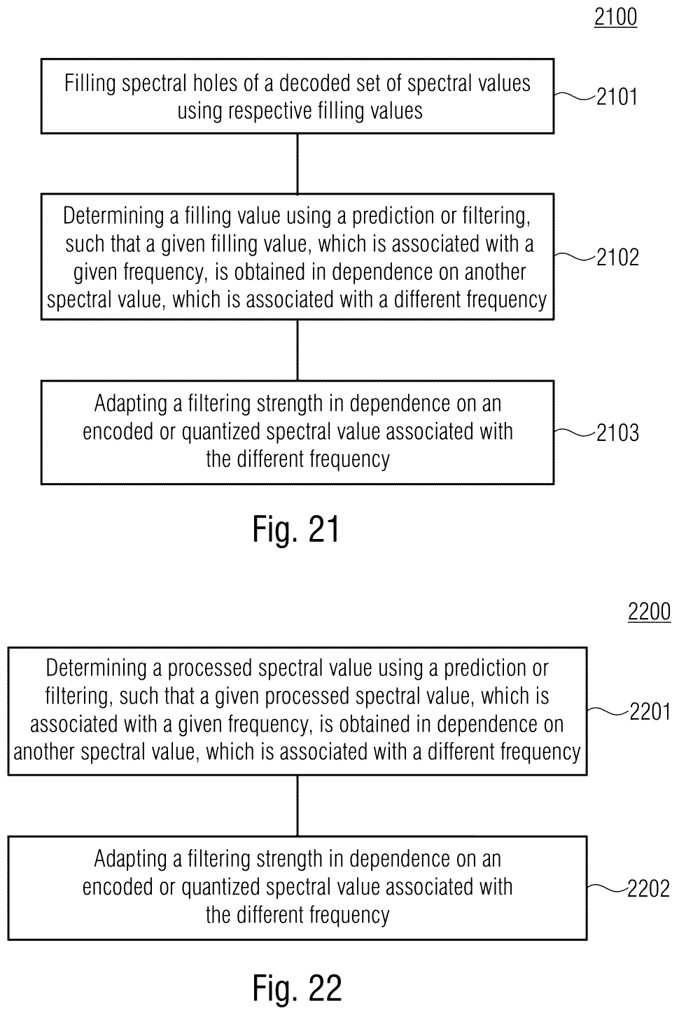

FIG. 21 shows a block diagram of a first method for providing a decoded audio information on the basis of an encoded audio information according to an embodiment according to the third aspect of the invention. Method 2100 comprises filling 2101 spectral holes of a decoded set of spectral values using respective filling values, determining 2102 a filling value using a prediction or filtering, such that a given filling value, which is associated with a given frequency, is obtained in dependence on another spectral value, which is associated with a different frequency and adapting 2103 a filtering strength in dependence on an encoded or quantized spectral value associated with the different frequency.

FIG. 22 shows a block diagram of a second method for providing a decoded audio information on the basis of an encoded audio information according to an embodiment according to the third aspect of the invention. Method 2200 comprises determining 2201 a processed spectral value using a prediction or filtering, such that a given processed spectral value, which is associated with a given frequency, is obtained in dependence on another spectral value, which is associated with a different frequency and adapting 2202 a filtering strength in dependence on an encoded or quantized spectral value associated with the different frequency.

In the following further embodiments of the invention are disclosed. In addition, embodiments according to the invention as discussed above, will be explained in different words. It is to be noted that any feature, functionality and detail as discussed above may optionally be used with or incorporated in any of the embodiments explained below and vice versa.

Furthermore, it is to be noted that in the following, some embodiments according to the invention are explained structured according to different inventive aspects. However, the following structuring in aspects may, for example, be different from the before explained structuring, in order to underline different features, functionalities and details of embodiments and a respective combinability of said features, functionalities and details. As an example, aspect 1 as explained before may correspond to the following aspect 1. Aspect 2 as explained before, may, for example, correspond to the following aspects 2, 3 and 4. Aspect 3 as explained before, may, for example, correspond to the following aspects 2, 3 and 4. However, these are just examples, and it is to be noted once again, that any features, functionalities and details according to any embodiment may be incorporated or used with any other embodiment, e.g. irrespective of a categorization to different aspects. Such a categorization may for example only be used to provide an example for a clustering of embodiments to facilitate a person skilled in the art to develop a better understanding of the invention.

In the following, different inventive embodiments and aspects will be described in “Method and Apparatus for Spectrotemporally Improved Spectral Gap Filling in Audio Coding”, e.g. in a chapter “Introduction, Conventional solutions”, e.g. in a chapter “Drawbacks of Conventional Solutions”, in a chapter “Summary of the Invention”, e.g. in a chapter “Description of the Invention”, e.g. in a chapter “Application of FD-LTP Adaptive Filtering Aspect to Temporal Noise Shaping Filtering” and e.g. in a chapter “Proposals for three [e.g. partially] independent decoders according to embodiments of the invention”.

Also, further embodiments will be defined by the enclosed claims.

It should be noted that any embodiments as defined by the claims can be supplemented by any of the details (features and functionalities) described in the above mentioned chapters and by any of the details (features and functionalities) described in the context of any other embodiment as disclosed herein.

Also, the embodiments described in the above mentioned chapters as well as any of the before discussed embodiments can be used individually, and can also be supplemented by any of the features in another chapter or from any other embodiment, or by any feature included in the claims.

Also, it should be noted that individual aspects described herein can be used individually or in combination. Thus, details can be added to each of said individual aspects without adding details to another one of said aspects.

Moreover, features and functionalities disclosed herein relating to a method can also be used in an apparatus (configured to perform such functionality). Furthermore, any features and functionalities disclosed herein with respect to an apparatus can also be used in a corresponding method. In other words, the methods disclosed herein can be supplemented by any of the features and functionalities described with respect to the apparatuses.

Also, any of the features and functionalities described herein can be implemented in hardware or in software, or using a combination of hardware and software, as will be described in the section “implementation alternatives”.

### Implementation Alternatives

Although some aspects have been described or will be described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

An inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

### Method and Apparatus for Spectrotemporally Improved Spectral Gap Filling in Audio Coding

### 1. Introduction, Conventional Solution

The present invention relates to, for example perceptually, improved ways of calculating spectral envelopes, e.g. as applied in modern audio transform codecs, and/or to improved ways of reconstructing the spectral and/or temporal fine-structure of spectral regions quantized to zero in an encoder. In addition, or as an example in other words, the invention relates to spectral envelopes representing time and/or frequency variant masking thresholds, for example, used during spectral quantization in conventional audio codecs, whereby, as an example, each spectrum may, for example, be divided by the associated masking threshold e.g. prior to quantization and, for example multiplied by it after quantization, yielding, as an example, spectral shaping of the quantization distortion, e.g. according to the masking threshold. The calculation of such spectral envelopes may, for example traditionally, involve the application of some spectral tilt, also, as an example or for example often referred to as “pre-emphasis”, to the envelope data prior to quantization, e.g. in order to ensure, for example during the coding bit allocation, a higher coding SNR at low than at high frequencies and, as an example thereby, higher audio quality. See, e.g., the 3GPP TS 26.445, Enhanced Voice Services (EVS) detailed algorithmic description or PCT/EP2018/080137 from 2018. In addition, the invention relates to spectral substitution, or “filling”, of spectral gaps (zero-quantized frequency coefficients after encoding) caused by coarse quantization at relatively low target bit-rates.

It was discovered that low-frequency (LF) spectral content is, for example generally, coded sufficiently accurately e.g. by the abovementioned approach, for example, since the LF SNR is, e.g. due to the application of the spectral tilt onto the actual spectral envelope during the calculation of the masking envelope, for example relatively, high. However, it was also discovered that, at low coding bit-rates, e.g. large parts of the high-frequency (HF) spectral range may, for example, be likely to be quantized to zero, e.g. resulting in HF spectral gaps. Methods exist which may fill these zero-quantized parts, e.g. with random spectral values (for example, such as the Perceptual Noise Substitution (PNS) in MPEG-4 Advanced Audio Coding (AAC) and/or the frequency-domain Noise Filling in MPEG-D Extended HE-AAC and 3GPP EVS), but these methods may exhibit certain drawbacks, e.g. in terms of flexibility and/or signaling, for example as described in the following.

### 2. Drawbacks of Conventional Solutions

The PNS method may signal to the decoder the target energy of a spectral band which has, for example, been quantized to zero in the encoder, and the PNS decoder may insert pseudo-random values into the zero-quantized band, e.g. scaled such that the inserted signal energy matches the signaled target energy. Although this scheme can, for example, preserve the spectral energy (and, thereby as an example, original spectral envelope) for example quite accurately, e.g. at low bit-rates, it may tend to require many bits, e.g. for signaling of the zero-quantized band energies, which may be counterproductive. Moreover, it may be, for example relatively, inflexible since only fully zero-quantized spectral bands can, for example, be substituted—no substitution may be performed in bands where at least one spectral coefficient is nonzero, e.g. after quantization.

The noise filling approaches employed in MPEG-D Extended HE-AAC and 3GPP EVS may improve upon the PNS design, e.g. by allowing to replace zero-quantized spectral coefficients, for example, with pseudo-random values e.g. upon decoding, for example above a certain “noise fill start frequency”, e.g. even when a certain spectral band was not entirely quantized to zero in the encoder. The MPEG-D codec may, however, still signal band-wise target energy data for all fully zero-quantized bands, thus as an example increasing the signaling overhead e.g. especially when many bands are zero-quantized. The noise filling method in 3GPP EVS may avoid the transmission of such band-wise energies and, instead, may make use of e.g. only a transmitted spectrally global noise level l and/or a predefined spectral tilt t.

Taking a closer look at the EVS noise filling approach by way of FIGS. 2 and 3 reveals that, in EVS, the spectral envelope reconstructed in zero-quantized spectral regions may, for example, not directly be given by the original signal's spectral envelope (i.e., the signal envelope; solid thick black curve) but, for example, by a scaled version of the masking threshold (i.e., the inverse of the normalization envelope used prior to quantization, e.g. used for the spectral shaping of the quantization distortion, for example, as described in the introduction; dashed thick black curve). This is not surprising: the decoding result in zero-quantized spectral regions may be the product of the inserted pseudo-random values, the transmitted spectral global noise level 0<L<1, and the transmitted masking envelope—no representation of the true spectral envelope may be conveyed from the encoder to the decoder.

FIG. 2 compares, or may for example show a comparison of, the spectral envelope, e.g. targeted by the EVS gap filling (or, for example, noise filling) algorithm, e.g. in the absence of any spectral tilt compensation. Note that the dashed masking threshold curve has been offset downwards for better visibility of all curves. It can be seen that, e.g. due to the frequency invariant level l, the distance between the masking envelope and the effective reconstructed noise envelope (solid gray curve) may be constant (thin double arrow) and, for example therefore, may not or does not follow the original spectral envelope accurately. In fact, the reconstructed noise envelope may exceed the original spectral envelope at high frequencies, e.g. thus potentially causing audible noise after decoding, while it may remain significantly below the original spectral envelope, e.g. at lower frequencies, for example thus likely causing insufficient gap-fill energy and/or audible spectral holes. A spectral tilt e.g. applied during the calculation of the masking envelope (i.e., the noise shaping envelope, e.g. as explained) may, for example, thus find its way into the spectral envelope reconstructed in zero-quantized spectral regions.

FIG. 3 illustrates, or may for example show an illustration of an example of, the, for example desired, spectral gap filling behavior. Here, the distance between the noise shaping envelope and the effective reconstructed envelope in the zero-quantized spectral regions (gray curve) is not constant but tilted downwards towards higher frequencies (length of thin double arrow decreases with frequency). This tilt, which may, for example, be applied multiplicatively to l in (e.g. to and/or in) a frequency dependent fashion, may intend to compensate for the pre-emphasis tilt applied e.g. during the calculation of the masking envelope, for example in order to recover—or at least approximate—the true spectral envelope of the input signal, e.g. during the gap filling. In EVS, this tilt t (see above) may be a predefined constant, but it may, for example, be observed that, e.g. due to the quantization of the masking envelope (for example by way of low-rate vector quantization in EVS and derived codecs) and/or some input signal dependency, the optimal value of t per frame or transform may, for example, vary quite a bit. A, for example, signal adaptive, frame-wise or transform-wise signaled t would or may, for example, therefore, be, for example, more desirable than e.g. a constant value for t.

Moreover, it would, or may, for example, be, be desirable to allow for adjustment of the fine spectral and/or temporal envelope of the substituted pseudo-random gap-fill values, e.g. during decoding, for example, to better match the input signal envelope.

### 3. Summary of the Invention

For example, to address the aforementioned shortcomings of the state of the art, for example namely, a relatively large gap filling energy signaling overhead and/or insufficiently accurate spectral envelope recovery during audio decoding, e.g. via gap filling for example in combination with insufficiently accurate reconstruction of the fine spectrotemporal envelope, e.g. in spectral regions generated via gap filling, the following method for improved gap filling is proposed, e.g. according to embodiments of the invention:
1. Transmission of a frame-wise and/or subframe-wise spectral tilt correction t, e.g. in an audio transform codec, for example applying spectral gap filling, e.g. without explicit transmission of target energies in zero-quantized bands (where, for example, “bands” denote specific nonoverlapping frequency ranges). This aspect or, for example, examples of this aspect according to embodiments is described in Sec. 4.1. Its benefit may, for example, be improved recovery of the e.g. true spectral envelope from, and/or, for example regardless of the quantization of, the transmitted masking envelope (i.e., noise shaping envelope) e.g. with very little additional signaling.
2. Signal adaptive choice, for example on a per-frame and/or per-subframe basis, e.g. between different methods, e.g. for generating the “artificial” spectral content, for example, used during gap filling, with the choice being signaled, as an example, to an audio transform decoder, e.g. by means of a frequency-domain long-term prediction (FD-LTP) lag parameter. This aspect, or for example, examples of this aspect according to embodiments is described in Sec. 4.2. The general idea according to embodiments is to, for example depending on the FD-LTP lag value, choose between a) noise filling with FD-LTP, b) tonality based gap filling, for example, without FD-LTP, e.g. similar to IGF in EVS (a prior-art method), and c) e.g. conventional noise filling, for example, without FD-LTP, e.g. similar to that in EVS or MPEG-D.
3. When, for example in aspect 2 above, noise filling with FD-LTP is selected (wherein, as an example, the FD-LTP lag is nonzero), application of a long-term predictive filter, e.g. in a spectral domain (e.g. the MDCT domain) for example of the audio transform codec, e.g. during the decoder-side noise filling routine, for example depending on whether a “current” coded FD coefficient is zero and for example on whether a corresponding “previous” coded FD coefficient located at a distance from the current coefficient (specified by the transmitted FD-LTP lag) is zero may, for example, be performed. This aspect or examples of this aspect according to embodiments is described in Sec. 4.3.
4. When, for example in aspect 2 above, gap filling without FD-LTP is selected (wherein, for example, the FD-LTP lag is zero), application of a signal adaptive, e.g. copy-up and/or tonality based spectral gap filling procedure, for example, similar to the Intelligent Gap Filling (IGF) method used in, e.g., 3GPP EVS and MPEG-H Audio may, for example, be performed. Copy-up may indicate a reconstruction of a zero-quantized FD coefficient from a lower-frequency nonzero-quantized FD coefficient and tonality based may, for example, mean that the copy-up process may be guided by transmitted (sub)frame-wise (e.g. frame wise and/or subframe wise) “audio tonality data”, e.g. known from conventional solutions (here, a time-domain LTP or a HPF lag). This e.g. final aspect or examples of this aspect according to embodiments is described in Sec. 4.4.

These aspects were devised, as an example, for the 3GPP IVAS codec but may be equally applicable (or for example in a similar way) to other codecs, e.g., EVS.

### 4. Description of Embodiments of the Invention

A preferred implementation, e.g. embodiments, of one or for example, even the inventive aspects may, for example require the following, e.g. to be used in the audio codec. As an example, embodiment according to the invention may comprise means in order to fulfill the following prerequisites. Hence, embodiments according to the invention may comprise the following features:
Prerequisite a: transmission of an N-bit noise level index, e.g. 0≤l_{sf}<2^{N} within for example each frame and/or subframe sf, as an example, used to derive a noise level e.g. L_{sf}<1. E.g. in EVS, IVAS, and/or other codecs, N=3 may, for example, usually be chosen.
Prerequisite b: transmission of noise shaping envelope (as an example i.e., masking envelope) which is being derived as an example in the encoder, for example, by obtaining spectral band-wise energy or RMS values of the input spectrum.
Prerequisite c: transmission of, e.g. some kind of, frame and/or subframe audio tonality information to a decoder, e.g., by way of a time-domain long-term prediction (TD-LTP) and/or a harmonic post-filtering (e.g. HPF) lag and gain. If such information is present, the (sub)frame can, for example, be considered tonal. Note, also, that in the following description, the terms frame and subframe may be used interchangeably.

### 4.1. Preferred Embodiment: E.g. According to Aspect 1 (as an Example, Adaptive Tilt Correction)

The general idea according to embodiments behind the transmission of the tilt correction value may, for example, be the calculation and/or low-bit-rate signaling of a difference curve, e.g. in logarithmic intensity domain, for example, between a subframe's e.g. true spectral envelope (as an example, i.e., its input signal envelope, solid black curve in FIGS. 2 and 3) and the subframe's masking envelope (as an example, i.e., the noise shaping envelope, dashed black curve in FIGS. 2 and 3). Since the masking envelope may be transmitted to the decoder (e.g. according to, prerequisite b), additional transmission of the difference may, for example allow to, e.g. in the gap and/or noise filling decoding procedure, reconstruct the e.g. true spectral envelope, for example from the masking envelope and/or the tilt related difference curve, for example with better accuracy than in the conventional solutions and/or with fewer side information bits.

### 4.1.1. Tilt Line Calculation and Encoding in the Encoder (Optional)

FIG. 3 indicates that the intensity difference between the e.g. true spectral envelope and masking envelope may change monotonically, for example, with frequency. In a logarithmic intensity domain (e.g., base-10 logarithm) and/or in the gap and/or noise filling spectral region (for example between the two thin vertical arrows), the monotonic difference curve was found to resemble a straight line, e.g. most of the time. Therefore, it is proposed, e.g. according to embodiments, to calculate and to parameterize the difference curve, for example, by means of e.g. simple linear regression, for example, in a logarithmic intensity domain (see, e.g., https://en.m.wikipedia.org/wiki/Simple linear repression for a description), for example, via or using the function

$$difference curve ( f ) = true spectral envelope ( f ) - masking envelope ( f ) = T \cdot f + O ,$$

where f is the desired frequency (or, for example, equivalently, the offset of the transform coefficient), T is the tilt—or slope—value, O is an intensity offset, and both envelopes are in said logarithmic domain. For example, to minimize the computational complexity of the calculation of T and O, both envelopes may, for example, preferably be, represented by spectral band-wise energy (e.g. sum of squares) and/or root-mean-square (RMS) values, for example not transform coefficient-wise values (e.g. according to prerequisite b, as an example i.e., the number of values for f may, for example, be smaller than the number of transform coefficients). The encoder-side calculation and/or en-/decoding of T and O can, for example, then, be conducted as follows:

For each (sub)frame sf do:
1. Calculate spectral band-wise energy and/or RMS values E_{sf}(f), e.g from the input (i.e., uncoded) spectrum for sf
2. Convert for example all E_{sf}(f) to a logarithmic domain; subtract from all E_{sf}(f) their overall mean=>(e.g. providing) zero-mean E_{sf}
3. Calculate, quantize, and/or dequantize masking envelope M_{sf} from E′_{sf} e.g. as described in the state of the art
4. Reconstruct spectral band-wise energy and/or RMS values from M_{sf}=>(e.g. providing) logarithmic and zero-mean M_{sf}(f)
5. Conduct for example simple linear regression between e.g. all pairs of spectral band values E′_{sf} and M′_{sf}=>(e.g. providing) T_{sf} and O_{sf}
6. Quantize (e.g., to 3 bits) and dequantize tilt index t_{sf} from T_{sf} (e.g., quantized T_{sf} values: [1,2, . . . 7,8]/−5)
7. Reconstruct tilt value from t_{sf}=>(e.g. providing) decoded tilt T′_{sf}; use −T′_{sf}·f during calculation of noise level index l_{sf}.

Note that, with proper choices of certain constants e.g. during step 7, the value of Oₛ, can, for example, be accounted for in the calculation of l_{sf} (as an example, i.e., can be compensated for by l_{sf} itself). Hence, it may, for example, not be necessary to quantize and to signal O_{sf} to the decoder, e.g. rendering the method very low-rate (only the e.g. 3-bit t_{sf} may, or for example must, be transmitted).

Note, further, that T′_{sf} may, for example, still be in the logarithmic domain, as an example i.e., T′_{sf}·f may be an additive product, e.g. in the logarithmic domain. Therefore, negating this logarithmic-domain product in the derivation of l_{sf} may imply a division by a linear-domain e.g. equivalent of the product (e.g., 10^{T′sf′f}) for example in case of calculations performed in a linear domain.

### 4.1.2. Tilt Reconstruction and Application in the Decoder (Optional)

During gap and/or noise filling (for example using l_{sf}) in the decoder, the encoder-side step 7 may, for example, be inversely applied, e.g. as follows:

For each (sub)frame sf do:
1. Reconstruct final noise level L_{sf} for example from the transmitted l_{sf} e.g. according to the state of the art; cf. as an example also Sec. 4.5
2. Reconstruct tilt value from t_{sf}=>(e.g. providing) decoded tilt T′_{sf}; use T′_{sf}·f for example during multiplication of e.g. final noise level L_{sf}.

As an example, in other words, for example when L_{sf} is multiplied onto generated gap-fill coefficients, linear-domain equivalents of the tilt correction product T′_{sf}·f (e.g., 10^{T′sf·f} as above) may, for example, be multiplied as well, e.g. in a frequency offset (f) dependent fashion. In order to maintain, e.g. on average, the value range of L_{sf}, T′_{sf} may, for example, be scaled by some constant.

In case of a band-wise segmentation of a transform spectrum, e.g. as described above, the frequency offset f of, for example, each spectral band can, for example, represent e.g. either a) the start frequency of that band (or, for example, equivalently, the offset of the first transform coefficient associated with that band) or b) the band's center frequency (or for example, equivalently, the offset of the first transform coefficient in the band plus half the width, e.g in number of transform coefficients, of the band). Both options were found to result in almost identical accuracy of the approach.

### 4.2. Preferred Embodiment: E.g. According to Aspect 2 (as an Example, Adaptive Gap-Fill Choice)

The state of the art, e.g. as described in Sec. 2, provides for example at least two different approaches to reconstruct zero-quantized spectral regions in audio transform coding: simple noise filling (or PNS), e.g. using pseudo-randomly generated transform coefficient values, and for example more intelligent gap filling (or for example spectral band replication, SBR), e.g. applying copy-up or copy-over from nonzero-quantized spectral coefficients. The general idea according to embodiments and for example behind this aspect or examples of this aspect according to embodiments of the invention is to provide means to adaptively, e.g. based on the (sub)frame's signal characteristic, switch between a noise filling and gap filling solution, the former with optional improved fine temporal shaping, for example as follows.

### 4.2.1. “Long-Term Transientness” Detection and FD-LTP Encoding (Optional)

It was discovered experimentally that, e.g. in particular, applause-like, rain-like, and/or LF male speech signals can, for example, benefit from improved reconstruction, e.g. of the HF fine temporal signal envelope, e.g. during decoder-side gap and/or noise filling. For such signals, detected and/or classified e.g. as “long-term transient”, the for example fine temporal structure of a specific (sub)frame sf can, for example, be parameterized by frequency-domain long-term prediction (FD-LTP) information. Analogous to conventional LTP pitch and gain information acquired in time domain (TD), FD-LTP lag and/or gain values can, for example, be obtained directly in the audio codec's transform domain; a detailed description follows in Sec. 4.3. The choice of noise and/or gap filling to be applied in a decoder can, for example, be made and/or signaled to the decoder for example depending on the value of said FD-LTP lag p e.g. transmitted in the audio bitstream, for example as follows:

For each (sub)frame sf do:
1. Perform “long-term transientness” detection; if sf is not long-term transient, set p_{sf}=0 and abort; else:
2. Calculate FD-LTP lag P_{sf} and/or gain G_{sf}; if |G_{sf}|<β, where 0<β<1 is a threshold, set p_{sf}=0 and stop; else:
3. Obtain quantized (e.g., to 3 or 4 bits) FD-LTP lag index p_{sf} for example from lag P_{sf} e.g. as described in Sec. 4.3 hereafter
4. If p_{sf} is 0, calculate quantized (e.g., to 2 bits) HF energy value e. g. for adjusting a HF gap filling region; else:
5. Obtain quantized (e.g., to 2 bits) FD-LTP gain g_{sf} and/or sign s_{sf} from G_{sf} e.g as described in Sec. 4.3 hereafter.

An example according to embodiments for the calculation of the HF energy value e.g. for adjusting a HF gap filling range is described in detail in Sec. 4.4. Note that the “long-term transientness” detection can, for example, be performed conventionally as in state-of-the-art audio encoders, e.g., by comparing, for example for each subframe, calculated instantaneous (and, for example, possibly temporally smoothed) spectral and/or temporal flatness measurement values to predefined thresholds and for example classifying sf as “long-term transient” e.g. if the temporal flatness is below and the spectral flatness is above the thresholds.

### 4.2.2. Filling Type Selection and Parameter Reading in the Decoder (Optional)

With the quantized FD-LTP lag value p_{sf}, e.g. transmitted alongside the FD-LTP g_{sf} and its sign s_{sf} and the audio tonality information (TD-LTP or HPF data, prerequisite c) in the bitstream, the decoder can, for example, select which of the types of spectral filling to apply—gap filling or noise filling with or without FD-LTP filtering—for example, as follows:

For each (sub)frame sf do:
1. If quantized lag p_{sf}>0, read quantized gain g_{sf} and sign s_{sf} and select type: noise filling +FD-LTP; else:
2. Read HF energy value, check presence of audio tonality data; if sf is tonal, select type: gap filling; else:
3. Select type: traditional noise filling without FD-LTP, as described in state of the art (e.g., EVS, MPEG-D).

Examples according to embodiments for the operations of the FD-LTP augmented noise filling and tonality based gap filling are described below. Note that the classification of sf as “tonal” in step 2 can, for example, be based upon the prior-art audio tonality data, e.g., by classifying sf as “tonal” if the audio tonality data is present (as an example, i.e., the TD-LTP/HPF data is nonzero). Alternatively, sf may, for example only, be classified “tonal” if the TD-LTP/HPF gain value is transmitted and maximum.

### 4.3. Preferred Embodiment: E.g. According to Aspect 3 (as an Example, Noise Filling with FD-LTP)

As mentioned or explained in Sec. 4.2.1, the temporal fine structure of coded audio signals can, for example, be reconstructed e.g. more accurately by means of FD-LTP filtering for example during the decoder-side noise filling process. Hence, when in the (sub)frame-wise procedure in Sec. 4.2.2, type noise filling+FD-LTP has been selected (or may, as an example be selected according to embodiments), an infinite impulse response (IIR) LTP-like filter may, as an example, according to this aspect, be applied to the pseudo-random noise coefficients, e.g. generated during the decoder-side noise filling, resulting, as an example, in a fine temporally shaped noise filling signal.

### 4.3.1. FD-LTP Calculation in the Encoder (Optional)

The decision whether to apply noise filling with FD-LTP filtering may for example, be based on FD predictor parameters that may, for example, be determined in the encoder. These predictor parameters—lag index p_{sf}, gain index g_{sf}, and/or sign index s_{sf}—may, for example, preferably, be calculated in the spectrotemporally normalized domain, e.g. utilized before the transform coefficient quantization, as an example i.e., on the (if applicable) TNS analysis filtered transform vector which has, for example, been perceptually normalized (as an example i.e., divided) e.g. by the noise shaping envelope. Note that the TNS analysis filtering may, for example, effectively remove the subframe's coarse temporal envelope while the perceptual normalization may, for example, remove the coarse spectralenvelope, e.g. leaving for example only the fine temporal envelope (e.g. to be parameterized by the FD-LTP) and/or the fine spectral envelope (which, for said “long-term transient” signals, may be expected to be negligible). The FD-LTP parameter calculation can, for example, be applied e.g. analogous to conventional TD-LTP and/or HPF calculations:

As an example for each (sub)frame sf classified as “long-term transient” do:
1. Calculate normalized autocorrelation on spectrotemporally normalized spectrum at lags B<p′<B+2^{B}
2. Find p′ for which magnitude of normalized autocorrelation is maximum=>(e.g. providing) P_{sf} with autocorr. (e.g. autocorrelation) value G_{sf}
3. If |G_{sf}|<β, set p_{sf}=0 and stop (see, for example, also Sec. 4.2.1; 0<β<1 may be a threshold, e.g. ¼); else set p_{sf}=P_{sf}−B
4. If |G_{sf}|<½, set g_{sf}=0; else set g_{sf}=1. Finally, if G_{sf}>0, set s_{sf}=0; else set s_{sf}=1 (see, for example, also Sec. 4.2.1).

Note that, e.g. to lower the computational complexity, for example only, integer spectral lags may be calculated for the FD-LTP. Moreover, all calculations may be applied only in the HF gap filling region. Constant B is, as an example, described in Sec. 4.5.

### 4.3.2. FD-LTP Application in the Decoder (Optional)

After e.g. all steps in Sec. 4.2.2 have been executed and type noise filling+FD-LTP has been chosen, the three FD-LTP parameters may, for example, be decoded and traditional noise filling and, e.g. subsequently, FD-LTP filtering may, for example, be applied:

As an example, for each (sub)frame sf for which type noise filling+FD-LTP has been selected do:
1. Set P′_{sf}=p_{sf}+B, G′_{sf}=(−1)^{Ssf}·(3+2·g_{sf})/8, and d=(7.5−g_{sf})/8. Note that, here, p_{sf}>0 may be guaranteed
2. Perform conventional noise filling (i.e. using l_{sf}); mark e.g. all noise-filled zero-quantized spectral coefficients
3. For each noise-filled zero-quantized spectral coefficient c at location i≥P′_{sf} (e.g. ordered by increasing i) do:
4. If the coefficient c at location i−P′ₛ was marked in step 2, replace c(i) by d·c(i)+G′_{sf}c(i−P′_{sf}); else:
5. Replace c(i) by d−c(i)+1½·G′_{sf}·c(i−P′_{sf}).

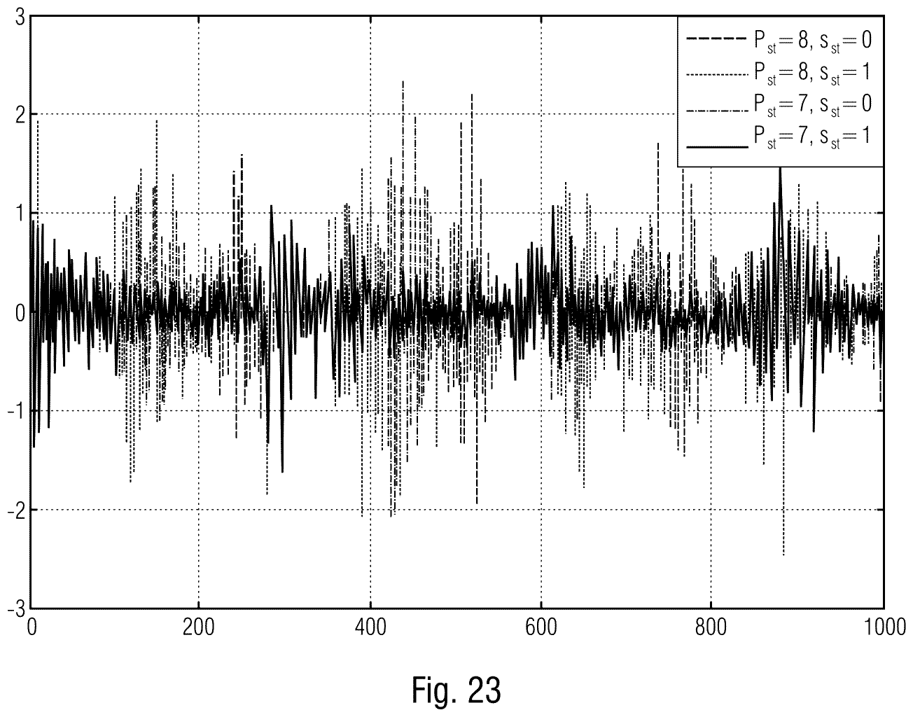

FIG. 23 illustrates (or may show an illustration of an example of) the time-domain effect of FD-LTP filtering of a pseudo-random noise spectrum subjected to an inverse transform (as an example i.e., frequency-to-time transformation e.g. using an inverse MDCT). It shows that, e.g. depending on the choices of p_{sf} and/or s_{sf}, the number and location of the shaped peaks can, for example, be varied.

### Remark 1:

Note that decoding steps 4 and 5 may, for example, effectively limit the contribution of lower-frequency non-zero quantized spectral coefficients, e.g. on a given substituted zero quantized spectral coefficient, for example during the FD-LTP filtering. The e.g. same approach may be applied during FD-LPC filtering, e.g., Temporal Noise Shaping (TNS) synthesis filtering, for example to reduce the likelihood of audible clicks e.g. in low-bit-rate audio coding. Specifically, when filtering a given zero quantized spectral coefficient (e.g. as part of a vector) for example with a TNS synthesis filter, the contribution of nonzero quantized (and for example possibly previously TNS synthesis filtered) lower-frequency spectral coefficients included in the filtering operation (as an example i.e., scaled by a nonzero filtering weight) can, for example, be limited by attenuating their (e.g. filter output) values, e.g. by ½ as in step 5, for example when using those values during the filtering operation.

### 4.4. Preferred Embodiment: E.g. According to Aspect 4 (as an Example, Tonality Based Gap Filling)

Aspect 3 or embodiments according to aspect 3 addressed the need for more accurate fine temporal noise shaping. The desire for more accurate fine spectral noise shaping, e.g. especially on highly tonal and/or harmonic audio signals (for example such as speech or isolated musical instruments like acoustic or electric guitars, harpsichords, trumpets), is addressed by the following tonality based spectral gap filling method according to further embodiments of the invention, which may, for example, be similar to, e.g., the IGF scheme in 3GPP EVS. The main three differences between the following proposal and the IGF technique may be a) the dependency on an audio tonality parameter—e.g. particularly, a

TD-LTP or HPF parameter—and/or b) the application of said tonality based gap filling at lower frequencies, as an example i.e., in a HF spectral region usually targeted by noise filling, and/or c) the use of only one HF energy value (or for example delta)—LF spectral shaping may, for example, be realized via l_{sf} and/or the tilt line.

### 4.4.1. Tonality Based Gap Filling in the Encoder (Example)

As an example, when, in the (sub)frame-wise procedure in Sec. 4.2.1, step 4 is executed (as an example i.e., tonality based gap filling is selected and the FD-LTP is disabled), harmonically continuous gap substitution may, for example, be applied e.g. according to the “zero filling” approach e.g. described in European patent EP21185666 (Integral Band-wise Parametric Coder, 2021) by Marković et al. for example with the notable exception that this method is utilized exclusively on the spectrotemporally normalized spectrum in the HF gap filling region in question. This region may, for example, be the spectral range between the typical noise filling start frequency (e.g., 2 kHz) and noise filling end frequency (e.g., 10 kHz), where the latter, in case of superwideband and/or fullband coding, may, for example, equal the traditional IGF start frequency. Note that conventional IGF processing for audio bandwidth extension (ABE) may still be applied above 10 kHz, as an example, i.e., further IGF related whitening/flattening/energy data may be calculated for said IGF ABE region.

The HF energy value (or, for example, delta e.g. in case of differential entropy coding) may represent the original RMS energy of the spectro-temporally normalized spectral coefficients e.g. slightly below the noise filling end frequency (e.g., in the 8-10 kHz frequency range) which may have been quantized to zero. The energy value may, for example preferably be quantized like the scale factors in AAC, as an example i.e., logarithmically in steps of 1.51 dB. Beside the fine spectral envelope, the tonality based gap filling can, for example, therefore, accurately reconstruct also the coarse HF noise spectral envelope. Note that, for example, to minimize the signaling overhead, for example, required to convey the HF energy value to the decoder, the energy value can, for example, be transmitted as a delta relative to the core coder's global gain and noise level product, as an example i.e., as a “noise gain normalized” value. Preferably, this may, for example be realized by transmitting a rounded scaled result e.g. of a logarithm of the ratio between the HF energy value and the product of global gain and noise level, for example, according to

$$e . g . , {ehf}_{sf} = 1 + round ( Δ \cdot {log}_{2} ( {EHF}_{sf} / ( {GG}_{sf} \cdot {L}_{sf} ) ) ,$$

where ehf_{sf} is the quantized HF energy value (or delta), EHF_{sf} is the above-noted HF original RMS energy, GG_{sf} is the global gain, L_{sf} is the noise level e.g. as earlier, and A is a constant scalar (e.g., Δ=2). To ensure a constant bit consumption of ehf_{sf}, it may need to be limited in its value range (e.g., 0≤ehf_{sf}<4 for 2 bit).

### 4.4.2. Tonality Based Gap Filling in the Decoder (Optional)

As an example, for all subframes sf where gap filling without FD-LTP is being signaled (i.e., where p_{sf} equals 0), the above “noise gain normalized” HF energy delta (as an example, i.e., ratio EHF_{sf}/(GG_{sf}−L_{sf})) can, for example, be reconstructed in the decoder, for example according to:

$$e . g . , {nrgFac}_{sf} = {EHF}_{sf} / ( {GG}_{sf} \cdot {L}_{sf} ) = 2 ( {ehf}_{sf} - 1 ) / Δ ,$$

where ehf_{sf} and L_{sf} are the transmitted quantized HF energy delta and decoded noise level, respectively, and GG_{sf} denotes the reconstructed global gain value as used for gain normalization in the encoder. Note that value A may be chosen as in the encoder and that the “−1” (and the “1+” in Sec. 4.4.1) may be omitted.

Since the product GG_{sf}·L_{sf} may, for example already be multiplied onto the substituted zero-quantized spectral coefficients e.g. by state-of-the-art decoders, the inventive recovery of the desired HF spectral energy may, for example, be achieved e.g. simply by multiplying all generated gap-fill spectral coefficients substituted for zero-quantized coded coefficients in said spectral region, e.g. slightly below the noise filling end frequency (e.g., in the 8-10 kHz frequency range, for example as stated above) by nrgFac_{sf} for example prior to the application of an inverse (as an example i.e., frequency-to-time) transformation, e.g. such as an IMDCT to the reconstructed spectral coefficient vector. In this way, the original RMS energy of gap/noise filled spectral values (e.g. of gap and/or noise filled spectral values) slightly below the noise filling end frequency may, for example, be reconstructed closely.

As an example, the remainder of the decoder-side gap filling operation, for example or namely, the application of either a tonality based filling or conventional noise filling, may, for example, depend on the presence of the audio tonality data mentioned earlier. As an example:
If sf is tonal (as an example, i.e., TD-LTP/HPF data is nonzero), apply copy-up and/or tonality based gap filling, for example as described in European patent EP21185666 (Integral Band-wise Parametric Coder, 2021) by Marković et al.
Otherwise (as an example, i.e., sf is not tonal, the TD-LTP/HPF data is zero or absent), apply traditional noise filling.

### 4.5. Preferred Embodiment: Parameter Signaling

The side information that may for example be required to signal the subframe-wise l, t, and FD-LTP lag and gain or HF energy delta data may, for example, preferably, be of fixed bit length. This may simplify the bit allocation prior to spectral quantization in the encoder. The following example according to embodiments of a transmission design, consuming fixed 12 bits per subframe, works well in practice:

### Signaling Syntax:

If the given frame has more than one subframe (e.g., 2 subframes), then:
set B=3
transmit other control data with {number of subframes} bits (see below) else:
set B=4

For each subframe 0≤sf<{number of subframes} in the given frame do:
transmit noise level index l_{sf} e.g. with 3 bits, for example according to the state of the art
transmit spectral tilt index t_{sf} e.g. with 3 bits, for example according to the present invention
transmit FD-LTP lag index p_{sf} with B bits, according to the present invention
If the transmitted FD-LTP lag is nonzero (i.e., FD-LTP is used), then:
   transmit FD-LTP gain g_{sf} e.g. with 1 bit, according to the present invention
   transmit FD-LTP sign s_{sf} e.g. with 1 bit, according to the present invention else:
   transmit HF energy value e.g. with 2 bits, according to the present invention.

Note that, when a frame is divided into 2 subframes, e.g., two TCX-10 transforms instead of one TCX-20 transform in EVS or IVAS, the FD-LTP lag value can, for example, due to the reduced transform length, be transmitted using 3 instead of 4 bits per subframe which, may, for example, effectively, save two bits for the affected frame. However, the two bits can, for example, be used (and are, for example, preferably, be used) for other bit allocation control data, e.g. a 2-bit index for example defining how the bit budget available for coding of the spectral coefficient and gap fill data is distributed among the two subframes. In doing so, the sum of the inventive signaling overhead and for example if applicable, the 2-bit subframe bit distribution information may remain at a constant 12 bits per subframe, e.g. irrespective of the choice of the number of subframes. This may simplify the encoder-side bit allocation and/or quantization steps.

For example, to conclude, we discuss and/or clarify the l_{sf} and spectrotemporal flattening data (e.g. according to embodiments of the invention), which may be incorporated from conventional solutions:
The subframe-wise 3-bit noise level index l_{sf} can, e.g., be signaled as in EVS or PCT/EP2018/080137, as an example i.e., the final noise level L_{sf} can, for example, be reconstructed as follows: L_{sf}=l_{sf}· 3/32 or, as an example alternatively, L_{sf}=(l_{sf}+½)·- 3/32.
The spectral whitening flag can, e.g., be used to distinguish between mid and strong spectral flattening (e.g. if TD-LTP or HPF data is unavailable) and/or between no and mid spectral flattening (e.g. if said data is available) of the copy-up spectral content. For descriptions of such spectrally whitened content, and how to obtain it, see for example the EVS or ISO/IEC 23008-3 (MPEG-H) Audio standards, specifically the IGF decoding descriptions.
The temporal flattening flag can, e.g., be used to signal the activation of TNS-like filtering of the copy-up spectral content e.g. in order to flatten its temporal envelope. Again, for a description of this technology, see for example the EVS or ISO/IEC 23008-3 (MPEG-H) Audio standards, specifically the IGF decoding algorithms.

Aspect 2, described in Sec. 4.2, introduced for example, inter alia, the signal adaptive choice, on a per-frame and/or a per-subframe basis, e.g. between different methods for generating “artificial” spectral gap-filling content, with the choice being signaled for example to said audio transform decoder e.g. by means of a frequency-domain long-term prediction (FD-LTP) parameter. Specifically, this FD-LTP parameter preferably constitutes a transform-domain “lag” parameter p_{sf} optionally transmitted in the audio bitstream for said frame or subframe sf. It should be apparent to those skilled in the art that, as an alternative to the “lag” parameter p_{sf}, the choice of spectral gap-filling method may depend, for example, on a different FD-LTP parameter instead, namely or for example, the FD-LTP “gain” parameter g_{sf}.

As an example, more precisely, the parametrization of the, e.g. absolute, gain value may be chosen such that a quantized gain value g_{sf}=0 represents a deactivated FD-LTP (e.g. since the effective decoded gain G_{sf} may or will be zero). In that case, the FD-LTP lag p_{sf} and/or sign s_{sf} data do not need to be transmitted (instead, a HF energy value may, for example, be transmitted), and the choice of whether or not to apply noise filling with FD-LTP post-processing (e.g. instead of traditional noise or gap filling without FD-LTP), may depend on the gain e.g. instead of the lag parameter.

The decoder-side step 1. e.g. as described in Sec. 4.2.2 would then or may, for example, be written as follows (note the exchange of p_{sf} and g_{sf}):
1. If quantized gain g_{sf}>0, read quantized lag p_{sf} and sign s_{sf} and select type: noise filling +FD-LTP; . . .

Analogously, on the encoder side, e.g. as described in Sec. 4.2.1, one would or may, for example, need to exchange e.g. all p_{sf} with g_{sf} and vice versa. A further change would or may, for example, be to, e.g. on both the encoder and decoder side, adjust the number of bits used for signaling of the HF energy value, e.g., from the described 2 bits to 4 or 5 bits, for example, so as to match the sum of bits used for signaling of the (e.g. sub)frame-wise FD-LTP lag (3 or 4 bits) and/or sign (1 bit) parameters.

### 5. References and Further Reading

### Patents

M. Dietz, G. Fuchs, C. R. Helmrich, and G. Markovic, Low-Complexity Tonality-Adaptive Audio Signal Quantization, U.S. Patent PCT/EP2014/0516242014 (about quantization with tonality based deadzone)
S. Disch, M. Gayer, C. R. Helmrich, G. Markovic, and M. Luis Valero, Noise Filling Concept, U.S. Patent PCT/EP2014/0516302014. (about filling of contiguous zero-quantized spectral regions & their shaping)
E. Ravelli, C. R. Helmrich, G. Markovic, M. Neusinger, S. Disch, M. Jander, and M. Dietz, Apparatus and Method for Processing an Audio Signal Using a Harmonic Post-Filter, U.S.
Patent PCT/EP2015/066998.
E. Ravelli, M. Schnell, C. Benndorf, M. Lutzky, M. Dietz, and S. Korse, Apparatus and Method for Encoding and Decoding an Audio Signal Using Downsampling or Interpolation of Scale Parameters, U.S. Patent PCT/EP2018/0801372018. (about IVAS SNS method, i.e., calculation of noise shaping envelope)
A. Niedermeier, C. Ertel, R. Geiger, F. Ghido, and C. R. Helmrich, Apparatus and Method for Decoding or Encoding an Audio Signal Using Energy Information Values for a Reconstruction Band, U.S. Patent PCT/EP2014/0651102013. (about Intelligent Gap Filling in EVS or MPEG-H Audio, band energy aspect)
S. Disch, R. Geiger, C. Helmrich, F. Nagel, C. Neukam, K. Schmidt, and M. Fischer, Apparatus, Method and Computer Program for Decoding an Encoded Audio Signal, U.S. Patent PCT/EP2014/0651182013.
S. Disch, F. Nagel, R. Geiger, B. N. Thoshkahna, K. Schmidt, S. Bayer, C. Neukam, B. Edler, and C. R. Helmrich, Apparatus and Method for Encoding or Decoding an Audio Signal with Intelligent Gap Filling in the Spectral Domain, U.S. Patent PCT/EP2014/0651232013. (another fundamental IGF application).

### Papers

C. R. Helmrich, G. Markovic, and B. Edler, Improved Low-Delay MDCT-Based Coding of Both Stationary and Transient Audio Signals, in Proc. IEEE International Conference on Acoustics, Speech, and Signal Processing (ICASSP), pp. 6954-6958, 2014. Online: https://ieeexplore.ieee.org/document/6854948/
C. R. Helmrich, A. Niedermeier, S. Disch, and F. Ghido, Spectral Envelope Reconstruction via IGF for Audio Transform Coding, in Proc. IEEE International Conference on Acoustics, Speech, and Signal Processing (ICASSP), pp. 389-393, 2015. Online: https://ieeexplore.ieee.org/document/7177997/
G. Fuchs, C. R. Helmrich, G. Markovic, M. Neusinger, E. Ravelli, and T. Moriya, Low Delay LPC and MDCT Based Audio Coding in the EVS Codec, in Proc. IEEE Int. Conference on Acoustics, Speech, and Signal Processing (ICASSP), pp. 5723-5727, 2015. Online: https://ieeexplore.ieee.org/document/7179068/
C. R. Helmrich, A. Niedermeier, S. Bayer, and B. Edler, Low-Complexity Semi-Parametric Joint-Stereo Audio Transform Coding, in Proc. EURASIP 23^{rd} EUSIPCO, pp. 799-803, 2015. (stereo filling & IGF stereo)
K. Schmidt and C. Neukam, Low Complexity Tonality Control in the Intelligent Gap Filling Tool, in Proc. IEEE ICASSP, pp. 644-648, 2016. Online: https://ieeexplore.ieee.org/document/7471754/(whitening).

### Links

Simple linear regression method:
https://en.m.wikipedia.org/wiki/Simple linear repression
Spectral Flatness (measurement): https://en.m.wikipedia.org/wiki/Specral_fitness

### APPENDIX 1: APPLICATION OF FD-LTP ADAPTIVE FILTERING ASPECT TO TEMPORAL NOISE SHAPING FILTERING

It is to be noted that the aspects explained in the following may be used independently, and may also optionally be used in combination with any of the features, functionalities and details disclosed herein

It was mentioned in remark 1 in Sec. 4.3.2 that the proposed strength-adaptive filtering operation defined by steps 4 and 5 in Sec. 4.3.2 can, for example, also be applied to Temporal Noise Shaping (TNS) synthesis filtering. Said two steps may, for example, effectively attenuate the filter (as an example i.e., its strength) in a sample-index-wise (i) manner, for example if and only if
the transmitted current spectral coefficient c(i) located at index i has been quantized to zero and
the ‘previous’ spectral coefficient c(i−P′_{sf}) located at index i−P′_{sf} has not been quantized to zero,
with the preferred attenuation being for example 1% (see e.g. step 5) and for example FD-LTP lag P′_{sf}>0 e.g. denoting a spectral distance to i which, in this paragraph, will be abbreviated d_{sf}. This two-part condition can, for example, be generalized as follows e.g. in order to make it applicable to TNS-like filters, e.g. characterized by, instead of a lag and gain, a filter order and one or more filter weights, or filter coefficients, for example, with the number of such weights depending on the filter order (the number of filter coefficients may, for example, equal the filter order). Setting distance d_{sf} equal to the filter order, the TNS or FD-LTP filter may be attenuated, e.g. by multiplying each filter weight by %, e.g. for each i, for example, if and only if
the one or more signaled spectral coefficients c(i−d_{sf}+1) . . . c(i) have been quantized to zero and
the ‘previous’ spectral coefficient c(i−d_{sf}) located at index i−d_{sf} has not been quantized to zero.

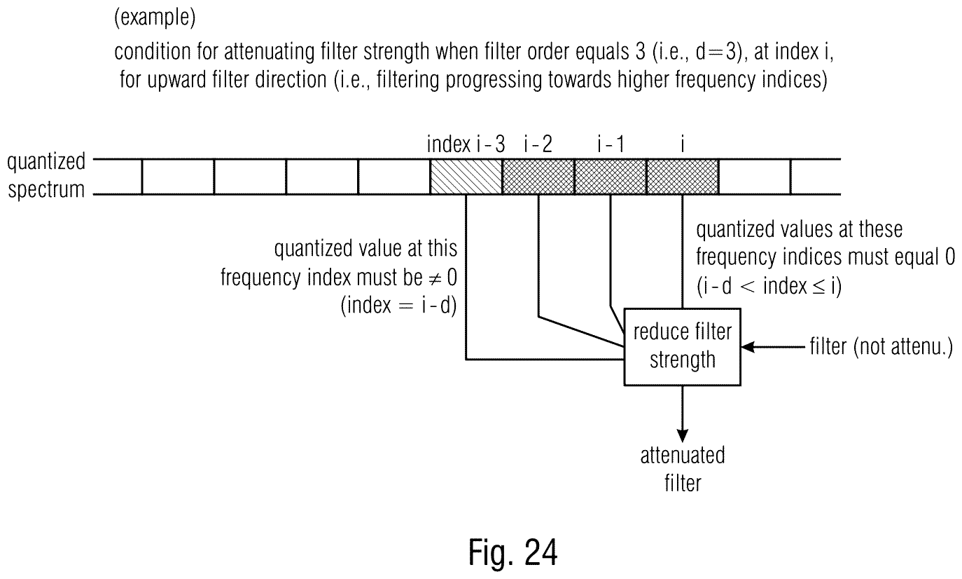

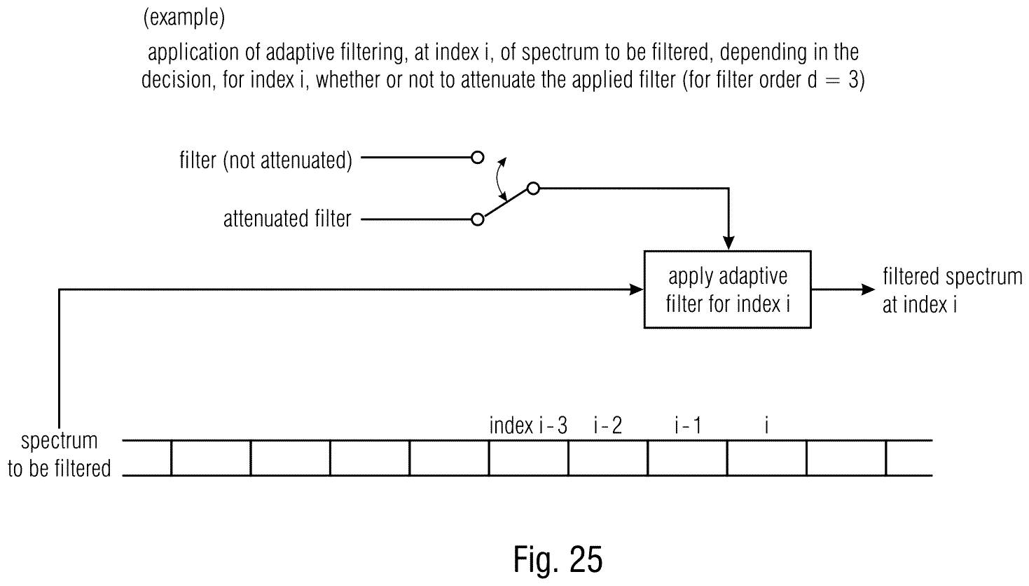

In other words, when both of the above conditions hold, the spectral coefficient c(i) may be filtered with a TNS and/or FD-LTP filter, e.g. whose weights have been attenuated. Conversely, when at least one condition does not hold, coefficient c(i) may, for example, be filtered with an unaltered TNS and/or FD-LTP filter. This is illustrated in FIGS. 24 and 25, where (sub)frame subscript sf has been omitted for clarity. Note that a FD-LTP filter can, for example, be represented by as TNS-like filter by setting d_{sf}=P′_{sf} and specifying all filter weights in the index range 1 . . . d_{sf}−1 to equal zero. Thus, the above generalized condition for strength adaptive filtering may, for example, apply to both TNS and FD-LTP.

Note also that, in case of IIR filtering e.g. as proposed in Sec. 4.3.2, the spectral coefficient vectors input to the filter strength decision (e.g. “quantized spectrum” in FIG. 24) and input to the actual in-place filtering operation (e.g. “spectrum to be filtered” in FIG. 25) may for example differ: the former may specify the spectrum before noise filling (e.g. used for marking in step 2 in Sec. 4.3.2) while the latter may specify the FD-LTP filtered spectrum after noise filling.

### Appendix 2: Proposals for Three [e.g. Partially] Independent Decoders According to Embodiments of the Invention

In the following further embodiments of the invention will be explained with respect to further proposals for decoders according to embodiments of the invention. It is to be noted that the embodiments according to the aspects explained in the following may be used independently, and may also optionally be used in combination with any of the features, functionalities and details disclosed herein. In other words, the embodiments described here, e.g. according to aspects 1 to 4 may optionally be supplemented by any of the features functionalities and details disclosed herein. ¹ scaled?

### Aspect 1 (Adaptive Tilt Correction, Sec. 4.1) (Embodiment 1)

1. Audio transform decoder performing substitution of zero-quantized spectral samples by noise samples, wherein a frame-wise or subframe-wise spectral tilt correction value, t_{sf}, is read from a bit-stream, a frequency dependent tilt curve is derived from t_{sf}, e.g., a line function in a logarithmic domain, and the noise samples substituted for the zero-quantized samples are multiplied¹ by the tilt curve.

### Aspect 2 (Adaptive Gap-Fill Choice, Sec. 4.2) (Embodiment 2)

2. Audio transform decoder performing or configured to perform a substitution of zero-quantized spectral samples by or using filled samples, wherein a frame-wise or subframe-wise spectral, e.g. LTP, distance value, p_{sf}, is read from a bitstream, a first spectral substitution method, e.g. noise filling or some gap filling, is chosen if p_{sf} indicates zero, and a further spectral substitution method, noise filling+FD-LTP of aspect 3, is chosen otherwise.

### Aspect 3 (Noise Filling with FD-LTP, Sec. 4.3) (Embodiment 3)

3. Audio transform decoder configured to perform or performing substitution of zero-quantized spectral samples by noise samples, wherein a noise sample č(i) substituted for a zero-quantized sample is, e.g. LTP, TNS, filtered such that the filtering strength depends on a quantized value c(i−d_{sf}) located at spectral distance d_{sf} from i.
d_{sf}=P′_{sf} in case of FD-LTP. For generalization, č (after noise filling) has been chosen here as symbol to differentiate from c (before noise filling), because c(i−d_{sf}) may, for example, values before noise filling.

### Aspect 4 (Tonality Based Gap Filling, Sec. 4.4) (Embodiment 4)

The following embodiments may, for example, address adaptive (sub)frame-wise selection of, and switching between, three types of spectral substitution (wherein this functionality may optionally be used in any of the embodiments disclosed herein). The following embodiment may, for example, be an inventive further development, or, for example improvement, of the embodiment explained in section Aspect 2 (adaptive gap-fill choice, Sec. 4.2), but may optionally be used together with any other embodiment disclosed herein or independent from other embodiments.
2.1. Audio transform decoder, e.g. configured to perform or performing substitution of zero-quantized samples, according to embodiment 2, wherein a frame or subframe-wise temporal, e.g. audio tonality, pitch info j_{sf} is read from a bitstream, a first e.g. noise filing, or second, e.g. gap filling, spectral substitution method is chosen if p_{sf} equals zero, the further spectral substitution method, e.g.noise filling+FD-LTP, aspect 3, is chosen otherwise, and the choice between the first and second spectral substitution method depends on pitch info j_{sf}.

j_{sf} is not explicitly mentioned in the text as it is known in some conventional solutions (e.g. in some of the conventional solutions mentioned herein). In general, embodiments according to the invention relate to the selection and implementation of the method to be used for generating the spectral values with which the decoder substitutes the “zero-quantized spectral samples” before frequency-to-time transformation, as an example i.e., either these generated spectral values are generated by means of a noise generator (e.g. noise filling=first spectral substitution method, optionally with subsequent FD-LTP filtering=further spectral substitution method) or they are generated by means of a “copy-up” translation method (gap filling=second spectral substitution method).

Details of the “second spectral substitution method”, i.e. for example harmonically accurate “tonality based gap filling” as an extension of the IGF approach employed in EVS and MPEG-H, are not essential for embodiments according to the invention. Embodiments of the invention optionally address the scaling of the RF spectral values quantized (and for example substituted) to zero by 8-10 kHz (e.g. by means of “RF energy (delta) value”) in the case of the first or second spectral substitution method (e.g. because only then the RF energy (delta) value is transmitted). It is to be noted, that this concept (e.g. the scaling of the RF spectral values quantized to zero) may, for example be used in combination with the embodiments according to aspect 2, but may optionally be used in combination with any of the other embodiments of the invention or even independently. It is to be noted that, using this RF energy (delta) value may also be valid when legacy noise filling (first spectral substitution method) is selected; thus, this scaling in an 8-10 kHz range may, for example, not be bound to the “copy-up”-based filling method.

Furthermore, it is to be noted that a filtering according to embodiments of the invention may, for example, comprise a processing of one or more spectral values or sampling values of a same frame or of a same subframe or of a same frequency band or of a same time interval and/or a processing of one or more spectral values or sampling values of different frames or of different subframes or of different frequency bands or of a different intervals.

According to some embodiments, a filtering may, for example, comprise a linear filtering or a non-linear filtering, in which a filtered value is obtained on the basis of one or more input values (e.g. at least one sample value or spectral value). For example, the filtering may provide a filtered value on the basis of a plurality of input values (e.g. sample values or spectral values). A filtering according to embodiments may, for example, comprise a determination of an interpolated (or extrapolated) spectral value or of an interpolated sample value. A filtering may, for example, be used in order to obtain a spectral value or a sample value with good robustness and/or certainty.

Furthermore, it is to be noted that a prediction according to embodiments of the invention may, for example, comprise a processing of one or more spectral values or sampling values of a same frame or of a same subframe or of a same frequency band or of a same time interval and/or a processing of one or more spectral values or sampling values of different frames or of different subframes or of different frequency bands or of a different intervals.

According to some embodiments, a prediction may, for example, comprise a determination of one or more sample values or spectral values on the basis of one or more “earlier” values (e.g. values that are, for example, associated with one or more times that lie before a time of a predicted value to be obtained by the prediction, or values that are, for example, associated with one or more frequencies that are lower than a frequency of a predicted value to be obtained by the prediction) A prediction according to embodiments may, for example, comprise an extrapolation (e.g. a temporal extrapolation or an extrapolation in a frequency direction) of a spectral value or of a sample value. Hence, a prediction may, for example, comprise a processing of frequency values of a certain frequency band, in order to obtain a frequency value, e.g. a spectral coefficient, in another (preferably higher) frequency band. The same may, for example, apply vice versa for sample values in time domain.

Furthermore, it is to be noted that according to some embodiments filtering and prediction may, for example, be used interchangeable, or may, in other words, for example, even be the same, e.g. in the context of prediction filters. Hence, a filtering may, for example, be performed in order to predict a value. In other words, prediction may, for example, be performed using a filtering, but, for example, other prediction algorithms, which do not use a filtering, may optionally be used as well. Also, for example, some filtering operations may perform a prediction, while, for example, other filtering operations may rather use values (or samples) before (e.g. temporally before) and after (e.g. temporally after) a value to be obtained. Thus, for example, filtering and prediction may be considered as similar or equal concepts in some cases, while, for example, there are filtering operations that do not perform a prediction and vice versa.

Moreover, it is to be noted, that embodiments according to the invention may, for example, be used in the context of EVS, Intelligent gap filling (IGF), IVAS, MDCT coding, MPEG-H 3D Audio, noise filling. Embodiments may, for example, be used or may, for example, be part of the technical field of MDCT based audio coding for 3GPP IVAS. Embodiments may, for example, be used for 3GPP IVAS, IIS proprietary low-rate speech and audio codec.

In the following embodiments according to the invention are discussed in different words:

Embodiments according to the invention may, for example, relate to perceptually improved ways of calculating spectral envelopes, e.g. as applied in modern audio transform codecs, and, for example, to improved ways of reconstructing the spectral and/or temporal fine-structure of spectral regions quantized to zero in an encoder. In other words, the embodiments, may, for example, relate to spectral envelopes representing time and/or frequency variant masking thresholds, for example, used during spectral quantization in conventional audio codecs, whereby each spectrum may, for example, be divided by the associated masking threshold, e.g. prior to quantization and multiplied by it after quantization, optionally yielding spectral shaping of the quantization distortion according to the masking threshold. In addition, the embodiments may, for example, relate to spectral substitution, or “filling”, of spectral gaps (e.g. zero-quantized frequency coefficients after encoding) for example caused by coarse quantization, e.g. at relatively low target bit-rates.

Embodiments may, for example, comprise:
1. Transmission of a frame-wise and/or subframe-wise spectral tilt correction t in an audio transform codec, optionally applying spectral gap filling e.g. without explicit transmission of target energies in zero-quantized bands.
2. Application of a long-term predictive filter in a spectral domain, for example, during the decoder-side noise filling routine.

The above described embodiments are merely illustrative for the principles of the present invention. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An audio decoder for providing a decoded audio information on the basis of an encoded audio information,
wherein the audio decoder is configured to fill spectral holes of a decoded set of spectral values;
wherein the audio decoder is configured to acquire a prediction lag information; and
wherein the audio decoder is configured to switch between a first spectral filling method, in which a frequency filtering or a frequency prediction is used to acquire filling values which are used to fill spectral holes, and one or more further spectral filling methods, in which no frequency filtering and no frequency prediction are used to acquire filling values which are used to fill spectral holes, in dependence on the prediction lag information.

2. Audio decoder according to claim 1, wherein the audio decoder is configured to use the first spectral filling method if the prediction lag information is non-zero, or
wherein the audio decoder is configured to use the first spectral filling method if the prediction lag information is larger than zero; and
wherein the audio decoder is configured to use one of the one or more further spectral filling methods otherwise.

3. Audio decoder according to claim 1, wherein the audio decoder is configured to use an encoded representation of a prediction lag value, which is comprised by the encoded audio information, in order to acquire the prediction lag value.

4. An audio decoder according to claim 1,
wherein the audio decoder is configured to determine a filling value using a prediction or filtering, such that a given filling value, which is associated with a given frequency, is acquired in dependence on another spectral value, which is associated with a different frequency, when using the first spectral filling method;
wherein the audio decoder is configured to adapt a filtering strength in dependence on an encoded or quantized spectral value associated with the different frequency when using the first spectral filling method.

5. Audio decoder according to claim 4, wherein the filtering strength determines an impact of the other spectral value onto the given filling value.

6. Audio decoder according to claim 4, wherein the audio decoder is configured to adapt the filtering strength in dependence on the spectral value associated with the different frequency as it is determined by the encoded representation of individual spectral values in the encoded audio information.

7. Audio decoder according to claim 4, wherein the audio decoder is configured to adapt the filtering strength in dependence on the spectral value associated with the different frequency before a noise filling is applied.

8. Audio decoder according to claim 4, wherein the audio decoder is configured to adapt the filtering strength in dependence on whether the spectral value associated with the different frequency is quantized to zero or not.

9. Audio decoder according to claim 4, wherein the audio decoder is configured to adapt the filtering strength in dependence on whether a noise filling is applied to the spectral value associated with the different frequency or not.

10. Audio decoder according to claim 4, wherein the audio decoder is configured to selectively apply a filtering in a frequency direction or a prediction in a frequency direction for spectral values for which a noise filling is applied.

11. Audio decoder according to claim 4, wherein the audio decoder is configured to apply the prediction or the filtering, in order to determine the given filling value on the basis of a random or pseudo-random noise values.

12. Audio decoder according to claim 4, wherein the audio decoder is configured to perform
a weighted combination of a noise value associated with the given frequency, and of a noise value associated with the other frequency,
or
a weighted combination of a noise value associated with the given frequency, and of a filling value associated with the other frequency,
in order to acquire the given filling value; and
wherein the audio decoder is configured to adjust a weight given to the noise value associated with the other frequency or the weight given to the filling value associated with the other frequency in dependence on whether a noise filling has been applied for a spectral value associated with the other frequency.

13. Audio decoder according to claim 4, wherein the audio decoder is configured to determine a spectral distance between the filling value associated with the given frequency and the other spectral value associated with the different frequency on the basis of an encoded information describing the spectral distance, which is comprised by the encoded representation of the audio information.

14. Audio decoder according to claim 4, wherein the audio decoder is configured to determine a weight, which is applied to the noise value associated with the given frequency, on the basis of a gain information which is comprised by the encoded representation of the audio information.

15. Audio decoder according to claim 4, wherein the audio decoder is configured to determine a weight, which is applied to the noise value associated with the other frequency, or to the filling value associated with the other frequency, in dependence on a gain information which is comprised by the encoded representation of the audio information.

16. Audio decoder according to claim 4, wherein the audio decoder is configured to determine the weight, which is applied to the noise value associated with the other frequency, or to the filling value associated with the other frequency, in dependence on a sign information which is comprised by the encoded representation of the audio information.

17. Audio decoder according to claim 4, wherein the audio decoder is configured to determine the given filling value č(i)
according to č(i)=d*c(i)+G′_{sf}*c(i−P′_{sf}), if the coefficient c(i−P′_{sf}) was acquired using a noise filling; and
according to č(i)=d*c(i)+½*G′_{sf}*c(i−P′_{sf}), if the coefficient c(i−P′_{sf}) was not acquired using a noise filling;
wherein c(i) designates a spectral coefficient which is acquired using a noise filling and comprising a spectral index i;
wherein d designates an attenuation coefficient,
wherein G′_{sf} designates a weight which is based on a gain value that is comprised by the encoded audio representation; and
wherein c(i−P′_{sf}) designates a spectral coefficient comprising a spectral index i−P′_{sf},
wherein P′_{sf} is a prediction parameter or a filtering parameter which is based on a prediction parameter information that is comprised by the encoded audio representation.

18. Audio decoder according to claim 4, wherein the audio decoder is configured to acquire the prediction parameter or filtering parameter P′_{sf} according to P′_{sf}=p_{sf}+B, wherein p_{sf} is a lag index which is comprised by the encoded audio representation, and wherein B is a constant; and/or
wherein the audio decoder is configured to acquire the weight G′_{sf} according to G′_{sf}=(−1)^{Ssf}*(3+2*g_{sf})/8, wherein S_{sf} is a binary value which is comprised by the encoded representation and wherein g_{sf} is a binary value which is comprised by the encoded representation; and/or
wherein the audio decoder is configured to acquire the attenuation coefficient d according to d=(7.5−g_{sf})/8, wherein g_{sf} is a binary value which is comprised by the encoded representation.

19. Audio decoder according to claim 4, wherein the audio decoder is configured to mark noise-filled zero-quantized spectral coefficients, and
wherein the audio decoder is configured to selectively use a reduced filtering strength which is applied to spectral coefficients which are not marked.

20. Audio decoder according to claim 1, wherein the audio decoder is configured to switch between a second spectral filling method, in which random or pseudo-random filling values are used to fill spectral holes, and a third spectral filling method, in which filling values which are acquired using a copying of non-zero spectral coefficients are used to fill spectral holes, in dependence on a prediction lag information and/or in dependence on a tonality of the audio information.

21. Audio decoder according to claim 1,
wherein the audio decoder is configured to acquire a tonality information on the basis of the encoded audio information, and
wherein the audio decoder is configured to switch between a second spectral filling method and a third spectral filling method in dependence in the tonality information.

22. Audio decoder according to claim 1, wherein the audio decoder is configured to acquire a prediction lag information.

23. Audio decoder according to claim 1, wherein the audio decoder is configured to judge whether the audio information is tonal in dependence on a tonality information which is comprised by the encoded audio representation and/or in dependence on an information indicating whether a tonality information is comprised by the encoded audio information, and/or in dependence on a filtering gain value and/or in dependence on a prediction gain value and/or in dependence on a time-domain post-filter gain value.

24. Audio decoder according to claim 1,
wherein the audio decoder is configured to apply a high frequency noise gain adjustment for a filling of spectral holes in an upper frequency region below an noise filling end frequency.

25. An audio encoder for providing an encoded audio information on the basis of an input audio information,
wherein the audio encoder is configured to encode a plurality of quantized spectral values;
wherein the audio encoder is configured to acquire a lag value, which defines a characteristic of a filtering operation or of a prediction operation to be performed by an audio decoder for deriving one or more filling values for filling spectral holes; and
wherein the audio encoder is configured to acquire a gain value which defines a characteristic of the filtering operation or of the prediction operation to be performed by an audio decoder for deriving one or more filling values for filling spectral holes;
wherein the audio encoder is configured to set the lag value to zero if the gain value is smaller than a threshold value or if an absolute value of the gain value is smaller than a threshold value, to thereby acquire a modified lag value; and
wherein the audio encoder is configured to encode the determined lag value or the modified lag value.

26. Audio encoder according to claim 25, wherein the audio encoder is configured to determine the lag value and the gain value using an autocorrelation information which is applied to a set of spectral values.

27. Audio encoder according to claim 25, wherein the audio encoder is configured to selectively encode the gain value if the encoded lag value is non-zero.

28. Audio encoder according to claim 25, wherein the audio encoder is configured to selectively encode a high-frequency energy value, which describes an energy in an upper portion of a spectrum, if the encoded lag value is zero.

29. Audio encoder according to claim 25, wherein the audio encoder is configured to determine separate lag values and/or separate gain values for different audio frames and/or for different audio subframes.

30. Audio encoder according to claim 25, wherein the audio encoder is configured to acquire the lag value and/or the gain value in a transform domain.

31. Audio encoder according to claim 25, wherein the audio encoder is configured to perform a long term transientness detection and to selectively set the lag value to zero if an audio frame or audio subframe is found to be not long-term transient.

32. An audio encoder for providing an encoded audio information on the basis of an input audio information,
wherein the audio encoder is configured to encode a plurality of quantized spectral values;
wherein the audio encoder is configured to encode a high frequency energy value or a high frequency energy delta value,
wherein the high frequency energy value or the high frequency energy delta value represents an energy of a plurality of spectral coefficients at a frequency below a noise filling end frequency or in a frequency region below the noise filling end frequency which were quantized to zero.

33. Audio decoder according to claim 4, wherein the audio decoder is configured to perform
a weighted combination of a noise value associated with the given frequency, and of a spectral value associated with the other frequency or
a weighted combination of a filling value associated with the given frequency, and of a spectral value associated with the other frequency
in order to acquire the given filling value; and
wherein the audio decoder is configured to adjust a weight given to the spectral value associated with the other frequency in dependence on whether a noise filling has been applied for the spectral value associated with the other frequency.

34. An audio decoder for providing a decoded audio information on the basis of an encoded audio information,
wherein the audio decoder is configured to fill spectral holes of a decoded set of spectral values;
wherein the audio decoder is configured to acquire a prediction gain information; and
wherein the audio decoder is configured to switch between a first spectral filling method, in which a frequency filtering or a frequency prediction is used to acquire filling values which are used to fill spectral holes, and one or more further spectral filling methods, in which no frequency filtering and no frequency prediction are used to acquire filling values which are used to fill spectral holes, in dependence on the prediction gain information.

35. An audio encoder for providing an encoded audio information on the basis of an input audio information,
wherein the audio encoder is configured to encode a plurality of quantized spectral values;
wherein the audio encoder is configured to acquire a gain value which defines a characteristic of a filtering operation or of a prediction operation to be performed by an audio decoder for deriving one or more filling values for filling spectral holes;
wherein the audio encoder is configured to encode the gain value;
wherein the audio encoder is configured to selectively encode a lag value, which defines a characteristic of the filtering operation or of the prediction operation to be performed by an audio decoder for deriving one or more filling values for filling spectral holes, if a quantized gain value or an encoded gain value is non-zero, or
wherein the audio encoder is configured to selectively encode a lag value, which defines a characteristic of the filtering operation or of the prediction operation to be performed by an audio decoder for deriving one or more filling values for filling spectral holes, if the gain value is larger than or equal to a threshold value.

36. Method for providing a decoded audio information on the basis of an encoded audio information, the method comprising:
filling spectral holes of a decoded set of spectral values;
acquiring a prediction lag information; and
switching between a first spectral filling method, in which a frequency filtering or a frequency prediction is used to acquire filling values which are used to fill spectral holes, and one or more further spectral filling methods, in which no frequency filtering and no frequency prediction are used to acquire filling values which are used to fill spectral holes, in dependence on the prediction lag information.

37. Method for providing an encoded audio information on the basis of an input audio information,
encoding a plurality of quantized spectral values;
acquiring a lag value, which defines a characteristic of a filtering operation or of a prediction operation to be performed by an audio decoder for deriving one or more filling values for filling spectral holes; and
acquiring a gain value which defines a characteristic of the filtering operation or of the prediction operation to be performed by an audio decoder for deriving one or more filling values for filling spectral holes;
setting the lag value to zero if the gain value is smaller than a threshold value or if an absolute value of the gain value is smaller than a threshold value, to thereby acquire a modified lag value; and
encoding the determined lag value or the modified lag value.

38. Method for providing a decoded audio information on the basis of an encoded audio information, the method comprising:
filling spectral holes of a decoded set of spectral values;
acquiring a prediction gain information; and
switching between a first spectral filling method, in which a frequency filtering or a frequency prediction is used to acquire filling values which are used to fill spectral holes, and one or more further spectral filling methods, in which no frequency filtering and no frequency prediction are used to acquire filling values which are used to fill spectral holes, in dependence on the prediction gain information.

39. Method for providing an encoded audio information on the basis of an input audio information, the method comprising
encoding a plurality of quantized spectral values;
acquiring a gain value which defines a characteristic of a filtering operation or of a prediction operation to be performed by an audio decoder for deriving one or more filling values for filling spectral holes;
encoding the gain value;
selectively encoding a lag value, which defines a characteristic of the filtering operation or of the prediction operation to be performed by an audio decoder for deriving one or more filling values for filling spectral holes, if a quantized gain value or an encoded gain value is non-zero, or
selectively encoding a lag value, which defines a characteristic of the filtering operation or of the prediction operation to be performed by an audio decoder for deriving one or more filling values for filling spectral holes, if the gain value is larger than or equal to a threshold value.

40. A non-transitory digital storage medium having a computer program stored thereon to perform the method for providing a decoded audio information on the basis of an encoded audio information, the method comprising:
filling spectral holes of a decoded set of spectral values;
acquiring a prediction lag information; and
switching between a first spectral filling method, in which a frequency filtering or a frequency prediction is used to acquire filling values which are used to fill spectral holes, and one or more further spectral filling methods, in which no frequency filtering and no frequency prediction are used to acquire filling values which are used to fill spectral holes, in dependence on the prediction lag information,
when said computer program is run by a computer.

41. A non-transitory digital storage medium having a computer program stored thereon to perform the method for providing an encoded audio information on the basis of an input audio information,
encoding a plurality of quantized spectral values;
acquiring a lag value, which defines a characteristic of a filtering operation or of a prediction operation to be performed by an audio decoder for deriving one or more filling values for filling spectral holes; and
acquiring a gain value which defines a characteristic of the filtering operation or of the prediction operation to be performed by an audio decoder for deriving one or more filling values for filling spectral holes;
setting the lag value to zero if the gain value is smaller than a threshold value or if an absolute value of the gain value is smaller than a threshold value, to thereby acquire a modified lag value; and
encoding the determined lag value or the modified lag value,
when said computer program is run by a computer.

42. A non-transitory digital storage medium having a computer program stored thereon to perform the method for providing a decoded audio information on the basis of an encoded audio information, the method comprising:
filling spectral holes of a decoded set of spectral values;
acquiring a prediction gain information; and
switching between a first spectral filling method, in which a frequency filtering or a frequency prediction is used to acquire filling values which are used to fill spectral holes, and one or more further spectral filling methods, in which no frequency filtering and no frequency prediction are used to acquire filling values which are used to fill spectral holes, in dependence on the prediction gain information,
when said computer program is run by a computer.

43. A non-transitory digital storage medium having a computer program stored thereon to perform the method for providing an encoded audio information on the basis of an input audio information, the method comprising
encoding a plurality of quantized spectral values;
acquiring a gain value which defines a characteristic of a filtering operation or of a prediction operation to be performed by an audio decoder for deriving one or more filling values for filling spectral holes;
encoding the gain value;
selectively encoding a lag value, which defines a characteristic of the filtering operation or of the prediction operation to be performed by an audio decoder for deriving one or more filling values for filling spectral holes, if a quantized gain value or an encoded gain value is non-zero, or
selectively encoding a lag value, which defines a characteristic of the filtering operation or of the prediction operation to be performed by an audio decoder for deriving one or more filling values for filling spectral holes, if the gain value is larger than or equal to a threshold value,
when said computer program is run by a computer.

44. An audio decoder for providing a decoded audio information on the basis of an encoded audio information,
wherein the audio decoder is configured to fill spectral holes of a decoded set of spectral values;
wherein the audio decoder is configured to acquire a prediction lag information; and
wherein the audio decoder is configured to switch between a first spectral filling method, in which a frequency filtering or a frequency prediction is used to acquire filling values which are used to fill spectral holes, and one or more further spectral filling methods, in which no frequency filtering and no frequency prediction are used to acquire filling values which are used to fill spectral holes, in dependence on the prediction lag information,
wherein the one or more further spectral filling methods comprise a usage of random or pseudo-random filling values to fill spectral holes, and/or a copying of non-zero spectral coefficients to fill spectral holes.

45. An audio decoder for providing a decoded audio information on the basis of an encoded audio information,
wherein the audio decoder is configured to fill spectral holes of a decoded set of spectral values;
wherein the audio decoder is configured to acquire a prediction lag information; and
wherein the audio decoder is configured to switch between a first spectral filling method, in which a frequency filtering or a frequency prediction is used to acquire filling values which are used to fill spectral holes, and one or more further spectral filling methods, in which the frequency filtering or the frequency prediction is not used to acquire filling values which are used to fill spectral holes, in dependence on the prediction lag information.

46. An audio decoder for providing a decoded audio information on the basis of an encoded audio information,
wherein the audio decoder is configured to fill spectral holes of a decoded set of spectral values;
wherein the audio decoder is configured to acquire a prediction lag information; and
wherein the audio decoder is configured to switch between
a first spectral filling method, in which a noise filling, that uses random or pseudo random values, with a frequency filtering or a frequency prediction is used to acquire filling values which are used to fill spectral holes, and
one or more further spectral filling methods, in which a noise filling, that uses random or pseudo random values, or a tonality based gap filling is used without the frequency filtering or the frequency prediction to acquire filling values which are used to fill spectral holes, in dependence on the prediction lag information.

47. Audio encoder according to claim 25,
wherein the audio encoder is configured to encode the modified gain value, if the modified gain value was obtained, and to encode the gain value if the modified gain value was not obtained.
